(19) United States
(12) Patent Application Publication
(10) Pub. No.: US 2024/0031103 A1
(43) Pub. Date: Jan. 25, 2024

(54) Methods and Apparatus for SRS Transmission and Signaling

(71) Applicant: Huawei Technologies Co., Ltd., Shenzhen (CN)

(72) Inventors: Jialing Liu, Palatine, IL (US); Weimin Xiao, Hoffman Estates, IL (US); Qian Cheng, Naperville, IL (US)

(21) Appl. No.: 18/481,452

(22) Filed: Oct. 5, 2023

Related U.S. Application Data
(63) Continuation of application No. PCT/US2022/023340, filed on Apr. 4, 2022.
(60) Provisional application No. 63/170,996, filed on Apr. 5, 2021.

(51) Int. Cl. H04L 5/00

(52) U.S. Cl. CPC H04L 5/0051; H04L 5/0094

(57) ABSTRACT

According to embodiments, a user equipment (UE) receives control information for a first sounding reference signal (SRS). The control information indicates at least a first frequency resource in a carrier, a frequency-domain shift parameter, a PF value, and a frequency-domain offset value. Based on the control information, the UE transmits the first SRS on a first partial frequency sounding resource within the first frequency resource in the carrier. A resource starting physical resource block (PRB) of the first frequency resource is in accordance with the frequency-domain shift parameter. A bandwidth of the first partial frequency sounding resource is based on at least the PF value and a bandwidth of the first frequency resource. A partial frequency sounding resource starting PRB of the first partial frequency sounding resource is based at least on the resource starting PRB of the first frequency resource and the frequency-domain offset value.

### CROSS-REFERENCE TO RELATED APPLICATIONS

This patent application is a continuation of International Patent Application No. PCT/US2022/023340, filed on Apr. 4, 2022 and entitled “Methods and Apparatus for SRS Transmission and Signaling,” which claims priority to U.S. Provisional Application No. 63/170,996, filed on Apr. 5, 2021 and entitled “Methods and Apparatus for SRS Transmission and Signaling,” applications of which are hereby incorporated by reference herein as if reproduced in their entireties.

### TECHNICAL FIELD

The present disclosure relates generally to methods and apparatus for wireless communications, and, in particular embodiments, to methods and apparatus for sounding reference signals transmission and reception enhancements, including signaling control information for sounding reference signals.

### BACKGROUND

Sounding reference signals (SRSs) are reference signals transmitted by user equipment (UE) in the uplink for the purpose of enabling uplink channel estimation over a wide bandwidth. As such, the network may be able to perform communication with the UEs based on the uplink channel estimation. Moreover, due to channel reciprocity between the uplink and the downlink present in a time division duplex (TDD) communication system, the network may utilize the SRSs to perform dynamic scheduling. That is, the network may exploit channel-dependent scheduling. In this case, the time-frequency resources are dynamically scheduled, taking into account the different traffic priorities and quality of services requirements. Typically, the UEs monitor several Physical Downlink Control Channels (PDCCHs) to acquire the scheduling decisions, which are signaled to the UEs by the network. Upon the detection of a valid PDCCH, the UE follows the scheduling decision and receives (or transmits) data.

### SUMMARY

According to a first aspect, a method implemented by an access node is provided. The method comprising transmitting, by the access node, to a user equipment (UE) served by the access node, configuration information of a sounding reference signal (SRS) resource with a set of SRS ports, and transmitting, by the access node, to the UE, an indication of a subset of the set of SRS ports of the SRS resource.

In a first implementation form of the method according to the first aspect as such, the indication of the subset indicating one of a plurality of subsets of SRS ports.

In a second implementation form of the method according to the first aspect as such or any preceding implementation form of the first aspect, each of the plurality of subsets of SRS ports being associated with a unique index.

In a third implementation form of the method according to the first aspect as such or any preceding implementation form of the first aspect, the indication of the subset specifying the index associated with the subset of the set of SRS ports.

In a fourth implementation form of the method according to the first aspect as such or any preceding implementation form of the first aspect, each SRS port in the set of SRS ports of the SRS resource is associated with a transmission comb, an offset associated with the transmission comb, a cyclic shift, and an orthogonal frequency division multiplex (OFDM) symbol.

In a fifth implementation form of the method according to the first aspect as such or any preceding implementation form of the first aspect, further comprising, receiving, by the access node, from the UE, a SRS transmission in accordance with the subset of the set of SRS ports.

In a sixth implementation form of the method according to the first aspect as such or any preceding implementation form of the first aspect, the configuration information being transmitted in a higher layer message.

In a seventh implementation form of the method according to the first aspect as such or any preceding implementation form of the first aspect, the indication of the subset being transmitted in a group downlink control information (DCI) message (also called group common DCI, or GC DCI).

In an eighth implementation form of the method according to the first aspect as such or any preceding implementation form of the first aspect, the UE being one of a subset of the plurality of UEs served by the access node, the method further comprising assigning, by the access node, a UE identifier to each UE in the subset of UEs served by the access node, the UE identifiers being unique within the subset of UEs served by the access node, and transmitting, by the access node, indications of the UE identifiers of the UEs in the subset of UEs served by the access node.

In a ninth implementation form of the method according to the first aspect as such or any preceding implementation form of the first aspect, the UE identifiers being configured in a higher layer message.

In a tenth implementation form of the method according to the first aspect as such or any preceding implementation form of the first aspect, transmitting the configuration information comprising, for each UE in the subset of UEs served by the access node, transmitting, by the access node, an indication of a UE identifier associated with the UE, a transmit power control (TPC) command associated with a SRS, and SRS configuration information associated with the UE, the SRS configuration information including an indication of a subset of a set SRS port resources and an indication of an association between SRS port resources and downlink port resources.

In an eleventh implementation form of the method according to the first aspect as such or any preceding implementation form of the first aspect, transmitting the indication of the subset comprising, for each UE in the subset of UEs served by the access node, transmitting, by the access node, a TPC command associated with the UE, and the indication of the subset.

In a twelfth implementation form of the method according to the first aspect as such or any preceding implementation form of the first aspect, transmitting the indication of the subset comprising transmitting, by the access node, a TPC command associated with the UE, and the indication.

In a thirteenth implementation form of the method according to the first aspect as such or any preceding implementation form of the first aspect, the indications of the UE identifiers being transmitted in a group DCI message.

In a fourteenth implementation form of the method according to the first aspect as such or any preceding implementation form of the first aspect, the indication of the subset being transmitted in a unicast DCI message.

In a fifteenth implementation form of the method according to the first aspect as such or any preceding implementation form of the first aspect, the indication of A-SRS triggering offset/delay being transmitted in a unicast DCI message for PDSCH scheduling.

In a sixteenth implementation form of the method according to the first aspect as such or any preceding implementation form of the first aspect, the indication of channel measurement resource(s) (CMRs) and optionally interference measurement resource(s) (IMRs) for determining A-SRS transmission precoding being transmitted in a unicast DCI message.

In a seventeenth implementation form of the method according to the first aspect as such or any preceding implementation form of the first aspect, the UE behavior and assumptions for the A-SRS transmission.

According to a second aspect, a method implemented by an access node is provided. The method comprising transmitting, by the access node, to a UE, SRS configuration information, the SRS configuration information comprising associations between SRS ports and downlink ports, and transmitting, by the access node, to the UE, an indication of one of the associations between the SRS ports and the downlink ports.

In a first implementation form of the method according to the second aspect as such, the SRS ports being SRS port resources indicated as a subset of a set of an ordering of the SRS port resources.

In a second implementation form of the method according to the second aspect as such or any preceding implementation form of the second aspect, the SRS configuration information being transmitted in a higher layer message.

In a third implementation form of the method according to the second aspect as such or any preceding implementation form of the second aspect, the indication being transmitted in a group DCI message.

In a fourth implementation form of the method according to the second aspect as such or any preceding implementation form of the second aspect, the indication being transmitted in a unicast DCI message.

According to a third aspect, an access node is provided. The access node comprises a non-transitory memory storage comprising instructions, and one or more processors in communication with the memory storage. The one or more processors execute the instructions to transmit, to a UE served by the access node, configuration information of a SRS resource with a set of SRS ports, and transmit, to the UE, an indication of a subset of the set of SRS ports of the SRS resource.

In a first implementation form of the access node according to the third aspect as such, the indication of the subset indicating one of a plurality of subsets of SRS ports.

In a second implementation form of the access node according to the third aspect as such or any preceding implementation form of the third aspect, each of the plurality of subsets of SRS ports being associated with a unique index.

In a third implementation form of the access node according to the third aspect as such or any preceding implementation form of the third aspect, the indication of the subset specifying the index associated with the subset of the set of SRS ports.

In a fourth implementation form of the access node according to the third aspect as such or any preceding implementation form of the third aspect, each SRS port in the set of SRS ports of the SRS resource is associated with a transmission comb, an offset associated with the transmission comb, a cyclic shift, and an OFDM symbol.

In a fifth implementation form of the access node according to the third aspect as such or any preceding implementation form of the third aspect, the one or more processors executing the instructions to receive, from the UE, a SRS transmission in accordance with the subset of the set of SRS ports.

In a sixth implementation form of the access node according to the third aspect as such or any preceding implementation form of the third aspect, the configuration information being transmitted in a higher layer message.

In a seventh implementation form of the access node according to the third aspect as such or any preceding implementation form of the third aspect, the indication of the subset being transmitted in a group DCI message.

In an eighth implementation form of the access node according to the third aspect as such or any preceding implementation form of the third aspect, the UE being one of a subset of the plurality of UEs served by the access node, and the one or more processors executing the instructions to assign a UE identifier to each UE in the subset of UEs served by the access node, the UE identifiers being unique within the subset of UEs served by the access node, and transmit indications of the UE identifiers of the UEs in the subset of UEs served by the access node.

In a ninth implementation form of the access node according to the third aspect as such or any preceding implementation form of the third aspect, the UE identifiers being configured in a higher layer message.

In a tenth implementation form of the access node according to the third aspect as such or any preceding implementation form of the third aspect, the one or more processors executing the instructions to, for each UE in the subset of UEs served by the access node, transmit an indication of a UE identifier associated with the UE, a TPC command associated with a SRS, and SRS configuration information associated with the UE, the SRS configuration information including an indication of a subset of a set SRS port resources and an indication of an association between SRS port resources and downlink port resources.

In an eleventh implementation form of the access node according to the third aspect as such or any preceding implementation form of the third aspect, the one or more processors executing the instructions to, for each UE in the subset of UEs served by the access node, transmit a TPC command associated with the UE, and the indication of the subset.

In a twelfth implementation form of the access node according to the third aspect as such or any preceding implementation form of the third aspect, the one or more processors executing the instructions to transmit a TPC command associated with the UE, and the indication.

In a thirteenth implementation form of the access node according to the third aspect as such or any preceding implementation form of the third aspect, the indications of the UE identifiers being transmitted in a group DCI message.

In a fourteenth implementation form of the access node according to the third aspect as such or any preceding implementation form of the third aspect, the indication of the subset being transmitted in a unicast DCI message.

According to a fourth aspect, an access node is provided. The access node comprises a non-transitory memory storage comprising instructions, and one or more processors in communication with the memory storage. The one or more processors execute the instructions to transmit, to a UE, SRS configuration information, the SRS configuration information comprising associations between SRS ports and downlink ports, and transmit, to the UE, an indication of one of the associations between the SRS ports and the downlink ports.

In a first implementation form of the access node according to the fourth aspect as such, the SRS ports being SRS port resources indicated as a subset of a set of an ordering of the SRS port resources.

In a second implementation form of the access node according to the fourth aspect as such or any preceding implementation form of the fourth aspect, the SRS configuration information being transmitted in a higher layer message.

In a third implementation form of the access node according to the fourth aspect as such or any preceding implementation form of the fourth aspect, the indication being transmitted in a group DCI message.

In a fourth implementation form of the access node according to the fourth aspect as such or any preceding implementation form of the fourth aspect, the indication being transmitted in a unicast DCI message.

According to a fifth aspect, a method implemented by a UE is provided. The method comprising receiving, by the UE, from an access node, configuration information of a SRS resource with a set of SRS ports, and receiving, by the UE, from the access node, an indication of a subset of the set of SRS ports of the SRS resource.

In a first implementation form of the method according to the fifth aspect as such, the indication of the subset indicating one of a plurality of subsets of SRS ports.

In a second implementation form of the method according to the fifth aspect as such or any preceding implementation form of the fifth aspect, each of the plurality of subsets of SRS ports being associated with a unique index.

In a third implementation form of the method according to the fifth aspect as such or any preceding implementation form of the fifth aspect, the indication of the subset specifying the index associated with the subset of the set of SRS ports.

In a fourth implementation form of the method according to the fifth aspect as such or any preceding implementation form of the fifth aspect, each SRS port in the set of SRS ports of the SRS resource is associated with a transmission comb, an offset associated with the transmission comb, a cyclic shift, and an OFDM symbol.

In a fifth implementation form of the method according to the fifth aspect as such or any preceding implementation form of the fifth aspect, further comprising, transmitting, by the UE, to the access node, a SRS transmission in accordance with the subset of the set of SRS ports.

In a sixth implementation form of the method according to the fifth aspect as such or any preceding implementation form of the fifth aspect, the configuration information being received in a higher layer message.

In a seventh implementation form of the method according to the fifth aspect as such or any preceding implementation form of the fifth aspect, the indication of the subset being received in a group DCI message.

In an eighth implementation form of the method according to the fifth aspect as such or any preceding implementation form of the fifth aspect, the UE being one of a subset of a plurality of UEs served by the access node, the method further comprising receiving, by the UE, an indication of a UE identifier of the UE.

In a ninth implementation form of the method according to the fifth aspect as such or any preceding implementation form of the fifth aspect, the UE identifiers being configured in a higher layer message.

In a tenth implementation form of the method according to the fifth aspect as such or any preceding implementation form of the fifth aspect, receiving the configuration information comprising receiving the UE identifier of the UE, a TPC command associated with a SRS, and SRS configuration information associated with the UE, the SRS configuration information including an indication of a subset of a set SRS port resources and an indication of an association between SRS port resources and downlink port resources.

In an eleventh implementation form of the method according to the fifth aspect as such or any preceding implementation form of the fifth aspect, receiving the indication of the subset comprising receiving a TPC command associated with the UE, and the indication of the subset.

In a twelfth implementation form of the method according to the fifth aspect as such or any preceding implementation form of the fifth aspect, receiving the indication of the subset comprising receiving a TPC command associated with the UE, and the indication of the subset.

In a thirteenth implementation form of the method according to the fifth aspect as such or any preceding implementation form of the fifth aspect, the indications of the UE identifiers being received in a group DCI message.

In a fourteenth implementation form of the method according to the fifth aspect as such or any preceding implementation form of the fifth aspect, the indication of the subset being received in a unicast DCI message.

According to a sixth aspect, a method implemented by a UE is provided. The method comprising receiving, by the UE, from an access node, SRS configuration information, the SRS configuration information comprising associations between SRS ports and downlink ports, and receiving, by the UE, from the access node, an indication of one of the associations between the SRS ports and the downlink ports.

In a first implementation form of the method according to the sixth aspect as such, the SRS ports being SRS port resources indicated as a subset of a set of an ordering of the SRS port resources.

In a second implementation form of the method according to the sixth aspect as such or any preceding implementation form of the sixth aspect, the SRS configuration information being received in a higher layer message.

In a third implementation form of the method according to the sixth aspect as such or any preceding implementation form of the sixth aspect, the indication being received in a group DCI message.

In a fourth implementation form of the method according to the sixth aspect as such or any preceding implementation form of the sixth aspect, the indication being received in a unicast DCI message.

In accordance with one aspect, a method is provided that includes transmitting by the network to the UEs SRS in RRC signaling configuration information of ports, SRS transmission bandwidth, resource sets of SRSs, transmission comb and cyclic shift and further dynamically configuring a portion of the aforementioned (subset of the transmission bandwidth, subset of the SRS resource sets, a particular transmission comb and cyclic shift) using a downlink message.

In accordance with one aspect, a method is provided that includes transmitting by the network to the UE SRS in radio resource control RRC signaling configuration information of possible SRS resources/ports arrangement (distribution, packing, configuration, assignments) and further dynamically configuring a particular SRS resources/ports for each UE using downlink message

In accordance with one aspect, a method is provided that includes transmitting by the network to the UE SRS in radio resource control RRC signaling configuration information of SRS ports and/or CSI-RS transmission ports associated with the SRS ports and further dynamically configuring a particular mapping of the aforementioned relationship using downlink message.

In accordance with one aspect, a method is provided that includes transmitting by the network to the UE SRS in radio resource control RRC signaling configuration information of SRS ports and/or DMRS transmission ports associated with the SRS ports and further dynamically configuring a particular mapping of the aforementioned relationship using downlink message.

In accordance with one aspect, a method is provided that includes receiving by the UE through RRC configuration information. The configuration information includes information regarding the SRS resource sets, SRS transmission bandwidth, SRS ports, SRS transmission comb, cyclic shift and information of a mapping between transmission ports (such as CSI-RS, DMRS) associated with the SRS ports and further dynamically configuring portion of the aforementioned using downlink message

Optionally, in any of the preceding aspects, the downlink message is a DCI message.

Optionally the downlink message is in a Group DCI and the Group DCI format includes fields specific to prescheduled (or scheduled) UEs. The Group DCI has fields specifying the frequency and time resources (resource block groups), the SRS resource set, SRS ports, transmission comb and cyclic shift, CSI-RS associated with the triggered SRS, DMRS associated with the triggered SRS.

Optionally the group DCI has fields to identify the prescheduled (or scheduled) UEs which may be subset of configured (or active UEs)

Optionally the downlink message is DCI format 0_1 or DCI format 1_1 or other DCI formats in 5G NR with modified/added fields that dynamically signal the aforementioned parameters.

According to embodiments, a user equipment (UE) receives control information for a first sounding reference signal (SRS) resource. The control information indicates at least a first frequency resource in a carrier, a frequency-domain shift parameter, a PF value, and a frequency-domain offset value. Based on the control information, the UE transmits the first SRS resource on a first partial frequency sounding resource within the first frequency resource in the carrier. A resource starting physical resource block (PRB) of the first frequency resource is in accordance with the frequency-domain shift parameter. A bandwidth of the first partial frequency sounding resource is based on at least the PF value and a bandwidth of the first frequency resource. A partial frequency sounding resource starting PRB of the first partial frequency sounding resource is based at least on the resource starting PRB of the first frequency resource and the frequency-domain offset value.

In some embodiments, the first frequency resource may be configured with m PRBs. The first partial frequency sounding resource may be configured with m/(the PF value) PRBs in the m PRBs of the first frequency resource. In some embodiments, the partial frequency sounding resource starting PRB of the first partial frequency sounding resource may be the resource starting PRB of the first frequency resource shifted in accordance with the frequency-domain offset value. In some embodiments, the control information may further indicate a hopping parameter. The partial frequency sounding resource starting PRB of the first partial frequency sounding resource may be based on the resource starting PRB of the first frequency resource, the frequency-domain offset value, and a hopping offset value in accordance with the hopping parameter. In some embodiments, the PF value may be one of 2, 4, or 8. In some embodiments, the control information may be received in a radio resource control (RRC) message. In some embodiments, the first SRS resource may be configured in a first SRS resource set including one or more SRS resources, and each SRS resource in the first SRS resource set may be separately configured with a separate frequency resource in the carrier, a separate frequency-domain shift parameter, a separate PF value, and a separate frequency-domain offset value.

According to embodiments, a base station transmits to a user equipment (UE) control information for a first sounding reference signal (SRS) resource. The control information indicates at least a first frequency resource in a carrier, a frequency-domain shift parameter, a PF value, and a frequency-domain offset value. Based on the control information, the base station receives from the UE the first SRS resource on a first partial frequency sounding resource within the first frequency resource in the carrier. A resource starting physical resource block (PRB) of the first frequency resource is in accordance with the frequency-domain shift parameter. A bandwidth of the first partial frequency sounding resource is based on at least the PF value and a bandwidth of the first frequency resource. A partial frequency sounding resource starting PRB of the first partial frequency sounding resource is based at least on the resource starting PRB of the first frequency resource and the frequency-domain offset value.

In some embodiments, the first frequency resource may be configured with m PRBs. The first partial frequency sounding resource may be configured with m/(the PF value) PRBs in the m PRBs of the first frequency resource. In some embodiments, the partial frequency sounding resource starting PRB of the first partial frequency sounding resource may be the resource starting PRB of the first frequency resource shifted in accordance with the frequency-domain offset value. In some embodiments, the control information may further indicate a hopping parameter. The partial frequency sounding resource starting PRB of the first partial frequency sounding resource may be based on the resource starting PRB of the first frequency resource, the frequency-domain offset value, and a hopping offset value in accordance with the hopping parameter. In some embodiments, the PF value may be one of 2, 4, or 8. In some embodiments, the control information may be received in a radio resource control (RRC) message. In some embodiments, the first SRS resource may be configured in a first SRS resource set including one or more SRS resources, and each SRS resource in the first SRS resource set may be separately configured with a separate frequency resource in the carrier, a separate frequency-domain shift parameter, a separate PF value, and a separate frequency-domain offset value.

According to embodiments, a UE receives a control message for transmitting a sounding reference signal (SRS) associated with a data transmission. The UE transmits the SRS on a set of physical resource blocks (PRBs) allocated in accordance with the control message for the data transmission. The set of PRBs allocated for the data transmission is an almost contiguous allocation which includes at least two subset of PRBs with at least one gap PRB between the at least two subset of PRBs. A ratio of a gap size of the at least one gap PRB over a sum of a size of the set of PRBs and the gap size of the at least one gap PRB is less than or equal to a threshold value. After transmitting the SRS, the UE communicates the data transmission on the set of PRBs allocated for the data transmission.

In some embodiments, the transmitting of the SRS on the set of PRBs may be on an OFDM symbol. In some embodiments, the threshold value may be 0.25. In some embodiments, the data transmission may be one of a physical uplink shared channel (PUSCH) data transmission or a physical downlink shared channel (PDSCH) data transmission. In some embodiments, the control message may be a radio resource control (RRC) configuration message, a medium access control (MAC) control element (CE) message, or a downlink control information (DCI) message. In some embodiments, the data transmission may be one of a dynamically scheduled PUSCH or PDSCH, a PDSCH with a semi-persistent scheduling (SPS) configuration, or a PUSCH with a configured grant (CG) configuration.

According to embodiments, a base station transmits to a user equipment (UE) a control message for receiving a sounding reference signal (SRS) associated with a data transmission. The base station receives from the UE the SRS on a set of physical resource blocks (PRBs) allocated in accordance with the control message for the data transmission. The set of PRBs allocated for the data transmission is an almost contiguous allocation which includes at least two subset of PRBs with at least one gap PRB between the at least two subset of PRBs. A ratio of a gap size of the at least one gap PRB over a sum of a size of the set of PRBs and the gap size of the at least one gap PRB is less than or equal to a threshold value. After receiving the SRS, the base station communicates the data transmission with the UE on the set of PRBs allocated for the data transmission.

In some embodiments, the receiving of the SRS on the set of PRBs may be on an orthogonal frequency division multiplexing (OFDM) symbol. In some embodiments, the threshold value may be 0.25. In some embodiments, the data transmission may be one of a physical uplink shared channel (PUSCH) data transmission or a physical downlink shared channel (PDSCH) data transmission. In some embodiments, the control message may be a radio resource control (RRC) configuration message, a medium access control (MAC) control element (CE) message, or a downlink control information (DCI) message. In some embodiments, the data transmission may be one of a dynamically scheduled PUSCH or PDSCH, a PDSCH with a semi-persistent scheduling (SPS) configuration, or a PUSCH with a configured grant (CG) configuration.

According to embodiments, a UE receives control information for a first sounding reference signal (SRS) resource in a carrier. The control information indicates at least a first bandwidth parameter, a frequency-domain shift parameter, a PF value, and a frequency-domain offset value. Based on the control information, the UE transmits the first SRS resource on a first partial frequency sounding resource in the carrier. A bandwidth of the first partial frequency sounding resource is based on at least the PF value and the first bandwidth parameter. A partial frequency sounding resource starting PRB of the first partial frequency sounding resource is based on at least the frequency-domain shift parameter and the frequency-domain offset value.

In some embodiments, the first bandwidth parameter may be configured with m PRBs, and wherein the first partial frequency sounding resource is configured with m/(the PF value) PRBs. In some embodiments, the control information may further indicate a hopping parameter. The partial frequency sounding resource starting PRB of the first partial frequency sounding resource may be based on the frequency-domain shift parameter, the frequency-domain offset value, and a hopping offset value in accordance with the hopping parameter. In some embodiments, the PF value may be one of 2, 4, or 8. In some embodiments, the control information is received in a radio resource control (RRC) message. In some embodiments, the first SRS resource may be configured in a first SRS resource set including one or more SRS resources in the carrier. Each SRS resource in the first SRS resource set may be separately configured with a separate bandwidth parameter, a separate frequency-domain shift parameter, a separate PF value, and a separate frequency-domain offset value.

According to embodiments, a base stations transmits to a user equipment (UE) control information for a first sounding reference signal (SRS) resource in a carrier. The control information indicates at least a first bandwidth parameter, a frequency-domain shift parameter, a PF value, and a frequency-domain offset value. Based on the control information, the base station receives from the UE the first SRS resource on a first partial frequency sounding resource in the carrier. A bandwidth of the first partial frequency sounding resource is based on at least the PF value and the first bandwidth parameter. A partial frequency sounding resource starting PRB of the first partial frequency sounding resource is based on at least the frequency-domain shift parameter and the frequency-domain offset value.

In some embodiments, the first bandwidth parameter may be configured with m PRBs, and wherein the first partial frequency sounding resource is configured with m/(the PF value) PRBs. In some embodiments, the control information may further indicate a hopping parameter. The partial frequency sounding resource starting PRB of the first partial frequency sounding resource may be based on the frequency-domain shift parameter, the frequency-domain offset value, and a hopping offset value in accordance with the hopping parameter. In some embodiments, the PF value may be one of 2, 4, or 8. In some embodiments, the control information is received in a radio resource control (RRC) message. In some embodiments, the first SRS resource may be configured in a first SRS resource set including one or more SRS resources in the carrier. Each SRS resource in the first SRS resource set may be separately configured with a separate bandwidth parameter, a separate frequency-domain shift parameter, a separate PF value, and a separate frequency-domain offset value.

An advantage of the disclosed embodiments is that control information, such as the SRS transmission bandwidth, SRS transmission ports, and SRS resource sets including the SRS transmission comb and cyclic shift, are dynamically signaled for prescheduled (or scheduled) UEs after configuration through higher layer signaling, such as, for example, through radio resource control (RRC) or media access control (MAC) control element (CE) signaling.

Yet another advantage of the disclosed embodiments is that dynamic signaling of the control information does not significantly increase the communications overhead, thereby minimizing the impact on the overall performance of the communications system.

In yet another advantage, the present disclosure associates SRS configured parameters (SRS transmission bandwidth and/or ports) with the Physical Downlink Shared Control Channel (PDSCH) parameters (bandwidth and/or ports) and/or the CSI-RS parameters (bandwidth and/or ports).

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates an example wireless communication system;

FIG. 2 illustrates an example communications system, providing mathematical expressions of signals transmitted in the communications system;

FIG. 3A illustrates a flow diagram of operations occurring in interference probing process according to example embodiments presented herein;

FIG. 3B illustrates available slots 14 TTIs away according to example embodiments presented herein;

FIGS. 4 and 5 illustrate resource block groups (RBGs) and example mapping of SRS resources and ports according to example embodiments presented herein;

FIG. 6 illustrates a diagram of messages exchanged by communicating devices performing interference probing according to example embodiments presented herein;

FIG. 7 illustrates a first example DCI according to example embodiments presented herein;

FIG. 8 illustrates a second example DCI according to example embodiments presented herein;

FIG. 9 illustrates a third example DCI according to example embodiments presented herein;

FIG. 10 illustrates a fourth example DCI according to example embodiments presented herein;

FIG. 11 illustrates a flow diagram of example operations occurring in a UE according to example embodiments presented herein;

FIG. 12 illustrates a flow diagram of example operations occurring in an access node according to example embodiments presented herein;

FIG. 13 illustrates a flow diagram of example operations occurring in an access node configuring uplink SRSs according to example embodiments presented herein;

FIG. 14A illustrates a flow diagram of example operations occurring in a UE transmitting uplink SRSs according to example embodiments presented herein;

FIG. 14B illustrates an example of GC DCI for A-SRS transmissions according to example embodiments presented herein;

FIG. 15A illustrates an example one-shot BiT operation flow according to example embodiments presented herein;

FIG. 15B illustrates one specific example of BiT based on A-SRS triggering with dynamically indicated partial frequency sounding according to example embodiments presented herein.

FIGS. 16A and 16B illustrate communication systems highlighting example interference conditions according to example embodiments presented herein;

FIGS. 17A and 17B illustrate data plots of example BiT performance according to example embodiments presented herein;

FIG. 18 illustrates a diagram of information exchanged between a gNB and a UE as the gNB configures UL SRS sounding and then makes a DL transmission based on the UL SRS sounding results according to example embodiments presented herein;

FIG. 19 illustrates diagrams of RGBs with an example mapping of SRS resources and ports according to example embodiments presented herein;

FIG. 20 illustrates an example of Scenario 1 non-contiguous sounding according to example embodiments presented herein;

FIG. 21 illustrates an example of Scenario 2 non-contiguous sounding according to example embodiments presented herein;

FIG. 22 illustrates an example of Scenario 3 non-contiguous sounding according to example embodiments presented herein;

FIG. 23 illustrates an example of Scenario 4 non-contiguous sounding according to example embodiments presented herein;

FIG. 24B illustrates CCDF for PAPR of Scenario 4 non-contiguous sounding according to example embodiments presented herein;

FIG. 24C illustrates CCDF for PAPR of Scenario 5 non-contiguous sounding Cases 1-3, with the same or different sequences;

FIG. 25A1 is a flowchart of a method for transmitting an SRS based on received control information, according to some embodiments;

FIG. 25A2 is a flowchart of a method for receiving an SRS based on transmitted control information, according to some embodiments;

FIG. 25B1 is a flowchart of a method for transmitting an SRS associated with a data transmission, according to some embodiments;

FIG. 25B2 is a flowchart of a method for receiving an SRS associated with a data transmission, according to some embodiments;

FIG. 25C1 is a flowchart of a method for transmitting an SRS based on received control information, according to some embodiments;

FIG. 25C2 is a flowchart of a method for receiving an SRS based on transmitted control information, according to some embodiments.

FIG. 26 illustrates an example communication system according to example embodiments presented herein;

FIGS. 27A and 27B illustrate example devices that may implement the methods and teachings according to this disclosure; and

FIG. 28 is a block diagram of a computing system that may be used for implementing the devices and methods disclosed herein.

### DETAILED DESCRIPTION OF ILLUSTRATIVE EMBODIMENTS

The structure and use of disclosed embodiments are discussed in detail below. It should be appreciated, however, that the present disclosure provides many applicable concepts that can be embodied in a wide variety of specific contexts. The specific embodiments discussed are merely illustrative of specific structure and use of embodiments, and do not limit the scope of the disclosure.

The configuration of SRS related parameters of a SRS to be transmitted in the uplink (such as SRS transmission ports, SRS transmission bandwidth, SRS resources sets, transmission comb and cyclic shift, etc.) are semi-static in nature and may be provided through higher layer signaling, such as radio resource control (RRC) signaling. A more dynamic technique to signal the configuration is needed to better associate the SRS parameters (such as the SRS transmission bandwidth and/or ports) with the Physical Data Shared Channel (PDSCH) parameters. Moreover, the association between the downlink reference signals, such as Channel State Information Reference Signals (CSI-RS) or demodulation reference signals (DMRS), and the uplink SRS should be conveyed to the UE to accurately reflect the interference situation and perform optimal beamforming. Thus, there is a need for apparatus and methods for signaling control information that accurately indicates a more dynamic configuration (not semi-static) of the aforementioned parameters, such as, for example, a portion of the transmission bandwidth required to transmit a subset of the SRS resource set (thereby implicitly indicating a transmission comb and cyclic shift) using a subset of the transmission ports associated with a particular set of downlink reference signals. The signaling of the control information may be closely tied to an actual data transmission. The transmission of the SRS may be periodic (i.e., periodic SRS, P-SRS or P SRS) as configured by Layer 3 RRC configuration signaling, semi-persistence (i.e., semi-persistent SRS, SP-SRS or SP SRS) activated/deactivated via Layer 2 MAC CE, or aperiodic (i.e., aperiodic SRS (A-SRS or AP-SRS or A SRS or AP SRS)) indicated by Layer 1 DCI in PDCCH.

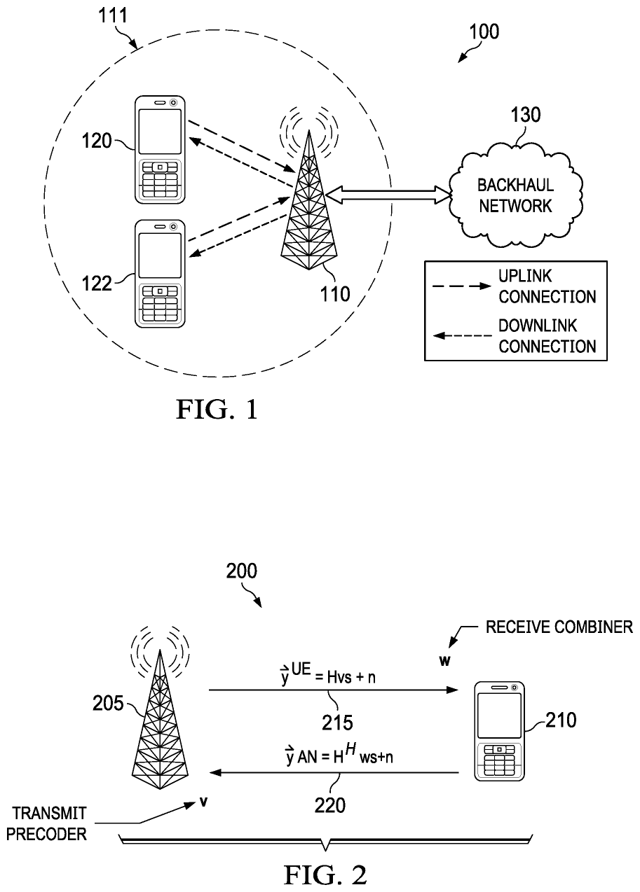

FIG. 1 illustrates an example wireless communication system 100. Communication system 100 includes an access node 110 with coverage area 111. Access node 110 serves a plurality of user equipments (UEs), including UE 120 and UE 122. Transmissions from access node 110 to a UE is referred to as a downlink (DL) transmission and occurs over a downlink channel (shown in FIG. 1 as a solid arrowed line), while transmissions from a UE to access node 110 is referred to as an uplink (UL) transmission and occurs over an uplink channel (shown in FIG. 1 as a dashed line). Services may be provided to the plurality of UEs by service providers connected to access node 110 through a backhaul network 130, such as the Internet. The wireless communication system 100 may include multiple distributed access nodes 110.

In a typical communications system, there are several operating modes. In a cellular operating mode, communications to and from the plurality of UEs go through access node 110, while in device to device communications mode, such as proximity services (ProSe) operating mode, for example, direct communication between UEs is possible. Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, relays, customer premises equipment (CPE), and so on. UEs may also be commonly referred to as mobile stations, mobiles, terminals, users, subscribers, stations, communication devices, CPEs, relays, Integrated Access and Backhaul (JAB) relays, and the like. It is noted that when relaying is used (based on relays, picos, CPEs, and so on), especially multihop relaying, the boundary between a controller and node controlled by the controller may become blurry, and a dual node (either the controller or the node controlled by the controller) deployment where a first node that provides configuration or control information to a second node is considered to be the controller. Likewise, the concept of UL and DL transmissions can be extended as well.

A cell may include one or more bandwidth parts (BWPs) for UL or DL allocated for a UE. Each BWP may have its own BWP-specific numerology and configuration. It is noted that not all BWPs need to be active at the same time for the UE. A cell may correspond to one or more carriers. Typically, one cell (a primary cell (PCell) or a secondary cell (SCell), for example) is a component carrier (a primary component carrier (PCC) or a secondary CC (SCC), for example). For some cells, each cell may include multiple carriers in UL, one carrier is referred to as an UL carrier or non-supplementary UL (non-SUL) UL carrier which has an associated DL, and other carriers are called a supplementary UL (SUL) carriers which do not have an associated DL. A cell, or a carrier, may be configured with slot or subframe formats comprised of DL and UL symbols, and that cell or carrier is seen as operating in time division duplexed (TDD) mode. In general, for unpaired spectrum, the cells or carriers are in TDD mode, and for paired spectrum, the cells or carrier are in a frequency division duplexed (FDD) mode. Access nodes may provide wireless access in accordance with one or more wireless communication protocols, e.g., long term evolution (LTE), LTE advanced (LTE-A), 5G, 5G LTE, 5G NR, High Speed Packet Access (HSPA), Wi-Fi 802.11a/b/g/n/ac, etc. While it is understood that communications systems may employ multiple access nodes capable of communicating with a number of UEs, only one access node, and two UEs are illustrated for simplicity.

In standard antenna element to element channel estimation, a channel between two devices is estimated by having a first device transmit a known signal on a known time or frequency resource (s) to a second device, the received signal at the second device is expressible as:

y=Hx+n (1)

where y is the received signal at the second device, x is the known signal (which may be a reference signal, a pilot, or a pilot signal), H is the channel model or response, and n is the noise (and interference for some communication channels). Because x is known by the second device, it is possible for the second device to determine or estimate H from y.

It is noted that the concept of antenna, antenna element, and antenna port may be generally interchangeable, but in some specific scenarios, they can mean different but related subjects. For example, one transmit (Tx) antenna port may be formed (or virtualized) by multiple antenna elements or antennas, and the receiver sees only the one Tx antenna port but not each of the multiple antenna elements or antennas. The virtualization may be achieved via beamforming, for example.

FIG. 2 illustrates an example communications system 200, providing mathematical expressions of signals transmitted in the communications system. Communications system 200 includes an access node 205 communicating with UE 210. As shown in FIG. 2, access node 205 is using a transmit filter v and UE 210 is using a receive filter w. Both access node 205 and UE 210 use linear precoding or combining. Assuming H is Nᵣₓ×Nₜₓ matrix of a MIMO system, i.e., there are Nₜₓ transmit antennas and Nᵣₓ receive antennas. The transmit filter v of dimension Nₜₓ×Ns enables the transmitter to precode or beamform the transmitted signal, where Ns is the number of layers, streams, symbols, pilots, messages, or known sequences transmitted. The receive filter w of multi-antenna systems is of dimension Nᵣₓ×Ns and represents the combining matrix. It is noted that the above description is for a transmission from access node 205 to UE 210, i.e., a downlink transmission. The transmission may also occur at the reverse direction (an uplink transmission), for which the channel matrix becomes H^{H}, which is the Hermitian of channel model H, and w may be seen as the transmit filter and v as the receiver filter. The w for transmission and the w for reception may or may not be the same, and likewise for v.

A downlink (or forward) channel 215 between access node 205 and UE 210 has channel model or response H, while an uplink (or backward, or reverse) channel 220 between UE 210 and access node 205 has channel model or response H^{H}, which is the Hermitian of channel model H. Although FIG. 2 depicts only one access node and one UE, it is not limited to this case. Multiple UEs may be served by the access node, on different time-frequency resources (such as FDM-TDM, as in typical cellular systems) or on the same time-frequency resources (such as MU-MIMO, wherein multiple UEs are paired together and each UE is individually precoded). Among the paired UEs, there is intra-cell interference. Also multiple access nodes may exist in the network, some of which may be cooperatively serving UE 210 in a joint transmission fashion (such as coherent joint transmission, non-coherent joint transmission, coordinated multipoint transmission etc.), dynamic point switching fashion, and so on. Some other access nodes may not serve UE 210 and their transmissions to their UEs cause inter-cell interference to UE 210. The scenario of multiple access nodes and multiple UEs, with access node cooperation to serve a UE and with MU-MIMO, is a scenario considered and analyzed herein, and the example embodiments of bi-directional training applies to this scenario.

In Release-17, incorporated herein by reference, further enhanced multiple-input multiple-output (FeMIMO) SRS enhancement WID includes enhancement on SRS, targeting both frequency range 1 (FR1) and frequency range 2 (FR2). The enhancement may include identifying and specifying enhancements on aperiodic SRS triggering to facilitate more flexible triggering and/or DCI overhead/usage reduction; specifying SRS switching for up to 8 antennas (e.g., xTyR, x={1, 2, 4} and y={6, 8}); and evaluating and, if needed, specifying the following mechanism(s) to enhance SRS capacity and/or coverage: SRS time bundling, increased SRS repetition, partial sounding across frequency.

Motivations for flexible triggering include limited triggering info in DCI (1, 2, or 3 bits only); inflexible triggering delay; important roles of SRS in DL full MIMO CSI acquisition, BM, UL frequency diversity and MIMO support, etc.; important roles of A-SRS in TDD cooperative MIMO via DL interference probing and mitigation, including: UE to Tx SRS according to DL (pre-)scheduling results so that gNB can estimate DL interference and then mitigate DL interference via precoder adjustment, some similarity with DL NZP CSI-RS based interference probing for better MCS. This is also after scheduling and before PDSCH, but with UL SRS for better precoding (hence bi-directional training (BiT)); and closely related to SRS coverage/capacity enhancements.

According to an example embodiment, precoded, unprecoded, or both precoded and unprecoded uplink SRSs are transmitted by UEs to access nodes to assist in dynamic scheduling. These uplink SRSs include specific transmission parameters (such as specific transmission ports, transmission comb, cyclic shift, transmission bandwidth (related to the SRS resources), etc.) that may be configured through higher layer signaling (such as through radio resource control (RRC) or media access control (MAC) control element (CE) signaling, for example). In some cases, the uplink SRS may be unprecoded to support uplink channel estimation and assist the network in prescheduling. Upon performing uplink channel estimation, the network preschedules UEs. The prescheduling of UEs may involve a selection of UEs from a plurality of UEs configured by the access node, where the selected UEs comprise UEs that are suitable for receiving (or transmitting) data. Hence, the selected UEs comprise a subset of the plurality of UEs configured by the access node. The selected UEs may be referred to as prescheduled UEs. The suitability of a UE may be determined based on factors such as channel quality, signal quality, error rate, data transfer history, quality of service restrictions, etc.

The prescheduling of UEs may precede an actual scheduling required for a data transmission (or reception) and the actual data transmission (or reception). In general, scheduling is not predictable. That is, the number of UEs and which subset of UEs selected for prescheduling are not known during higher layer configuration. Therefore, after prescheduling, the network may decide to re-configure the semi-static configured SRS parameters based on the subset of UEs chosen in prescheduling. As such, apparatus and methods supporting a more dynamic configuration of control signals are needed.

Interference probing and prescheduling may be performed by the network after UEs transmit the uplink SRS. As described previously, prescheduling is a process where the access node selects a subset of the UEs, which the access node has configured, for data transmission or reception. The selected UEs may be configured to transmit precoded SRSs. These precoded SRSs may be referred to as triggered SRSs. The access node may use the precoded SRSs to determine a downlink precoder (referred to as transmit filter v above). The prescheduling may precede the actual scheduling for data transmission (or reception) and may be performed during a training phase (such as for example during bi-directional training (BiT)) to determine the downlink precoder (and combiners).

BiT, also known as forward-backward training, is a generally distributed training procedure with low computational complexity that is used to train and update transmit precoders and receive combiners without explicitly estimating the CSI. BiT may adapt transmit beamformers, which may also be commonly known as transmit precoders, transmission filters, spatial transmission filters, transmit filter, analog precoder, and the like and receiver combiners (which are also commonly known as receive filter, spatial receive filters, analog combiner, and the like) in TDD MIMO communications systems. In BiT, neither device (a transmitting device or a receiving device) participating in BiT may have a priori knowledge of CSI, especially detailed information about the channel such as channel matrix H or covariance matrix of the channel, wherein the channel may be one between a UE and its serving access node(s) or one between a UE and its interfering access node(s) (which generally requires information exchanges among access nodes, such as channel information about an interfering link or RS information so that the UE or access node can estimate the interfering link). An iterative form of BiT consists of forward training (e.g., in a downlink direction) and backward training (e.g., in an uplink direction) that is repeated until convergence is achieved. A one-shot BiT comprises a single forward training step and a single backward training step. BiT is capable of adapting to unknown interference and can suppress interference without any channel estimation or CSI feedback, thereby making BiT less sensitive to the orthogonality of training sequences. A more detailed discussion of BiT is presented in co-assigned patent application entitled “System and Method for Communications System Training,” application Ser. No. 15/983,692, filed May 18, 2018, which is hereby incorporated herein by reference in its entirety.

Uplink probing involves the estimation of uplink channels between the access node and UEs served by the access node after reception of the uplink SRS, which reflects the interference situation at neighboring cells.

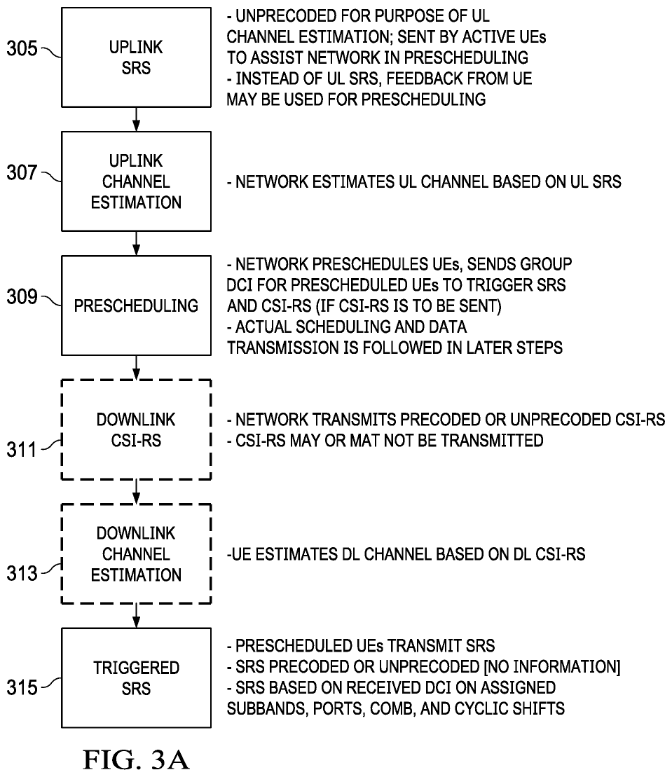

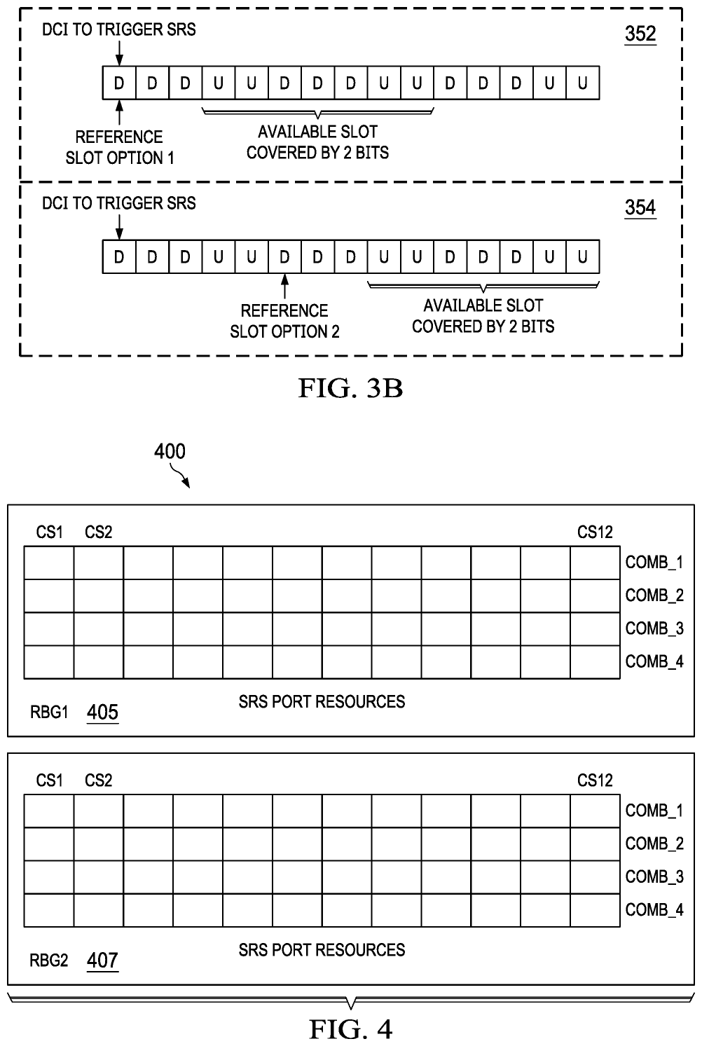

FIG. 3 illustrates a flow diagram of operations 300 occurring in an interference probing process. Operations 300 may be indicative of operations occurring in an interference probing process involving an access node and one or more UEs.

Operations 300 begin with the one or more UEs transmitting uplink SRSs (block 305). The uplink SRSs may be transmitted by active UEs that are configured by the access node, and may be used for uplink channel estimation of the uplink channels between the configured UEs and the access node. In addition to being used for uplink channel estimation, the uplink SRSs may be used by the access node to select UEs for prescheduling. As discussed previously, prescheduled UEs are UEs selected by the access node, from of its configured UEs, to transmit trigger based uplink SRSs, which are used by the access node to determine downlink precoders. In an embodiment, the uplink SRSs transmitted by the UEs in block 305 may be unprecoded. In an embodiment, instead of the uplink SRSs, feedback transmitted by the UEs is used by the access node to select UEs for prescheduling. The access node performs uplink channel estimation (block 307). The estimation of the uplink channels is performed using the uplink SRSs transmitted by the UEs, for example. Alternatively, the estimation of the uplink channels is performed using the feedback transmitted by the UEs.

The access node preschedules the UEs (block 309). The access node may preschedule UEs based on the uplink SRSs or feedback received from the UEs. As an example, the access node selects the UEs associated with the uplink SRS (or feedback) received with highest signal quality measure. Examples of signal quality measures include SINR, SNR, RSRP, RSRQ, received signal power, and so on. The access node may select the UEs associated with uplink SRSs received with signal quality measures that exceed a specified threshold. The specified threshold may be specified in a technical standard, an operator of the communication system, or through collaboration between the access node and the UEs, for example. The access node may select a specified number of UEs associated with uplink reference signals received with signal quality measures that exceed a specified threshold. The specified number may be specified in a technical standard, an operator of the communication system, or through collaboration between the access node and the UEs, for example. As an example, the access node may preschedule UEs based on the channel quality indicator (CQI) of the uplink channels, or the precoding matrix indicator (PMI) associated with the UEs. The access node transmits downlink control information, e.g., in a DCI, intended for the prescheduled UEs to trigger SRS transmission with specific parameters and to assist UEs in the measurement (e.g., use) of the downlink ports. The downlink control information may provide to the prescheduled UEs the SRS parameters, as well as related downlink associations. In other words, the downlink control information configures the SRS parameters and the related downlink associations. The downlink control information may indicate to the prescheduled UEs which of the downlink CSI-RS are assigned to the prescheduled UEs for proper measurement and determination of downlink combiner and/or uplink precoder. In an embodiment, the DCI may be a group based DCI addressing a group of UEs (e.g., all of active UEs or a subset of active UEs). In another embodiment, the DCI may be a unicast DCI (such as 5G NR DCIs) addressed to a UE. The DCI (in either case) includes modified or added fields that signal the SRS parameters. The access node may transmit CSI-RSs (block 311). The CSI-RSs (if the access node is to transmit the CSI-RSs) may be transmitted in a precoded or unprecoded manner. The UEs may perform downlink channel estimation (block 313). In situations where the access node transmits the CSI-RSs, the UE performs downlink channel estimation in accordance with the received CSI-RSs. In an embodiment, only the UEs that received the downlink control signals (i.e., the prescheduled UEs) perform downlink channel estimation.

The prescheduled UEs transmit triggered uplink SRSs (block 315). The prescheduled UEs transmit the uplink SRSs as configured by the downlink control signals. In an embodiment, the uplink SRSs are precoded or are unprecoded (with no information contained therein). The uplink SRSs are transmitted in accordance with the SRS configuration. As an example, a prescheduled UE transmits its uplink SRS in configured SRS resources, over configured transmission ports, using configured subbands, combs, and cyclic shifts, and with configured transmission bandwidth, as configured by the downlink control signals.

The configuration of the SRS parameters such as the SRS resource sets (SRS resources within a set), SRS transmission bandwidth, SRS transmission ports, SRS transmission comb and cyclic shift, etc., may be performed using higher layer configuration. Arrangements of SRS resources or ports may be defined by the network and the network may configure the UEs with the different arrangements. In addition, the network may configure the UEs with a different mappings (e.g., relationships, associations) between downlink ports, layers, reference signals (such as DMRS, CSI-RS), and uplink port or layers (SRS).

A key to support BiT and various SRS enhancements is to increase the flexibility of A-SRS triggering, for at least the following motivations, in addition to the BiT related motivations. That is, the flexible A-SRS triggering may be designed and used beyond BiT applications. For example, the design to support BiT can also be used for the special case of ZF without any inter-cell cooperation such as semi-static coordination. A-SRS can be used to probe DL channel/interference for the paired UEs within a cell. That is, a UE transmits A-SRS on the PRBs indicated by the network which are to be used for PDSCH, and the network adjust PDSCH precoding based on these partial bandwidth A-SRS, instead of based on P/SP SRS sent by UE regularly to cover the entire wideband and with longer periodicity in typical ZF schemes. Traditional ZF is based on P/SP SRS in general. The SRS has to cover the wideband (with or without hopping), and all active UEs have to sound. Therefore, the periodicity of P/SP SRS cannot be small for all UEs; otherwise, the SRS would lead to significant overhead. In fact, when ignoring the inter-cell interference (or the covariance matrix for inter-cell interference), the above scheme reduces to single-cell massive MIMO, i.e., ZF, except that the sounding used for ZF is based on A-SRS whose frequency-domain resources, ports, and beamforming are tied to the PDSCH. Only UEs to be scheduled with PDSCH in the next few TTIs will transmit A-SRS. The A-SRS PRBs, ports, and beamforming are the same as the prospective PDSCH. The A-SRS is used by the network to adjust ZF precoders for the PDSCH. Therefore, the aging of A-SRS will not exceed few TTIs, which ensures high accuracy of the precoding/beamforming leading to high SE. With these A-SRS, the P/SP SRS periodicity can be increased, reducing the overall SRS overhead. The A-SRS based ZF with DL interference probing without any inter-cell coordination hence can perform better than P/SP-SRS based ZF in terms of beamforming accuracy, interference suppression, and reduced overhead. The key standard component needed to support this enhancement is still flexible A-SRS triggering, similar to BiT.

### Limited Triggering Information in Existing DCIs (1, 2, or 3 Bits Only)

SRS transmissions are associated with many parameters, such as comb, cyclic shift, transmission bandwidth in terms of the number of PRBs, on UL or SUL of a serving cell, antenna port(s), etc. In existing standards, A-SRS can be triggered via a SRS request field in a DCI, and the field may include 1, 2, or 3 bits. These bits can indicate 1) certain indicated SRS resource set(s) of the current serving cell, or 2) SRS resource set(s) on certain indicated serving cells, or 3) one of the UL and SUL. However, many other SRS transmission parameters cannot be indicated in DCI and can only be specified in RRC configuration signaling. For example, because of the DCI bitwidth limitation, the network may have to configure a few SRS resource sets together or configure a few serving cells together, i.e., these sets have to be triggered together, which is highly undesirable. In general, the limited triggering information leads to lack of flexibility in many applications as outlined below, and hence it is desired to improve the A-SRS triggering flexibility.

### Lack Flexibility in Triggering Offset (Delay)

In existing standards, A-SRS triggering offset is configured via RRC field slotOffset of 1-32 slots, and if this field is not configured, then 0 slot offset is applied. This can be limiting in several cases. For example, when using the group-common (GC) DCI format 2_3 to trigger SRS for a group of UEs on one or more of their serving cells, all the SRS transmissions are to occur after their pre-configured offsets with respect to the same DCI triggering slot. This may impose significant restriction on network's decision on which slot to send the GC DCI. For another example, SRS triggering by a DL DCI is likely to collide with the A/N associated with the DL DCI, and SRS triggering by a UL DCI is likely to collide with the PUSCH associated with the UL DCI, especially in TDD when the UL slots occur less often. In general, the main purpose of A-SRS triggering is to provide flexibility in SRS timing, but the pre-determined timeline in the triggering offset along with the mostly fixed slot structure cannot serve that purpose well. Enhancements are needed.

### Various Important Roles of A-SRS

A-SRS plays important roles in TDD DL full MIMO CSI acquisition, TDD/FDD UL CSI acquisition, FR2 beam management, frequency-selective scheduling, UL TA maintenance, positioning, etc. As also considered and analyzed in this disclosure, it is also crucial for FDD DL performance. However, the lack of flexibility described above in SRS triggering limits the usefulness of SRS. For instance, if SRS is dropped due to collisions caused by inflexibility in triggering offset described above, then CSI acquisition and frequency-selective scheduling may be impacted. Note that CSI acquisition and frequency-selective scheduling can be highly dynamic and therefore P/SP-SRS are not suitable. In LTE Rel-14 SRS carrier-based switching, autonomous A-SRS retransmission is introduced so that a dropped A-SRS triggered by a DL DCI (i.e., colliding with A/N) would be autonomously retransmitted in the next configured SRS transmission occasion, but this feature is not yet supported in 5G NR. To make P/SP-SRS and A-SRS well complement each other, P/SP-SRS can be configured with long periodicities (to avoid excessive overhead and complexity) and the network relies on A-SRS for fast response to traffic load and CSI (especially dynamic interference). Therefore, flexible A-SRS triggering can be beneficial in many cases due to various important roles played by A-SRS and should be supported.

### Tightly Related to SRS Capacity/Coverage Enhancements:

SRS coverage/capacity enhancements may include, but not limited to: 1) SRS capacity enhancement via SRS on partial bandwidth, for which the bandwidth may be dynamically indicated via DCI; 2) SRS capacity enhancement via SRS on unused PRBs/symbols in PUSCH/PDSCH region, for which the SRS time-frequency resources may be dynamically indicated via DCI on the fly based on unused resources of a TTI; 3) SRS capacity enhancement via SRS multiplexed (on the same symbol) with other signals, e.g., A/N, to accommodate flexible SRS multiplexing to maximize SRS capacity; 4) SRS coverage enhancements via narrow-band transmission based on frequency selectivity (rather than pre-configured PRBs), and so on. Some of the enhancements are also applicable to P/SP-SRS. However, especially for capacity enhancement, the SRS needs to have sufficient flexibility (e.g., when the network identifies a chance for A-SRS to opportunistically fill a gap in time-frequency resources (e.g., an unoccupied symbol in a slot, a few unoccupied PRBs, etc.), it would trigger the UE to perform the A-SRS). Therefore, flexible triggering of A-SRS can be also useful to SRS capacity/coverage enhancements.

How the flexible A-SRS triggering should be designed highly depends on the target use cases for flexible A-SRS triggering. It is important to revisit the target use cases for flexible A-SRS triggering. A key question to be resolved here is why flexible A-SRS, as opposed to P/SP-SRS, is needed (i.e., what operations are reasonable for the time scale of A-SRS and what are not). With the target use cases clearly identified, the design proposed in the remainder of this section may be based on that the clarified use cases are assumed.

### Primary Target Use Cases: Flexible A-SRS for Data-Specific CSI Acquisition (CSI Acquisition for a Linked PUSCH/PDSCH)

Though SRS has been used for CSI acquisition, it is generally not linked to a specific data transmission, and thus it needs to cover the entire wideband. However, SRS can also be used for CSI acquisition linked to a specific PUSCH/PDSCH transmission (as opposed to for generic CSI acquisition), especially for interference information acquisition for that linked PUSCH/PDSCH transmission. This should be where flexible A-SRS is primarily and most frequently used. Data scheduling, CSI associated with the data transmission, interference seen by a data transmission, and interference caused by a data transmission are all generally in the TTI time scale. To support these operations, flexible A-SRS is required.

Note that the linkage between the flexible A-SRS and the linked PUSCH/PDSCH may or may not be made aware of to the UE.

Secondary Target Use Cases: Flexible A-SRS for Fast Action/Response to an Event Once in a while

Flexible A-SRS as a fast response to an event may be needed once in a while. The events may include SCell activation, a potential collision of SRS with other transmissions by the same UE, a different UE in the same cell, or a different UE in a neighboring, coordinating cell.

For example, when a SCell is activated, it may be desirable to transmit a flexible A-SRS as a fast reaction rather than waiting for some TTIs.

For another example, the gNB plans to trigger an A-SRS, but it finds that A-SRS according to RRC configuration may be in collision with another transmission in time domain, frequency domain, or cyclic shift. Then with flexible A-SRS enhancements, the gNB has the choice to temporarily adjust the A-SRS slot offset, symbol position, frequency domain allocation, comb and shift, and cyclic shift for collision avoidance.

This is actually related to SRS capacity enhancement. Generally, for SRS capacity enhancement, additional resources can be allocated to SRS, but SRS with pre-configured parameters may lack sufficient flexibility to utilize the additional resources. Hence, SRS capacity enhancement requires flexible A-SRS.

These events are not expected to occur all the time (should be much less often than data scheduling). Therefore, they may be considered as secondary target use cases.

### Other Cases for Flexible A-SRS

Other than the primary/second target use cases listed above, most other cases may not be well motivated for flexible A-SRS; at least P/SP-SRS and/or legacy A-SRS may work generally fine. These may include SRS for maintaining a connection, for coverage purpose, for power saving purpose, etc.

To summarize, flexible A-SRS design should be targeted for CSI acquisition for linked PUSCH/PDSCH and fast response to a dynamic event. The disclosed design for flexible A-SRS enhancements is based on this understanding.

In order to effectively convey information about dynamic interference conditions to the network, a gNB can indicate to UEs how the SRS should be transmitted, including the time/frequency resource allocation and port selection for the SRS corresponding to the prospective PDSCH. This means that the network needs to dynamically adjust more SRS transmission parameters (PRB allocations, port selection) than with conventional SRS transmission. Embodiments are provided for SRS transmission with parameters tied to DL transmission, including PRB allocation and port allocation.

An embodiment is for indication of A-SRS PRB/port allocation. The SRS PRB/port allocation should be the same as the prospective PDSCH and should be dynamically indicated.

An embodiment is for A-SRS beamforming indication. The SRS beamforming can be based on DL channel measurement resources (CMR), and to better reflect potential DL interference, it is more desirable to be based on DL CMR and interference measurement resources (IMR), one or both of which may be dynamically indicated. An embodiment is for A-SRS triggering offset. To utilize A-SRS to estimate interference for interference mitigation via precoding adjustment, the gNBs do not need to detect each UE's SRS sequences. Received SRS power accumulated on each gNB receiving antenna port should be sufficient. Thus, the A-SRS can be transmitted on overlapping resources to reduce overhead. However, the A-SRS triggers may be sent to different UEs at different times. To enable A-SRS overlap, A-SRS triggering offsets may be dynamically indicated to different UEs. The triggering offset may be similar to the k0 and SLIV (i.e., TDRA) design for PDSCH. To further reduce overhead, k0 and SLIV may not refer to the absolute slot/symbol offsets but slot/symbol offsets based on configured SRS slots/symbols. The TDRA overhead may be further reduced not to indicate the slot, for example, but just the symbol. The TDRA for SRS may be omitted in DCI and based on RRC/MAC.

The time-domain resources that can be used by A-SRS are first clarified. Based on the time-domain resources that can be used by A-SRS, based on the trigger offset design and indication is then discussed.

The time-domain resources that can be used by A-SRS with flexible triggering may be defined to avoid potential ambiguity. For example, An Alternative 1 delays the A-SRS transmission to a next “available” slot, but if the network and UE interpret the “available” slot differently, errors can occur. Possible A-SRS time-domain resources may comprise the time-domain resources on which SRS transmissions are not precluded, such as all the slots and OFDM symbols not configured as DL by RRC configuration. In other words, possible A-SRS time-domain resources may be the set of potential A-SRS transmission opportunities in time domain. For instance, all the slots and OFDM symbols that are for UL or flexible according to TDD-UL-DL-ConfigCommon or TDD-UL-DL-ConfigDedicated may be considered as possible A-SRS time-domain resources. For another instance, all the slots and OFDM symbols, regardless of whether they are configured as DL, UL, or flexible, may be considered and analyzed as possible A-SRS time-domain resources. The former approach may have the advantages such as reduced overhead for triggering offset indication (since the indication may need to refer to a subset of the slots/symbols as opposed to all slots/symbols), but it may have a major disadvantage that the determination of whether a slot/symbol is DL, UL, or flexible may be complicated and may also change over time, which may lead to confusion. On the other hand, the latter approach may require more bits to cover the same time duration, or same bits but covering shorter time duration, but it significantly simplifies the design. In case that a slot/symbol's transmission direction is overwritten by a DCI, no ambiguity would arise from the latter approach. The latter approach provides the same A-SRS time-domain resources for FDD and TDD, which is advantageous for cases that both FDD and TDD are aggregated. The latter approach can also enable some unused DL slots/symbols to be potentially used for A-SRS with proper UL/DL switching gaps, which further improves the triggering flexibility of A-SRS. Therefore, in an embodiment, all slots/symbols are specified as possible A-SRS time-domain resources. For either approach, if the numerology changes between the received DCI and the A-SRS transmission, the A-SRS is dropped.

When explicitly or implicitly indicating the time-domain resources allocated to a flexible A-SRS, the resource allocation granularity also may be defined. For example, the resource indication in the DCI could be slot-based, in which case the OFDM symbols to be used by the A-SRS are based on RRC configuration, i.e., the DCI can flexibly indicate in which slot the A-SRS is to be transmitted (such as 2 slots later than the current DCI slot) but does not provide symbol information (provided in RRC, for instance, to reduce DCI overhead). For another example, the DCI indication could be mini-slot (non-slot) based, such as on the 5^{th} mini-slot of the 2^{nd} slot after the current DCI slot, or on the 10^{th} mini-slot after the current DCI mini-slot. This may be especially useful for URLLC which already operates with mini slots. For yet another example, the DCI indication could be OFDM symbol based, such as on the 10^{th} symbol of the 2^{nd} slot after the current DCI slot, or on the loth symbol after the current DCI symbol. Generally, finer granularity requires higher indication overhead, but offers more flexibility.

Additionally, the reference time (starting point) of the triggering offset is clarified. One way is to define the starting point as the current DCI slot/mini-slot/symbol; note that generally the reference time granularity should be consistent with the A-SRS time-domain resource allocation granularity. Other ways may also be considered and analyzed, such as relative to the current DCI slot plus the slotoffset if already configured by RRC, or relative to the next flexible/UL slot/symbol. If the granularity is slot, then the current DCI slot is considered as the reference time (slot 0) for A-SRS triggering offset. If the granularity is mini-slot, then the mini-slot immediately after the current DCI mini-slot is considered as the reference time (mini-slot 0) for A-SRS triggering offset. If the granularity is symbol, then the symbol immediately after the last symbol of the current DCI is considered as the reference time (symbol 0) for A-SRS triggering offset. If the A-SRS is for CSI acquisition for a specific UL/DL data transmission, the A-SRS time may be relative to (before) the association data transmission (for URLLC, etc.). In general, the design can be readily extended to cases where the triggering offset is relative to a reference timing, and the reference timing may be specified in a standard, a RRC configuration, a MAC signaling, or a DCI field (e.g., indicating a slot/symbol).

Therefore, the following designs, and combinations of them are also possible. For flexible granularity is slot, then the current DCI slot may be considered as the reference time (slot 0) for A-SRS time-domain resources and triggering offset.

For flexible A-SRS time-domain resources, Option A1 may be on all slots/OFDM symbols configured not for DL in TDD-UL-DL-ConfigCommon or TDD-UL-DL-ConfigDedicated. Option A2 may be on all slots/OFDM symbols.

For flexible A-SRS time-domain resource allocation, if the granularity Option B1 may be based on slots, Option B2 may be based on slots and is mini-slots, and Option B3 may be based on slots and OFDM symbols.

For flexible slot, then the mini-slot immediately after the current DCI mini-slot may be considered as the reference time (mini-slot 0) for A-SRS triggering offset reference point. In Option C1, the reference point is based on the current DCI's slot/mini-slot/. If the granularity is symbol, in Option C2, the symbol immediately after the last symbol 0f the current DCI may be considered as the reference point is based on the current DCI's slot plus slot offset if configured time (symbol 0) for A-SRS triggering offset.

If the A-SRS is for CSI acquisition for a specific UL/DL data transmission, the A-SRS time may be relative to (e.g., before) the association data transmission (for URLLC, etc.). If the A-SRS is jointly with data, then the slot before the data with UL symbols available for the SRS could be the reference time. These may require a negative A-SRS triggering offset to be needed in some case. In Option C3: the reference point is based on the next UL/flexible slot/symbol.

When combining the different options, generally some consistency should be adopted. For example, if Option A2 based on symbols are considered, then Option B3 based on symbols should be used, and Option C3 based on symbols should be used. Similarly, they may be all based on mini-slots, slots, etc.

With the above clarified, A-SRS triggering offset indication design is explained next. The following alternative are described.

Alternative 1: Delay the SRS Transmission to an Available Slot Later than the Triggering Offset Defined in Current Specification, Including Possible Re-Definition of the Triggering Offset

There are at least several cases that delaying the SRS transmission to a next transmission opportunity would be useful. For example, when using the group-common (GC) DCI format 2_3 to trigger SRS for a group of UEs on one or more of their serving cells, all the SRS transmissions are to occur after their pre-configured offsets with respect to the same DCI triggering slot. This may impose significant restriction on network's decision on which slot to send the GC DCI. For another example, SRS triggering by a DL DCI is likely to collide with the A/N associated with the DL DCI, and SRS triggering by a UL DCI is likely to collide with the PUSCH associated with the UL DCI, especially in TDD when the UL slots occur less often. In LTE Rel-14 SRS carrier-based switching, autonomous A-SRS retransmission is introduced so that a dropped A-SRS triggered by a DL DCI (i.e., colliding with A/N) would be autonomously retransmitted in the next configured SRS transmission occasion, and design along this line can provide more opportunities for the dropped A-SRS to be transmitted later. With the A-SRS time-domain resources and granularity clarified, the A-SRS in collision with another transmission may be autonomously delayed to the nth transmission opportunity, e.g., the nth slot/mini-slot/symbol within the A-SRS time-domain resources with n>0, and if the resources on the nth transmission opportunity are not occupied by other transmission with equal or higher priority, the A-SRS may be transmitted there, but if the resources are occupied by other transmission with higher priority, the A-SRS shall not be transmitted there (which may be further delayed or dropped). Some rules may be specified to drop the A-SRS, such as a maximum time duration in terms of milliseconds or slots, a maximum number of delaying operations (i.e., trials), having to be before a certain slot (e.g., before the next slot, which is an intra-slot delay for low latency purpose), etc.

Closely related to this issue is the priority of flexible A-SRS. At least for some cases, the A-SRS may be treated with higher priority and should not be dropped in the first place. The higher priority may be explicitly assigned by the network with a priority flag, or implicitly assigned if the A-SRS is associated with a URLLC transmission or a specific data transmission (e.g., the A-SRS is for interference probing of a specific data transmission, as opposed to generic CSI acquisition purpose).

Regarding the re-definition of the triggering offset, a few options may be considered and analyzed, which also depends on how the A-SRS time-domain resources are specified. The triggering offset may be indicated as a slot offset and symbol position(s), similar to the k0 and SLIV design for PDSCH or the k2 and SLIV design for PUSCH. To further reduce overhead, k0, k2, and SLIV may not refer to the absolute slot/symbol offsets but slot/symbol offsets within the A-SRS time-domain resources. If the indicated A-SRS symbol length is longer than the RRC-configured A-SRS symbol length, the A-SRS may repeat, hop, or split in time domain to fill up the indicated symbols. Further details of splitting will be covered below. The indicated A-SRS symbols may also cross the slot boundary and go into the next slot if the indicated symbol length spans into the next slot, similar to existing PUSCH design. If the numerology is changed across the slot boundary, the A-SRS on the next slot may be cancelled. Generally, the UL/DL TDRA field design can be reused/enhanced for A-SRS triggering offset indication.

### Alternative 2: Indicate Triggering Offset in DCI Explicitly or Implicitly

To explicitly indicate a triggering offset, the A-SRS triggering DCI can be added with a triggering offset field, or more general, a UL/DL TDRA field may be reused or enhanced for A-SRS.

An implicit triggering offset may be the next SRS transmission opportunity within the A-SRS time-domain resources. That is, the UE can autonomously look for the next chunk of A-SRS time-domain resources that is available to transmit all the configured or indicated A-SRS symbols. This design may be seen as autonomous delaying and combined with the explicit triggering offset approach. For example, if a SRS TDRA field is absent, or the SRS TDRA indicated symbols are occupied, the UE will autonomously find the next available opportunity to transmit SRS. This mode of operation may be enabled/disabled by a flag in RRC (similar to LTE Rel-14 design of soundingRS-FlexibleTiming configuration) or in DCI. The UE may start to search from the DCI-carrying slot, but if a slotoffset value is configured in RRC and/or indicated by DCI, the UE may search from the slot with the configured/indicated offset. In an embodiment, if the reference slot (based on the DCI-carrying slot, and optionally also the RRC configured slotoffset; see below for further embodiments) is slot n, and the DCI indicates a slotoffset t, then the UE starts to search from slot n+t. If slot n+t is an available slot (see below for further embodiments) for the indicated A-SRS, then the UE transmit the A-SRS on that slot. But if slot n+t is not an available slot for the A-SRS, the UE will search for the next available slot from slot n+t and transmit on the next available slot if the autonomous delaying is configured/activated in case of a collision causing the A-SRS not able to be sent in slot n+t. The search may extend to at most k slots, i.e., by slot n+t+k, if the UE cannot find an available slot, the A-SRS is dropped. Note that a collision occurs if the symbols in the slot that the SRS are supposed to occupy are occupied by other transmissions/receptions with higher priorities, and hence the SRS cannot be sent.

An embodiment is for higher priority for A-SRS with newly introduced flexibility. The A-SRS with newly introduced parameters in a SRS request field to support BiT and other enhancements may be assigned with higher priority, so that when it collides with other SRS/UL transmissions, the other transmissions are dropped.

In some embodiments, reference slot designs and available slot designs are provided. A reference slot is the slot that the UE/gNB start to count for the slotoffset value. A given aperiodic SRS resource set is transmitted in the (t+1)-st available slot counting from a reference slot, where the field t (e.g., available slot position(s)) is indicated from DCI, or RRC, and the candidate values of the field t at least include 0.

There could be two options for reference slot. In Option 1, reference slot is the slot with the triggering DCI. In Option 2, reference slot is the slot indicated by the legacy triggering offset.

Option 1 and Option 2 have their respective pros and cons. Since the A-SRS resource set is transmitted only after the reference slot, if the configured legacy RRC slotoffset value is, say, 4, then Opt. 2 can only trigger A-SRS after 4 slots. So in case that the network wishes to trigger A-SRS after 2 slots (e.g., an UL slot occurs after 2 slots), Option 1 may be adopted. In this sense, Option 1 is more flexible than Option 2. On the other hand, with a non-zero RRC-configured slotoffset value, Option 2 can allow more time for the UE to prepare the A-SRS transmission, and can allow the network to trigger A-SRS later into the future than Option 1 with the same DCI overhead. Comparing the pros and cons, Option 1 may be more suitable as the enhancements for SRS is to improve the triggering flexibility.

Needless to say, the existing minimal trigger offset and the UE capability for minimum offset may need to be accounted for. According to the existing standards, the minimal time interval between the last symbol 0f the PDCCH triggering the aperiodic SRS transmission and the first symbol 0f SRS resource is N2 (or N2+14) symbols and an additional time duration T_{switch}, where N2 in symbols is determined according to the UE processing capability, and T_{switch} is for the uplink switching gap if any. These requirements defined in the existing standards can be accounted for in specifying the enhancement or by the gNB via gNB implementation.

Regarding the idea that Option 1 may be a special case of Option 2 if slotoffset is set to be 0, slotoffset is RRC configured and cannot be changed dynamically enough. The goal here is to have more flexibility in terms of dynamically changing parameters, but a reference slot based on RRC configuration lacks flexibility. If it turns out that slotoffset always have to be configured as 0, then we should just go with Option 1.

To have a fair comparison of the options, a given configuration of SRS resource set with a given slotoffset and a given DCI field bitwidth may be considered and analyzed, which slots are within reach and which are not for different options. With the same DCI field bitwidth, both options indicate the same number of slots. Option 1 can indicate near-future slots but not far-future slots, and Option 2 can indicate far-future slots but not near-future slots except for the no slotoffset case. It may be questioned why far-future slots indication is useful. For example, FIG. 3B illustrates available slots 14 TTIs away. The upper portion 352 shows indication of available slots in the near future. The lower portion 354 shows indication of available slots in far future. It is challenging for both gNB and UE to plan that far into the future, and given the current definition of available slot definition, strong restrictions on no dynamic events are imposed from the DCI slot to the last available slot. Thus, Option 2 may be less useful and more restrictive. If the issue of Option 2 is resolved with 0 slotoffset all the time, the resolution becomes Option 1. So, Option 1 may be a better solution.

Regarding “in the (t+1)-st available slot” above, this may be interpreted as to count “the first available slot”, “the second available slot”, until the “(t+1)-st available slot.” In other words, only the slot resources potentially available for SRS may be counted, including UL slots and flexible slots.

For the “available slot” definition, it may be useful to also consider consecutive slots with consecutive symbols that can be used for the SRS transmission, rather than restricting the symbols within one slot. If this is supported, then it is more likely to accommodate a SRS transmission without collision. Thus, we suggest to adopt the following definition of “available slot”: Based on only RRC configuration, “available slot” is the slot satisfying: there are available consecutive UL and/or flexible symbol(s) for the configured/indicated time-domain location(s) in a slot or consecutive slots for all the SRS resources in the resource set and it satisfies the minimum timing requirement between triggering PDCCH and all the SRS resources in the resource set.

“Available slot” definition in the current form is a bit limiting, in the sense that it only deals with the time-domain resource availability. Whether SRS can be transmitted in an “available slot” or not further depends on many other factors, such as the frequency-domain parameters for the SRS, the cyclic shift parameters for the SRS, etc. If these parameters are pre-configured for the SRS transmission and cannot be modified on the fly by the gNB based on possibly available resources, then many collisions are expected even on “available slots.” In other words, though the current “available slot” definition is not technically incorrect, it is quite incomplete. It may need to be associated with potential collision avoidance/collision handling designs.

To ensure the “available slot” definition to be meaningful in practical scenarios, collision avoidance mechanisms and collision handling mechanisms need to be jointly considered. The current working assumption mentions collision handling but no discussion has been provided so far. Collision avoidance has not been brought up yet, which may include dynamic indication of more SRS parameters for flexibility, i.e., collision avoidance, in frequency domain and/or in cyclic shift with same/different UEs, in time-domain such as symbol offset and length. So it is desirable to also add a note in the available slot definition to strive for collision avoidance via dynamic indication of frequency/cyclic shift/sequence parameters.

RRC configuration configures different numbers of slotoffset values. For positioning-related SRS, a resource set is configured with multiple slotoffset values by RRC, that is, the slot level offset is defined by the higher layer parameter slotOffset for each SRS resource within the resource set. But for all other SRS, a resource set is configured with only one slotoffset value by RRC. The above can be further extended to: A given aperiodic SRS resource within a given aperiodic SRS resource set is transmitted in the (t+1)-st available slot counting from a reference slot, where the field t (e.g., available slot position(s)) is indicated from DCI, or RRC, and the candidate values oft at least include 0, and based on only RRC configuration, “available slot” is the slot satisfying: there are available consecutive UL and/or flexible symbol(s) for the configured/indicated time-domain location(s) in a slot or consecutive slots for all the SRS resources in the resource set and it satisfies the minimum timing requirement between triggering PDCCH and all the SRS resources in the resource set, and a few further embodiments are provided here. The available slot becomes available slots for the SRS resource set if the set is associated with different slotoffsets for different resources. In one embodiment, the relative timing relations among the resources as configured via slotoffsets are maintained in the available slots, e.g., if the slotoffsets are such that resource 2 is 3 slots later than resource 1, then the available slots for a set of n resources should satisfy that there are available consecutive UL and/or flexible symbol(s) for the configured/indicated time-domain location(s) in n sets of single or consecutive slots for all the SRS resources in the resource set, and the minimum timing requirement between triggering PDCCH and all the SRS resources in the resource set, and the n resources are on slots (only counting the first slot within each set) with relative slot offsets the same as the configured slotoffsets. This embodiment may be complicated, and if one resource cannot fit then the entire set has to be either dropped or delayed. In another embodiment, each resource within the set is treated independently to be sent on an available slot, and there is no restriction on their relative timing. If one resource cannot fit on the slot n+t associated for the resource, it may be dropped or delayed based on the configuration but other resources are not affected.

In an embodiment, after reception of the uplink SRS, access nodes preschedules UEs and indicates to the prescheduled UEs through signaling which portion of the SRS transmission bandwidth, which SRS resources or ports from the different SRS resources or ports arrangements, transmission comb, cyclic shift, and which of the downlink CSI-RS ports (and/or DMRS) are assigned to it. In addition to the listed parameters the indication signaled to the prescheduled UEs may include the association (e.g., mappings, relationships) between the uplink ports, the downlink ports, or bandwidth. The downlink ports may consist of the DMRS and/or CSI-RS ports. In an embodiment, the network uses a group DCI message to dynamically configure the SRS parameters. In another embodiment, a unicast DCI message is used to dynamically configure the SRS parameters. The SRSs transmitted by the prescheduled UEs may be referred to as triggered SRS to differentiate them from the uplink SRSs transmitted by the UEs to facilitate uplink channel estimation, such as in block 305 of FIG. 3A. The uplink reference signals (e.g., the SRSs) are used to convey interference situation in the neighboring cells, as well as the serving access node's accounting of the interference suppression receiver capability of the UE. Subsequently, the access node determines the downlink precoder (in accordance with the received precoded SRSs (i.e., the triggered SRSs), for example) and transmits downlink data utilizing the downlink precoder.

The following will provide more details on the indication of the SRS transmission parameters.

As related to signaling the SRS Resources or Ports, the network indicates to the UEs which of the SRS resources or ports are assigned to the UEs. In other words, the UE needs to know which resource of the SRS resource pool or subset of the SRS configured resources to transmit on in the uplink.

In an embodiment, the network configures the UE with different arrangements of resources or ports. The different arrangements of the resources or ports may differ by the cyclic shift, transmission comb, number of symbols (e.g., orthogonal frequency division multiplexed (OFDM) symbols), etc., for example. The different arrangements represent different mechanisms the network may pack the UEs SRS resources or ports. In an embodiment, the different resources or ports arrangements are predefined. Signaling a predefined arrangement of resources or ports may require less overhead than signaling the different values for the cyclic shift, transmission comb, number of symbols (e.g., OFDM symbols), etc. As an example, if there are 8 predefined arrangements, signaling any one of the 8 may be accomplished by signaling a 3-bit index, while signaling the different values may require significantly more than 3 bits. The predefined arrangements may be defined in the 3GPP standard and/or higher layer configured, the network may downsize (further select and signal) a particular configuration after prescheduling (or scheduling) and may signal the downsized arrangement to the UE using DCI.

As an illustrative example of SRS resource or port signaling, consider a communication system with 8 type 1 demodulation reference signal (DMRS) ports. In an embodiment 12 DMRS ports may be used as an illustrative example. With 8 uplink SRS resources (e.g., ports) for all UEs operating within a single cell and that 8 UEs are prescheduled. There is a need for the UEs to know which of the 8 uplink SRS resources to transmit on. Therefore, there is a need to signal, to the UEs, in an attempt to inform the UE which uplink SRS resource (or resources) to use, in an efficient way to minimize impact on overall communication system performance. Informing the UEs which uplink SRS resources to use may involve indicating which comb, symbol, cyclic shift, number of OFDM symbols, etc., to use. As discussed previously, in one embodiment the UEs may be configured with different arrangements of these SRS resources or ports. These arrangements may be specified in a technical standard, by an operator of the communication system, or determined through collaboration between communicating devices, for example. Example arrangements include: 1 physical resource with 8 ports for 8 UEs having cyclic shift 8 (for orthogonality between ports) and comb 2; 1 physical resources with 8 ports for 8 UEs having cyclic shift 8 and comb 4; 8 physical resources with 1 port for each of the 8 UE; 2 physical resources with 4 ports per resources using cyclic shift 4.

In a first example embodiment, there is 1 physical resource with 8 ports for the 8 UEs served within the cell, with a cyclic shift of 8 (ensuring orthogonality of SRS transmission), a comb of 2, and repetition over a specified number of symbols (the specified number of symbols may be specified in a technical standard, by an operator of the communication system, or determined through collaboration between communicating devices, for example). In order to indicate to the UEs which one of the 8 resources to use, a 3-bit indication is sufficient.

In a second example embodiment, there is 1 physical resource with 8 ports for the 8 UEs operating within the cell, with a cyclic shift of 8, and a comb of 4. In order to indicate to the UEs which one of the 8 resources to use, a 3-bit indication is sufficient.

In a third example embodiment, there are 8 physical resources with 1 port per physical resource for each UE operating within the cell, with OFDM symbol multiplexing. In order to indicate to the UEs which one of the 8 resources to use, a 3-bit indication is sufficient.

In a fourth example embodiment, there are 2 physical resources with 4 ports per physical resource for each UE operating within the cell, with a cyclic shift of 4. In order to indicate to the UEs which one of the 8 resources to use, a 4-bit indication is sufficient if some UEs are allocated more than one port, e.g., a UE may be allocated 2 ports.

These different resources or ports arrangements may be predefined and the network may configure the UE with the different arrangement. The network may signal one or more of these arrangements using DCI for the subset of (prescheduled, scheduled, active) UEs.

The examples presented above are only examples of resource configuration and the actual configuration may not be limited to the aforementioned. In this case the network may use a certain number of bits (for example 3 to 4 bits) in DCI to indicate to the UE which of the arrangements of resources or ports (implicitly indicating the transmission layers, comb and cyclic shift) is assigned to it.

In one embodiment, the network may define a full set of SRS resources/ports and use an indication to indicate for subset. Such a design is similar to the DMRS port indication in 5G NR. In another embodiment, the network may define the subset of SRS resources/ports and use indication to indicate the subset from the configured subsets. In any of these embodiments, a table may be used to summarize all the possible resources set/subsets with the ports (ranks) which may be tied to the cyclic shift, comb, OFDM symbols, offset.

The network may define DCI bit indication that may have a one to one mapping to port indication of the SRS which may be tied to the cyclic shift, comb, offset, OFDM symbols. The value indicated in the DCI would map to the ports that may be used for SRS transmission. In one embodiment, one port may be used such as port 0. In another embodiment, multiple ports may be used and such as for example two ports may be used for SRS transmission. The field may be referred to as antenna ports and number of layers for SRS and a fixed number of bits may be used in the DCI to indicate it.

In another embodiment, the access node may transmit configuration information of a plurality of SRS resources to a user equipment (UE). The configuration information includes a plurality of SRS resource sets to the UE, each SRS resource set comprising one or more SRS resources. The access node then transmits to the UE, an indication of one of the plurality of SRS resource set.

The antenna ports to be used for SRS transmission shall be determined according to the ordering of the SRS ports given by the predefined configuration which may be represented by tables. The number of bits which are indicated in the DCI as defined by the groups indicates the ports of transmission which are tied to physical resources such as cyclic shift, comb, OFDM symbols.

In the situation where a group DCI is used to convey the SRS configuration, the indication of the layers or ports for a UE within the pre-defined SRS port resources is possible. As an example for each cell (e.g., sector, transmission point, etc.), a predefined number of SRS port resources is assigned, such as, 8 or 12 ports, for example. In the group DCI, the network indicates the layers or ports for a UE within the predefined SRS port resources. For example the network has configured a SRS resource for all active UEs in the cell and the SRS resource has the same 8 ports. The group DCI indicates which of the 8 ports are allocated for the UE. The pre-defined SRS port resources may be specified in a technical standard specification, or signaled from the network to the UE via a RRC configuration signaling, a MAC signaling, and in some embodiments, a DCI. For example, the RRC signaling configures SRS port resources with indexes 0-7 for UE1 as UE1's SRS ports 0-7, SRS port resources with indexes 0-7 for UE2 as UE2's SRS ports 0-7, SRS port resources with indexes 8-15 for UE3 as UE3's SRS ports 0-7, SRS port resources with indexes 8-15 for UE4 as UE4's SRS ports 0-7, etc. This design can also be adopted for UE-specific DCI (such as DCI format 1_1, an enhancement of 1_1 (which is discussed in detail below), etc.) for A-SRS triggering. The DCI may have an antenna port indication field for the A-SRS, which may also be used for antenna port indication for PDSCH in some embodiments, and the UE maps the ports indicated in the field to the pre-defined SRS port resources assigned to the UE. For example, UE1 may receive an enhanced DCI of 1_1 with the antenna port indication field for both PDSCH and SRS indicating value 25 (as in Table 1 from Table 7.3.1.2.2-2 of TS 38.212 v16.2.0, reproduced herewith; for dmrs-Type=1, maxLength=2, which are also signaled to the UE for PDSCH) which corresponds to PDSCH DMRS ports 2 and 6 as well as SRS ports 2 and 6, which is further mapped to SRS port resources 2 and 6. For another example, UE3 may receive an enhanced DCI of 1_1 with the antenna port indication field for both PDSCH and SRS indicating value 25 which corresponds to PDSCH DMRS ports 2 and 6 as well as SRS ports 2 and 6, which is further mapped to SRS port resources 10 and 14.

TABLE 1
Antenna port(s) (1000 + DMRS port), dmrs-Type = 1, maxLength = 2 from Table
7.3.1.2.2-2 of TS 38.212 v16.2.0

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | | | of DMRS | | |
| | CDM | | Number | | CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

In an example, considering a communication system with 4 UEs, the network may assign the first port for a first UE, two subsequent ports for the second UE, etc. In another embodiment, the network may reuse DMRS port mapping or CSI-RS port mapping.

In one embodiment, the SRS resource is configured for all resource block groups (RBGs) but the scheduling or group DCI allows different UEs be scheduled on different RBGs.

As related to UE identifiers, the UE identifiers are used to reduce DCI signaling overhead. In an embodiment, to further reduce DCI size, unique but short UE identifiers are assigned to the prescheduled UEs. Instead of using long UE identifiers, such as a radio network temporary identifier (RNTI), which may be 10 or more bits long, short UE identifiers that are unique within the prescheduled UEs are assigned to each prescheduled UE. As an example, if there is a maximum of 16 prescheduled UEs, then the short UE identifier may be as short as 4 bits, while if there is a maximum of 8 prescheduled UEs, then the short UE identifier may be as short as 3 bits. In an embodiment, the short UE identifier may be allocated by the access node and signaled to the prescheduled UEs using RRC messaging, MAC CE messaging, higher layer messaging, and so on.

As related to indicating UE identifiers, the access node may send a DCI trigger to the prescheduled UEs. The indication of the prescheduled UEs may be included in a dedicated field of the DCI. Additionally, the UE identifiers and the UE identifier field in the DCI may be configured using higher layer signaling.

With the use of UE identifiers, prescheduled UEs are able to decode the DCI that is identified the UE ID. Those prescheduled UEs that are able to decode the DCI identified with their UE IDs are considered to be the triggered UEs. UEs which are configured but not triggered may also attempt to decode the DCI, but they would fail because the DCI is not addressed to them, and hence they are not triggered.

As new UEs are prescheduled or additional set of active UEs are present, the UE identifiers may be renewed and reconfigured, possibly through higher layer configuration, for example.

As discussed previously, there may be an association between the SRS and the DL Reference Signals. In order for a UE to receive precoded (or unprecoded) CSI-RS, the UE needs to know which CSI-RS ports have been allocated, therefore, a CSI-RS port indication needs to be sent to the UE. After the UE receives the CSI-RS port indication, the UE may be able to infer (from the CSI-RS port indication, for example) the preconfigured CSI-RS ports to use to measure the downlink channel and the SRS ports to transmit the SRS because the SRS resource and CSI-RS resource are already preconfigured and there is an association between the SRS and the CSI-RS resources.

Similarly, a UE needs to know which of DMRS ports have been allocated for it. A DMRS port indication needs to be sent to the UE. After the UE receives the DMRS port indication, the UE may be able to infer (from the DMRS port indication, for example) the preconfigured DMRS ports to use to measure the downlink channel and the SRS ports to transmit the SRS because the SRS resource and DMRS resource are already preconfigured and there is an association between the SRS and DMRS resources.

In one embodiment, the SRS indication field which is used to signal the specific arrangement of SRS resources or ports are also used to indicate to the UE a mapping between the uplink and downlink ports (such as DMRS or CSI-RS ports). Because the SRS ports of each UE are identified, the UE may infer the associated ports in the downlink from the configuration (the mapping). In such a case, the associated relationship between the uplink and downlink ports may be configured through higher layer configuration. A fixed mapping may be defined that can identify the association, for example, a one to one mapping between the uplink and downlink ports may be configured. In another embodiment, a permutation between the uplink and downlink ports may be applied as a mapping. The permutation may be specified in a technical standard, by an operator of the communication system, or through collaboration between the network and the UE. Hence, the permutation is known by both the network and the UE. As the UE determines the SRS ports or layers indicated to the UE, the UE may measure the corresponding CSI-RS and/or DMRS for channel estimation and use the measurement to determine the precoder for precoding of the uplink SRS.

In one embodiment, the indication may be implicit. In this case, signaling the SRS resources or ports may be sufficient to signal the association due to the fixed mapping between the resources. In another embodiment, the indication may be explicit. In this case, a dedicated field that explicitly identifies the downlink CSI-RS, or DMRS for the scheduled UEs may be used.

DCI may have dedicated field to indicate the DMRS-SRS association. It may also have field to indicate the CSI-RS-DMRS association. A table may be defined in the specification that has a one to one mapping of the Uplink port with the downlink ports.

The number of bits used to indicate the association between the downlink port(s) and SRS port(s) may be used for indication of the transmission of one of more downlink ports and the SRS ports which may be indicated by the SRS resources/ports indication fields.

In an embodiment the association is used to indicate not only the port association but also the bandwidth association (active bandwidth part).

In addition to the above mentioned parameters (e.g., UE identifier, an association, and the SRS resources indication), the Group DCI may include some or all of the following: a resource allocation field which indicates the time and frequency resources (resource block groups for UEs, for example); an explicit indication of CSI-RS or DMRS ports using dedicated fields in the DCI that may signal the downlink ports. This may also be used by the UE to determine the rank of the transmission. In an embodiment, the UE may infer the rank of transmission in the uplink based on the downlink reception; and a transmit power command used for SRS transmission power control.

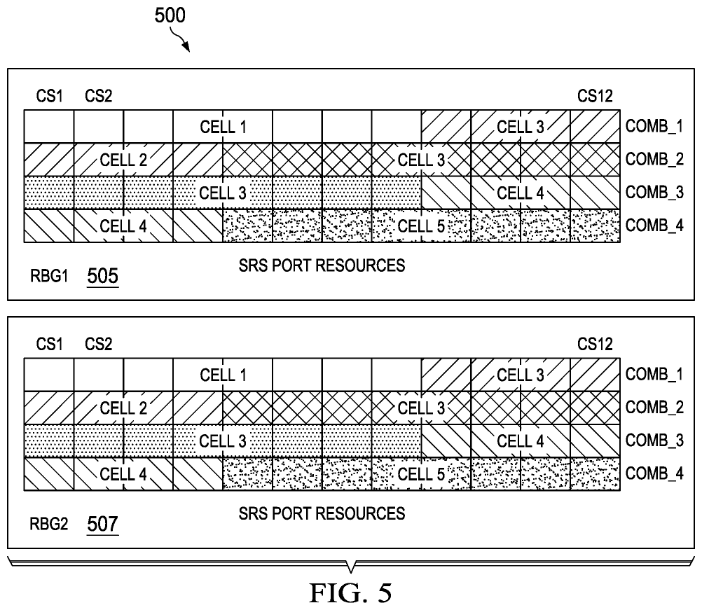

FIGS. 4 and 5 illustrate diagrams 400 and 500 of RGBs 405, 407, 505, and 507, and example mapping of SRS resources and ports. Diagram 400 illustrates RGBs 405 and 407 in a communication system with the following configuration: assume DMRS type 1 (8 ports per RGB per cell for all paired UEs); in another embodiment 12 port DMRS may be considered and analyzed, and the 8 ports are associated with 8 SRS port resources, selected from n available port resources (e.g., for comb 4, n=48, and for comb 2, n=16). The SRS port resources may be arranged in a manner similar to those illustrated for RBG1 405 and RBG2 407, and each port resource may be assigned with a global index such as (2, 9) for (COMB shift=2, cyclic shift=9), i.e., the global indexing may be the same for different RBGs, or (1, 2, 9) for (RBG=1, COMB shift=2, cyclic shift=9), i.e., RBG specific indexing. In some embodiments, instead of RBGs, other time/frequency resource groups can be used, such as (RBG, OFDM symbol), PRB, every 4 RBGs, etc. The SRS from neighboring cells should be multiplexed on the n SRS port resources. In order to indicate, to a UE, which 1, 2, or 4 SRS port resources out of the available n SRS port resources would require more bits than available in a DCI message.

Diagram 500 illustrates RGBs 505 and 507, with the same configuration as discussed in FIG. 4. In an embodiment, UE-group CSI-RS or DMRS design is applied to the SRS. For each cell, there are only 8 predefined SRS port resources (shown in FIG. 5 as different shaded and pattern blocks in the SRS port resources region of the RGBs). Then, in a DCI message (such as a group DCI message or a UE-specific DCI message), the layer or port assignments for a UE are made within the 8 predefined SRS port resources and indicated accordingly. As an example configure a SRS resource for all active UEs in cell 1 (shown as unshaded blocks in the SRS port resources region of the RGBs), and the SRS resource has the same 8 ports. That is, SRS port(s) indicated to a UE configured with the SRS port resources will be mapped to the SRS port resource(s) in a one-to-one fashion. The group DCI message indicates which of the 8 ports are allocated to a particular UE. As an example, rank [1, 2, 4, 1] are signaled for UEs 1, 2, 3, and 4, without needing to indicate the layer index. As another example, the DMRS port mapping of the resources are used. The SRS resource is configured for all RGBs, but the scheduling or group DCI allows different UEs to be scheduled on different RGBs. In an embodiment, a UE (or a cell) is assigned with SRS port resources not consecutive as shown in the figure, that is, a UE in CELL1 may not be assigned with COMB shift=1 and cyclic shifts from 1 to 12. Instead, the ports resources for the UE is distributed (spread out) in the figure, such as (COMB shift=1, cyclic shift=1), (COMB shift=1, cyclic shift=7), (COMB shift=2, cyclic shift=1), (COMB shift=2, cyclic shift=7), (COMB shift=3, cyclic shift=1), (COMB shift=3, cyclic shift=7), (COMB shift=4, cyclic shift=1), and (COMB shift=4, cyclic shift=7). An advantage is that the ports for one UE or one cell are more spread out over the potential SRS port resources, reducing the potential interference/overlap between cyclic shifts close to each other.

Alternative designs to the Group DCI for signaling control information of the SRS are possible. In one embodiment, the UEs identified in a Group DCI share a resource allocation field (Type 0 or Type 1 indication). Such a case may occur in a multi-user multiple input multiple output (MU-MIMO) setting, where UEs may share resource blocks or RBGs. In this situation, preconfigured UEs which are not prescheduled have fields in the Group DCI with trigger set to zero.

In another embodiment, the UEs identified in a Group DCI have separate fields for the indication of the resource allocation fields for each of the UEs. In this case, preconfigured UEs which are not prescheduled have fields with trigger set to zero.

In any of the preceding embodiment, a UE identifier may be used to identify prescheduled UEs. In this way, only prescheduled UE are able to decode the DCI. However, a UE will attempt to decode the DCI to check if it is triggered (prescheduled) or not. For example, all UEs detecting the DCI can attempt to decode the DCI.

In any of the preceding embodiments, the DCI includes a combination of fields listed or subset of the fields aforementioned.

In another embodiment, a modified DCI format, such as DCI format 0_1 (UL Grant) or DCI format 1_1, may be used to dynamically configure triggered (prescheduled UEs) with the SRS parameters aforementioned and the associated downlink PDSCH and/or CSI-RS parameters.

Any of the 5G NR DCI designs may be used to signal the necessary aforementioned such as the necessary fields are added/modified to the DCI.

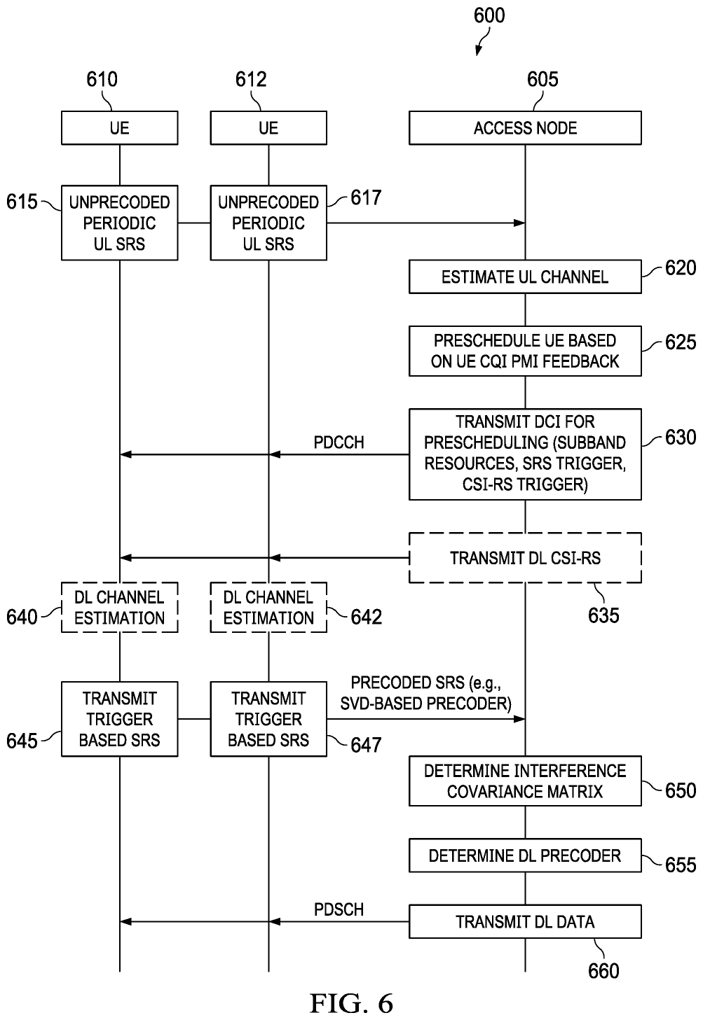

FIG. 6 illustrates a diagram 600 of messages exchanged by communicating devices performing interference probing. Diagram 600 displays messages exchanged by an access node 605 and UEs 610 and 612 as the communicating devices perform interference probing (may also be referred to as training or BiT).

UEs 610 and 612 transmit uplink SRSs (blocks 615 and 617). The uplink SRSs may be unprecoded and periodic. The uplink SRSs are transmitted to access node 605. Access node 605 estimates the uplink channels (block 620). The estimation of the uplink channels is made in accordance with the uplink SRSs transmitted by the UEs. Access node preschedules UEs (block 625). The prescheduling of the UEs may be in accordance with the signal quality measures, CQI, PMI, or feedback, as discussed previously. In the example shown in FIG. 6, UEs 610 and 612 are also the prescheduled UEs.

Access node 605 transmits control information configuring uplink SRSs for the prescheduled UEs (block 630). The control information may be transmitted in group DCI or unicast DCI, for example. The group DCI may contain the UE identifiers of the prescheduled UEs in one embodiment. The control information may include (a subset thereof is also possible) configuration information, for UEs, such as, transmission bandwidth of the uplink SRS, or a portion of the transmission bandwidth, an indication of the transmission ports of the uplink SRS, an indication of the SRS resources or ports of the uplink SRS, an implicit or explicit indication of the cyclic shift and comb, the subbands of the uplink SRS, SRS trigger, CSI-RS trigger, DMRS trigger, a mapping between the CSI-RS and SRS, an indication of the mapping between the DMRS and SRS, etc.

If access node 605 is to transmit CSI-RS, access node 605 transmits the CSI-RS (block 635). UEs 610 and 612 may perform downlink channel estimation (blocks 640 and 642). The downlink channel estimation may be performed in accordance with the CSI-RS transmitted by access node 605.

UEs 610 and 612 transmit uplink SRS (blocks 645 and 647). The uplink SRS are transmitted in accordance with the configuration information transmitted by access node 605. The uplink SRS may be precoded, e.g., single value decomposition (SVD) based precoder. Access node 605 determines interference covariance matrices (block 650). The interference covariance matrices are determined based on the uplink SRS transmitted by UEs 610 and 612 (i.e., the prescheduled UEs). Access node 605 determines downlink precoders (block 655). The downlink precoders are determined in accordance with the interference covariance matrices. Access node 605 transmits downlink data to UEs 610 and 612 (block 660). Access node 605 precodes the downlink data for each prescheduled UE using the downlink precoder associated with the prescheduled UE, for example. The precoded downlink data is transmitted over a physical downlink shared channel (PDSCH).

In the Third Generation Partnership Project (3GPP) Fifth Generation (5G) New Radio (NR) standards related to existing DCI formats, the DCI size is minimized in order to reduce communications overhead. As an example, in the DCI format 2_3, used for transmitting group transmit power control (TPC) commands for SRS transmissions by one or more UEs, the DCI size is less than or equal to the DCI size of DCI format 1_0. Therefore, the number of bits available to transmit the uplink SRS configurations is limited. However, existing DCI formats do not support dynamic signaling of SRS configuration. Additionally, control information has to be provided for all configured UEs, even those that are not triggered (i.e., not prescheduled) to transmit the uplink SRS, therefore, the number of UEs configured using the existing DCI formats is limited due to the limitation of the number of bits.

According to an example embodiment, a DCI format for conveying SRS configuration information is provided. In an embodiment, the DCI includes SRS configuration information only for the prescheduled UEs. Existing DCI formats includes control information for all configured UEs, even those that are not prescheduled. Having the DCI only including SRS configuration information for the prescheduled UEs reduces the size of the DCI, thereby permitting a reduction in the DCI size or an inclusion of more SRS configuration information.

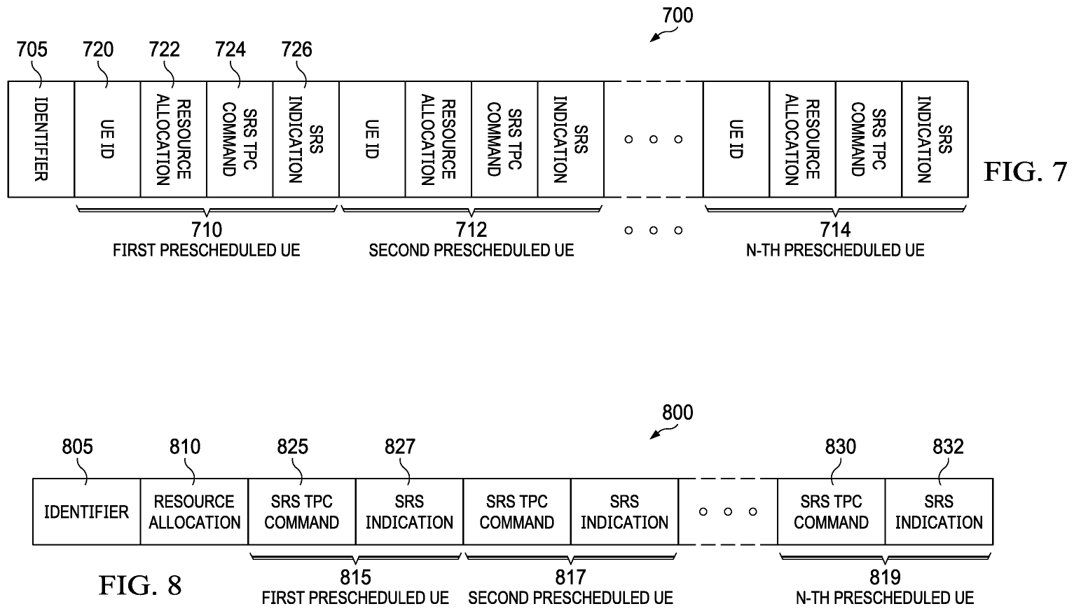

FIG. 7 illustrates a first example DCI 700. DCI 700, as shown in FIG. 7, is an example of a DCI where the DCI includes SRS configuration information for only prescheduled UEs and a short UE identifier is used to identify the UEs. DCI 700 includes an identifier field 705, which identifies the DCI being a DCI for conveying SRS configuration information to prescheduled UEs. DCI 700 also includes SRS configuration information for each of the prescheduled UEs, such as first prescheduled UE 710, second prescheduled UE 712, and N-th prescheduled UE 714.

As an example of the savings achievable by using the short UE identifiers and conveying information only for the prescheduled UEs, consider a situation where an access node is serving 20 UEs, with only 5 prescheduled UEs. If 10 bit long RNTIs are used, the DCI format would need to convey at least 20*10=200 bits of identifying information alone, while using the short UE identifiers and prescheduled UEs, DCI format 700 would need to convey only 5*4=20 bits of identifying information.

For each prescheduled UE, such as first prescheduled UE 710, DCI 700 includes a UE ID field 720, a resource allocation field 722, a SRS TPC command field 724, and a SRS indication field 726. UE ID field 720 comprising the short UE identifier of the prescheduled UE, and may be 4 bits in size, for example. Resource allocation field 722 comprising time and frequency resource blocks or groups for the prescheduled UE. The size of resource allocation field 722 may depend upon the type of the resource allocation, as well as the bandwidth part (BWP) size, with the size also being dependent on the Resource allocation type, for example. SRS TPC command field 724 comprising a power control command for the SRS, and may be 2 bits in size, for example. SRS indication field 726 comprising SRS resources, SRS ports, SRS transmission bandwidth, etc. The value in SRS indication field 726 may be preconfigured with a set of different possible arrangements of SRS resources or ports, SRS transmission bandwidth, etc., values and only an index to a particular set of possible SRS resources, SRS ports, SRS transmission bandwidth, etc., is held in SRS indication field 726 to reduce size. SRS indication field 726 may also be used to indicate the mapping with the DL ports (layers, reference signals, etc.). An example SRS indication field 726 size is 4 bits. SRS indication field 726 supports SRS port indication in the uplink to transmit the SRS. Also implicitly indicated is the SRS cyclic shift, SRS subband, SRS comb, etc. Also implicitly indicated is the precoded CSI-RS port(s) assigned to the prescheduled UE in the downlink (e.g., the same ports). The example sizes of the various fields of DCI 700 are for discussion purposes only. The example embodiments presented herein are operable with other field sizes.

As related to resource allocation fields, such as resource allocation field 722, Resource Type 1 may be used for frequency allocation. Alternatively, Resource Type 2 may be used for frequency allocation. Resource block groups may be used for UEs. Additionally, the frequency allocation may include the allocation for the SRS transmission.

As related to downlink antenna ports, an indication for the UE may be used for downlink ports or downlink layers. As an example, the indication may be a bitmap. As another example, the indication may be a value. A UE may be able to determine CSI-RS or DMRS ports to use in accordance with the SRS ports allocated to the UE. As an example, the indication may use the SRS indication field. In another embodiment, the indication of the SRS ports may use a bitmap.

Information associated with configured UEs that are not prescheduled are not be included in DCI format 700. A prescheduled UE may process the DCI to determine if the access node has triggered the prescheduled UE for SRS transmission.

In an embodiment, to further reduce DCI size, the SRS configuration information for each prescheduled UE is arranged in order (e.g., increasing or decreasing order) so that it is not necessary to include the short UE identifier in the DCI. Therefore, additional reduction in the DCI size is achieved.

In an embodiment, time and frequency resource blocks or groups are configured for the prescheduled UEs. In FIG. 7, each prescheduled UE may be configured with a different allocation of time and frequency resource blocks or groups. In this embodiment, a single allocation of time and frequency resource blocks or groups is configured for the prescheduled UEs indicated in the DCI. In an embodiment, a single DCI is used to convey SRS configuration information for the prescheduled UEs of the access node. In such a situation, the DCI includes SRS TPC command and SRS indication for each prescheduled UE. The SRS TPC command and SRS indication for each prescheduled UE may be arranged in accordance with the short UE identifier assigned to each prescheduled UE. The SRS TPC command and SRS indication for each prescheduled UE may be arranged in increasing short UE identifier or decreasing short UE identifier, for example.

In an embodiment, a single DCI is used to convey SRS configuration information for a subset of the prescheduled UEs of the access node. In such a situation, the DCI includes SRS TPC command and SRS indication for each prescheduled UE in the subset. As an example, a first DCI includes SRS TPC commands and SRS indications for a first subset of the prescheduled UEs, a second DCI includes SRS TPC commands and SRS indications for a second subset of the prescheduled UEs, and so on. The SRS TPC command and SRS indication for each prescheduled UE in a subset may be arranged in accordance with the short UE identifier assigned to each prescheduled UE in the subset. The SRS TPC command and SRS indication for each prescheduled UE in the subset may be arranged in increasing short UE identifier or decreasing short UE identifier, for example.

FIG. 8 illustrates a second example DCI 800. DCI 800, as shown in FIG. 8, is an example of a DCI where there is a single allocation of time and frequency resource blocks or groups is configured for the prescheduled UEs. DCI Boo includes an identifier field 805, which identifies the DCI being a DCI for conveying SRS configuration information to prescheduled UEs, and a resource allocation field 810. Resource allocation field 810 comprising time and frequency resource blocks or groups for the prescheduled UEs indicated in DCI 800. DCI 800 also includes SRS TPC commands and SRS indications for each of the prescheduled UEs, such as first prescheduled UE 815, second prescheduled UE 817, and N-th prescheduled UE 819.

For each prescheduled UE, such as first prescheduled UE 815, DCI 800 includes a SRS TPC command field 825, and a SRS indication field 827. SRS TPC command field 825 comprising a power control command for the SRS, and may be 2 bits in size, for example. SRS indication field 827 comprising SRS resources, SRS ports, SRS transmission bandwidth, etc. The value in SRS indication field 827 may be preconfigured with a set of possible SRS resources, SRS ports, SRS transmission bandwidth, etc., values and only an index to a particular set of possible SRS resources, SRS ports, SRS transmission bandwidth, etc., is held in SRS indication field 827 to reduce size. An example SRS indication field 827 size is 4 bits. SRS indication field 827 supports SRS port indication in the uplink to transmit the SRS. Also implicitly indicated is the precoded CSI-RS port(s) assigned to the prescheduled UE in the downlink (e.g., the same ports). Also implicitly indicated is the SRS cyclic shift, SRS subband, SRS comb, etc.

In an embodiment, to further reduce DCI size, allocations of time and frequency resource blocks or groups are configured for the prescheduled UEs. The allocation of time and frequency resource blocks or groups may be configured for the prescheduled UEs that are scheduled for SRS transmission. Hence, in such a situation, allocations of time and frequency resource blocks or groups are included for each prescheduled UE that is scheduled for SRS transmission and omitted for each prescheduled UE that is not scheduled for SRS transmission.

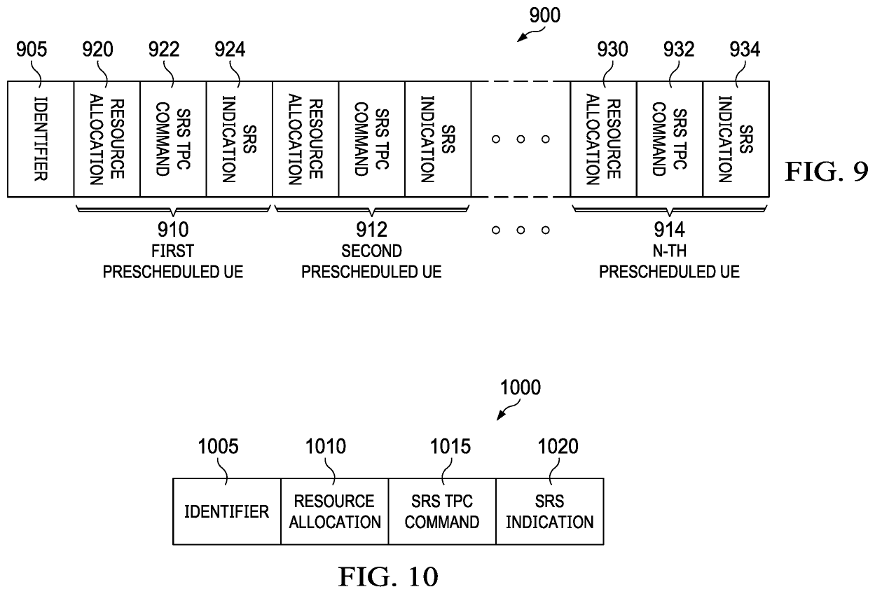

FIG. 9 illustrates a third example DCI 900. DCI 900, as shown in FIG. 9, is an example of a DCI where there are allocations of time and frequency resource blocks or groups for each prescheduled UE that is scheduled for SRS transmission. DCI 900 includes an identifier field 905, which identifies the DCI being a DCI for conveying SRS configuration information to prescheduled UEs. DCI 900 also includes information for each prescheduled UE, such as first prescheduled UE 910, second prescheduled UE 912, and N-th prescheduled UE 914. The information may differ depending on the prescheduled UE, e.g., prescheduled UEs that are scheduled for SRS transmission versus prescheduled UEs that are not scheduled for SRS transmission.

For each prescheduled UE that is scheduled for SRS transmission, such as first prescheduled UE 910, DCI 900 includes a resource allocation field 920, a SRS TPC command field 922, and a SRS indication field 924. Resource allocation field 920 comprising time and frequency resource blocks or groups for the prescheduled UE. The size of resource allocation field 920 may depend upon the type of the resource allocation, as well as the BWP size, and may be 10 bits in size, for example. SRS TPC command field 922 comprising a power control command for the SRS, and may be 2 bits in size, for example. SRS indication field 924 comprising SRS resources, SRS ports, SRS transmission bandwidth, etc. The value in SRS indication field 924 may be preconfigured with a set of possible SRS resources, SRS ports, SRS transmission bandwidth, etc., values and only an index to a particular set of possible SRS resources, SRS ports, SRS transmission bandwidth, etc., is held in SRS indication field 924 to reduce size. An example SRS indication field 924 size is 4 bits. SRS indication field 924 supports SRS port indication in the uplink to transmit the SRS. Also implicitly indicated is the precoded CSI-RS port(s) assigned to the prescheduled UE in the downlink (e.g., the same ports). Also implicitly indicated is the SRS cyclic shift, SRS subband, SRS comb, etc. The example sizes of the various fields of DCI 900 are for discussion purposes only. The example embodiments presented herein are operable with other field sizes.

For each prescheduled UE that is not scheduled for SRS transmission, such as N-th prescheduled UE 914, resource allocation field 930, SRS TPC command field 932, and SRS indication field 934 are set to zero or some other specified value. Although FIG. 9 illustrates an example where N-th prescheduled UE 914 is a prescheduled UE that is not scheduled for SRS transmission, any of the N prescheduled UE in DCI 900 may be a prescheduled UE that is not scheduled for SRS transmission.

The example embodiments illustrated in FIGS. 7-9 are for group DCI. However, the example embodiments presented herein are also operable for unicast DCI. In unicast DCI, the DCI is specifically addressed to a single UE. The addressing of the DCI to a particular UE may be accomplished by encoding the DCI with an identifier of the UE. When the DCI is encoded using the identifier of the UE, only the UE will be able to decode the DCI, while other UEs will detect the encoded DCI as noise. Because the DCI is specifically addressed to the UE using its identifier, the DCI does not need to include a unique identifier of the UE. Thereby, the size of the DCI is reduced.

FIG. 10 illustrates a fourth example DCI moo. DCI moo, as shown in FIG. 10, is an example of a DCI used in unicast DCI. DCI woo includes an identifier field 1005, a resource allocation field low, a SRS TPC command field 1015, and a SRS indication field 1020. Identifier field 1005 identifies the DCI being a DCI for conveying SRS configuration information to prescheduled UEs. Resource allocation field low comprising time and frequency resource blocks or groups for the prescheduled UE. The size of resource allocation field low may depend upon the type of the resource allocation, as well as the BWP size, and may be 10 bits in size, for example. SRS TPC command field 1015 comprising a power control command for the SRS, and may be 2 bits in size, for example. SRS indication field 1020 comprising SRS resources, SRS ports, SRS transmission bandwidth, etc. The value in SRS indication field 1020 may be preconfigured with a set of possible SRS resources, SRS ports, SRS transmission bandwidth, etc., values and only an index to a particular set of possible SRS resources, SRS ports, SRS transmission bandwidth, etc., is held in SRS indication field 1020 to reduce size. An example SRS indication field 1020 size is 4 bits. SRS indication field 1020 supports SRS port indication in the uplink to transmit the SRS. Also implicitly indicated is the precoded CSI-RS port(s) assigned to the prescheduled UE in the downlink (e.g., the same ports). Also implicitly indicated is the SRS cyclic shift, SRS subband, SRS comb, etc. The example sizes of the various fields of DCI woo are for discussion purposes only. The example embodiments presented herein are operable with other field sizes.

In another embodiment, dynamic signaling using a field (or fields) in the DCI may be used to signal an identifier of a reference downlink resource (or resources). A dedicated field to signal the mapping from a configured fixed mapping may be configured using higher layer signaling.

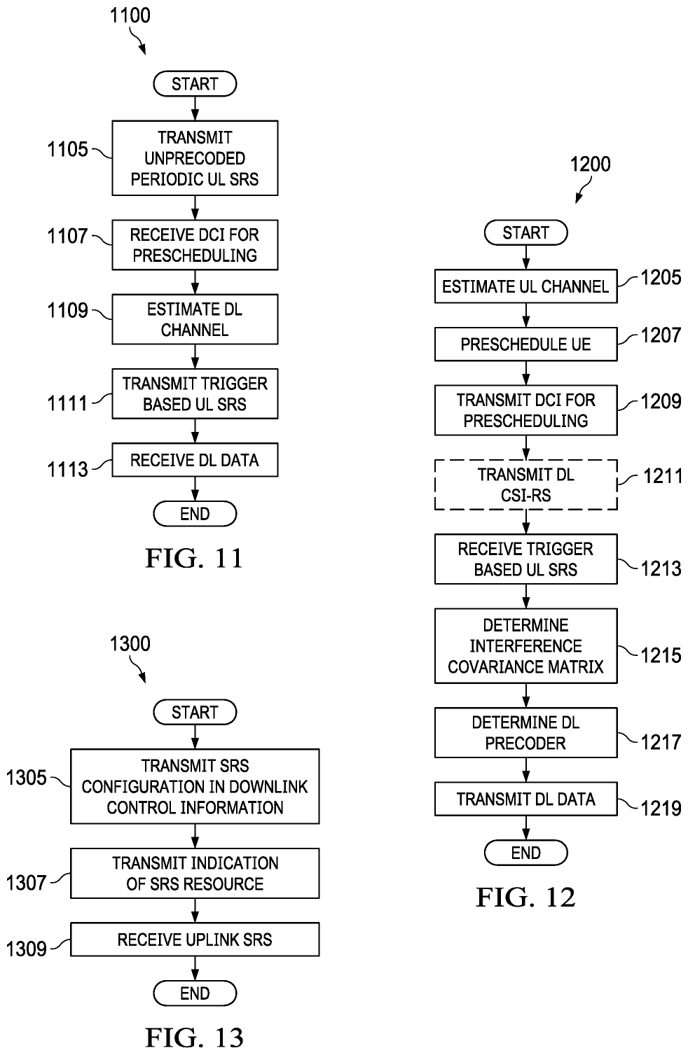

FIG. 11 illustrates a flow diagram of example operations 1100 occurring in a UE. Operations 1100 may be indicative of operations occurring in a UE as the UE participates in interference probing and receives downlink data. The UE may be a prescheduled UE.

Operations 1100 begin with the UE transmitting an uplink SRS (block 1105). The uplink SRS may be unprecoded. The uplink SRS may be periodic in nature. The UE receives DCI from an access node (block 1107). The DCI may include SRS configuration information for the UE. The SRS configuration information configures the UE to make a SRS transmission. The DCI may also include CSI-RS configuration. The DCI may be part of a group DCI message. The DCI may be a unicast DCI message. The UE estimates the downlink channel (block 1109). The UE estimates the downlink channel using a CSI-RS transmitted by the access node. The UE transmits a precoded SRS (block 111). The precoded SRS is transmitted in accordance with the SRS configuration information received in the DCI. The UE receives downlink data (block 1113). The downlink data is received from the access node. The downlink data is precoded using a precoder determined in accordance with the precoded SRS transmitted by the UE.

FIG. 12 illustrates a flow diagram of example operations 1200 occurring in an access node. Operations 1200 may be indicative of operations occurring in an access node as the access node participates in interference probing and transmits downlink data.

Operations 1200 begin with the access node estimating an uplink channel (block 1205). The access node estimates the uplink channel using a SRS transmitted by a UE, for example. The SRS may be precoded or unprecoded. The access node preschedules UEs (block 1207). The access node preschedules UEs in accordance with the SRSs transmitted by UEs. As an example, the access node preschedules UEs associated with SRSs with signal quality exceeding a specified threshold. The access node transmits DCI to the prescheduled UEs to trigger SRS transmission (block 1209). The DCI transmitted by the access node may also cause the UE to measure downlink CSI-RS or DMRS. The access node configures SRSs for the prescheduled UEs and sends SRS configuration information to the prescheduled UEs in the DCI. The SRS configuration information may also include CSI-RS information. The DCI may be a group DCI or unicast DCIs.

The access node may transmit a CSI-RS (block 1211). The CSI-RS may be used for downlink channel estimation. The access node receives a precoded SRS (block 1213). The precoded SRS may be received in accordance with the SRS configuration information. The access node determines an interference covariance matrix (block 1215). The interference covariance matrix is determined in accordance with the precoded SRS. The access node determines a downlink precoder (block 1217). The downlink precoder is determined in accordance with the interference covariance matrix. The access node transmits downlink data (block 1219). The downlink data is precoded in accordance with the downlink precoder.

FIG. 13 illustrates a flow diagram of example operations 1300 occurring in an access node configuring uplink SRSs. Operations 1300 may be indicative of operations occurring in an access node as the access node configures uplink SRSs and receives an uplink SRS transmission.

Operations 1300 begin with the access node transmitting a SRS configuration (block 1305). The SRS configuration may be transmitted in downlink control information, e.g., in a group DCI or a unicast DCI. In the situation when the group DCI is used, the group DCI may be addressed to UEs (e.g., prescheduled UEs) using UE identifiers, which are unique within the group of UEs, but are shorter than typical UE identifiers, so save signaling overhead. In an embodiment, the SRS configuration includes information regarding arrangements of SRS port resources (e.g., combs, offsets, cyclic shifts, symbols, etc.) The SRS port resources may also be grouped into plurality of resource groups. In an embodiment, the SRS configuration includes sets of SRS ports of SRS resources. In an embodiment, the SRS configuration includes information regarding associations between SRS port resources and downlink port resources (such as CSI-RS ports, DMRS ports, etc.). Also included may be information about mappings between the ports.

The access node transmits an indication of SRS resources (block 1305). In an embodiment, the indication of the SRS resources indicates a SRS resource group to use for uplink SRS transmission. In an embodiment, the indication of the SRS resources indicates a subset of the SRS ports of the SRS resource to use for uplink SRS transmission. In an embodiment, the indication of the SRS resources indicates an association to use to determine the SRS ports to use for uplink SRS transmission. The indication of the SRS resources may be transmitted in downlink control information, e.g., in a group DCI or a unicast DCI. When the group DCI is used, the UE identifiers (as described above) are used. The indication of the SRS resources may be included in a message transmitted after the transmission of the SRS configuration. The message including the indication of the SRS resources may be the first message transmitted after the transmission of the SRS configuration. The access node receives uplink SRS (block 1309). The uplink SRS is received in accordance with the SRS resources as indicated.

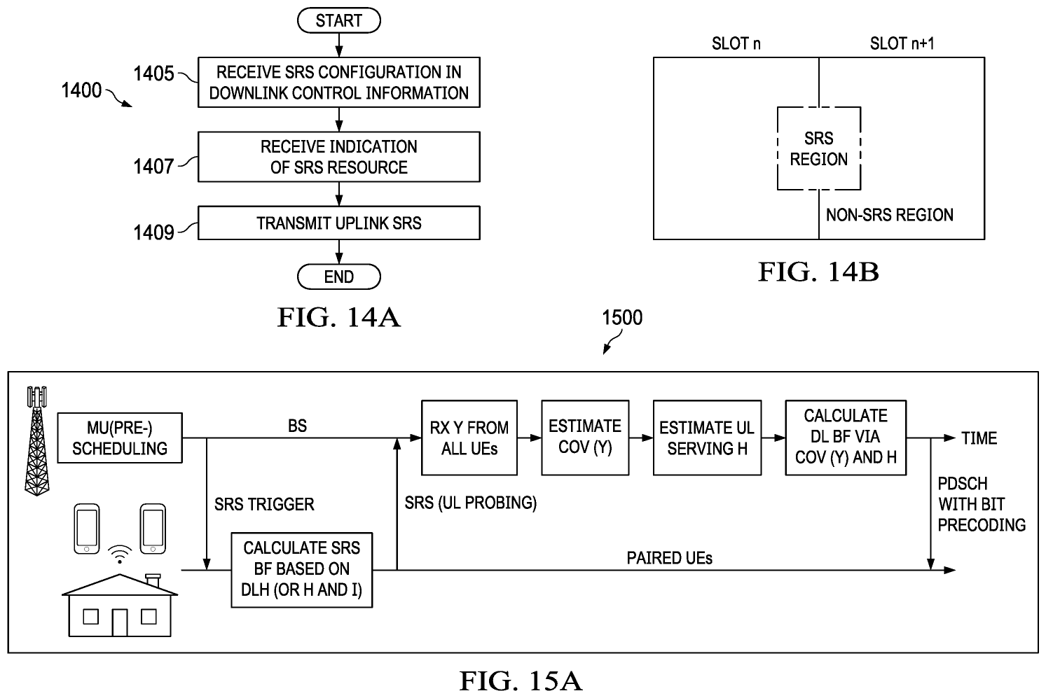

FIG. 14A illustrates a flow diagram of example operations 1400 occurring in a UE transmitting uplink SRSs. Operations 1400 may be indicative of operations occurring in a UE as the UE receives an uplink SRS configuration and transmits an uplink SRS.

Operations 1400 begin with the UE receiving a SRS configuration (block 1405). The SRS configuration may be received in downlink control information, e.g., in a group DCI or a unicast DCI. In the situation when the group DCI is used, the group DCI may be addressed to UEs (e.g., prescheduled UEs) using UE identifiers, which are unique within the group of UEs, but are shorter than typical UE identifiers, so save signaling overhead. In an embodiment, the SRS configuration includes information regarding arrangements of SRS port resources (e.g., combs, offsets, cyclic shifts, symbols, etc.) The SRS port resources may also be grouped into plurality of resource groups. In an embodiment, the SRS configuration includes sets of SRS ports of SRS resources. In an embodiment, the SRS configuration includes information regarding associations between SRS port resources and downlink port resources (such as CSI-RS ports, DMRS ports, etc.). Also included may be information about mappings between the ports. Even if the UE is not an intended recipient of the SRS configuration, the UE receives the downlink control information and attempts to decode the downlink control information.

The UE receives an indication of SRS resources (block 1407). In an embodiment, the indication of the SRS resources indicates a SRS resource group to use for uplink SRS transmission. In an embodiment, the indication of the SRS resources indicates a subset of the SRS ports of the SRS resource to use for uplink SRS transmission. In an embodiment, the indication of the SRS resources indicates an association to use to determine the SRS ports to use for uplink SRS transmission. The indication of the SRS resources may be received in downlink control information, e.g., in a group DCI or a unicast DCI. When the group DCI is used, the UE identifiers (as described above) are used. The indication of the SRS resources may be included in a message received after the reception of the SRS configuration. The message including the indication of the SRS resources may be the first message received after the transmission of the SRS configuration. The UE transmits the uplink SRS (block 1409). The uplink SRS is transmitted in accordance with the SRS resources as indicated.

Some embodiments described above for flexible A-SRS triggering for BiT may lead to higher DCI overhead as it contains more bits in the SRS request field. In addition, the A-SRS triggering may occur more frequently, such as each timing a MU scheduling occurs. To reduce DCI overhead, a few embodiments are provided. First, a more flexible framework to split SRS transmission parameter information among RRC configuration signaling, MAC CE, and DCI would be useful. Minimum standard impact is to keep as much SRS transmission parameter information in RRC and MAC, and DCI contains only the minimum parameter information necessary for dynamic signaling. Furthermore, existing DCIs can be enhanced to include new fields and be associated with new UE behavior.

Embodiments are provided for group-common DCI based overhead reduction.

BiT sounding is to support PDSCH with MU-MIMO, in which multiple UEs are paired together in PDSCH and its DMRS. Therefore, BiT sounding should “mirror” PDSCH DMRS. For example, we know that for PDSCH DMRS Type 1, at most 8 DMRS ports/RBG/cell can be supported. Correspondingly, 8 SRS port resources can be split and indicated to a number of UEs, where the SRS port resources are in terms of cyclic shift, comb and shift, and also possibly OFDM symbols of a RBG of a cell. Then a mapping (i.e., an association) of DL DMRS ports to the SRS port resources can be designed and the port information can be signaled to the UEs via SRS trigger. This may be done in an overhead-efficient way via GC DCI sent to the set of UEs possibly paired for MU transmissions in a slot. The GC DCI can trigger SRS to be sent from UEs at the same time, i.e., a common triggering offset can be used. In addition, other fields, such as CMR/IMR indication, may be included, and the design may be similar to a CSI request field as in DCI format 0_1. An embodiment is a GC DCI for flexible A-SRS triggering with reduced overhead, and the GC DCI is sent to a set of UEs possibly paired for MU transmission in a slot, with a common triggering offset, and each UE is assigned with UE-specific frequency domain resource assignment (FDRA), port allocation (with respect to its serving cell's available SRS port resources, e.g., cyclic shift, comb and shift), and CMR/IMR indication. In an embodiment, a new field of A-SRS triggering offset with slot offset k0 and symbol position is included in the GC DCI. In an embodiment, a new field of A-SRS beamforming with dynamically indicated DL CMR and/or IMR similar to the CSI request field in DCI format 0_1 is included in the GC DCI. In an embodiment, a higher priority for the A-SRS in the GC DCI is assumed by the UE if the A-SRS is assigned with a FDRA and/or port allocation. In an embodiment, the UE-specific port allocation field is replaced by a group-common (joint) port allocation field for all UEs paired on the RBG (or associated frequency domain unit), by indicating only the ranks (number of layers for a data or number of ports for SRS/DMRS) of the paired UEs (the ordering of the UEs may be indicated elsewhere, or UE ID is also included to accompany the rank allocation). With this embodiment, the ports of a UE have to follow a certain pattern such as consecutive or evenly spaced, but as long as the ranks are indicated, each UE can determine its SRS port resources.

TABLE 2
enhancements to DCI 1_1 for SRS probing

| Field (Item) | Bits | Reference | Notes |
|---|---|---|---|
| Frequency | Variable | Variable with Resource Allocation Type | Existing |
| domain | | | for |
| resource | | | PDSCH. |
| assignment | | | Now |
| (FDRA) | | | apply to |
| | | | PDSCH |
| | | | and SRS |
| Time | 4 | Carries the row index of the items in pdsch_allocationListin | Existing |
| domain | | RRC | for |
| resource | | | PDSCH. |
| assignment | | | No |
| (TDRA) | | | change |
| VRB-to-PRB | 0, 1 | 0 bit if only resource allocation type 0 is configured or if | Existing |
| mapping | | interleaved VRB-to-PRB mapping is not configured by high | for |
| | | layers; | PDSCH. |
| | | 1 bit according to Table 7.3.1.1.2-33 otherwise, only applicable | Now |
| | | to resource allocation type 1 | may also |
| | | | apply to |
| | | | SRS |
| PRB | 0, 1 | 0 bit if the higher layer parameter prb-BundlingType is not | Existing |
| bundling | | configured or is set to ‘static’ | for |
| size | | 1 bit if the higher layer parameter prb-BundlingType is set to | PDSCH. |
| indicator | | ‘dynamic’ | Now |
| | | | may also |
| | | | apply to |
| | | | SRS |
| Antenna | 4, 5, 6 | Determined by | Existing |
| port(s) and | | dmrs Configuration Type and max Length | for |
| number of | | See e.g., Table 7.3.1.2.2-2 of TS 38.212 v16.2.0. | PDSCH. |
| layers | | | Now |
| | | | apply to |
| | | | PDSCH |
| | | | and SRS |
| SRS request | 2 or | | Existing. |
| | more | | Now |
| | | | may add |
| | | | more |
| | | | bits for |
| | | | SRS |
| | | | resource |
| | | | selection |
| SRS Time | 0, 4 | Carries the row index of the items | New. |
| domain | | in pdsch_allocationListorpusch_allocationListorsrs_allocationListin | Apply to |
| resource | | RRC. Optional. Default is per RRC configuration | SRS. |
| assignment | | | Optional. |
| | | | Shall |
| | | | be |
| | | | earlier |
| | | | than |
| | | | PDSCH |
| SRS TPC | 0, 2 | Optional for SRS power control | New. |
| command | | | Optional. |
| | | | May |
| | | | present |
| | | | if SRS |
| | | | has |
| | | | separate |
| | | | power |
| | | | control |
| | | | than |
| | | | PUSCH |
| SRS | 0-6 | Optional, indicate SRS beamforming/precoding based on a | New. |
| beamforming | | CMR and optionally an IMR. If not present then a default CMR | Optional. |
| indicator | | is used for SRS beamforming determination | Can |
| | | | reuse |
| | | | 0_1 CSI |
| | | | Request |
| | | | field |
| | | | design |
| . . . | | | Other |
| | | | fields: |
| | | | same as |
| | | | before |

Limitations in enhanced 1_1 include: some fields as “Existing for PDSCH. Now may also apply to SRS”; it is not clear under what condition those PDSCH fields are also applied to SRS. The DCI does not have a CSI request. However, for BiT with DL probing to improve the link adaptation, a CSI request is desired; furthermore, enhancing UL DCI 0_1 for SRS probing is not described in much detail.

Embodiments are provided for UE-specific DCI based overhead reduction. To reduce DCI overhead, an embodiment uses DL DCI formats 1_0/1_1 for both A-SRS triggering and PDSCH scheduling, and the SRS and PDSCH have the same PRB/port allocation. In DCI formats 1_0 or 1_1, it already has fields for: i) A-SRS trigger, 2) dynamically indicated PDSCH PRB allocation via a DL FDRA field, 3) dynamically indicated PDSCH ports, and 4) possibly a field of PRB bundling size indicator (as in DCI format 1_1), etc. These fields can be (re)used by the UE for SRS triggering. New fields for BiT purposes are also added, e.g., SRS resource indication, SRS triggering offset (similar to PDSCH SLIV), a field of CMR/IMR indication which may be similar to a CSI request field as in DCI format 0_1. The UE assumes that the FDRA and ports are also applied for the triggered SRS, which can considerably reduce DCI overhead. For the port indication, a mapping (an association) of DCI DL port indication to SRS ports (in terms of cyclic shift, comb and shift) is needed, which can be defined in Rel-17. An embodiment is to reuse UE-specific DCI (e.g., format 1_1) and introduce new fields for flexible A-SRS triggering with reduced overhead, and UE first performs A-SRS transmission according to existing fields of FDRA, port indication, and PRB bundling size indicator, as well as the new fields of SRS resource indicator, SRS triggering offset, and CMR/IMR indication. UE then performs PDSCH reception according to at least the same FDRA and port indication in the same DCI. In an embodiment, a new field of A-SRS triggering offset with slot offset k0 and symbol position is included in the UE-specific DCI. In an embodiment, a new field of A-SRS beamforming with dynamically indicated DL CMR and/or IMR similar to the CSI request field in DCI format 0_1 is included in the UE-specific DCI. In an embodiment, a higher priority for the A-SRS in the UE-specific DCI is assumed by the UE if the A-SRS is assigned with a FDRA and/or port allocation. In an embodiment, the UE supports more receive antenna ports (e.g., for PDSCH and its DMRS) than transmit antenna ports (e.g., for SRS). For example, the UE can only sound on one port. In this case, the UE shall ignore the PDSCH port indication but just sound on the one port. For another example, the UE can only sound on two port but receive on up to four ports. In this case, the UE can still utilize the PDSCH port indication information, i.e., sound on one port if the PDSCH is only one layer, but sound on the two ports if the PDSCH is two or more layers. In an embodiment, the port indication for SRS is not supported but a rank (number of ports or number of layers) indication is supported. That is, the UE uses the rank indicator for the SRS (or PDSCH) for its SRS transmission. The ports associated with the rank are pre-determined based on the standard or RRC configuration.

Embodiments are provided for supporting both UE-specific DCI based overhead reduction and GC DCI based overhead reduction, for flexible A-SRS triggering for interference probing. In an embodiment, GC DCI is an enhanced GC DCI format 2_3 with UE FDRA and port indication. In an embodiment, UE-specific DCI is an enhanced DL DCI formats 1_0/1_1 to reinterpret existing FDRA/port indication fields for SRS transmission. In an embodiment, both above embodiments are supported. In an embodiment, the enhanced GC DCI and/or UE-specific DCI are supported and become new DL DCI formats. In any embodiment, a new field of A-SRS triggering offset with slot offset k0 and symbol position can be included. In any embodiment, a new field of A-SRS beamforming with dynamically indicated DL CMR and/or IMR similar to the CSI request field in DCI format 0_1 can be included. In any embodiment, a higher priority for the A-SRS is assumed by the UE if the A-SRS is assigned with a FDRA and/or port allocation.

In an embodiment, the GC DCI and/or UE-specific DCI are for TDD with UL operating in OFDM (rather than SC-FDMA). In order to properly utilize BiT or SRS probing for DL, the UL and DL should be as symmetric as possible. Because DL is only OFDM, it is more suitable that the UL is also OFDM. This may also be more suitable if the PDSCH/SRS transmissions are not consecutive in the frequency domain, such as with PRB skipping, FDRA type 0 with non-consecutive RBGs, interleaved VRB to PRB mapping, etc.

In an embodiment, the GC DCI and/or UE-specific DCI reuse the PDSCH TDRA design for its SRS triggering offset design. In an embodiment, the GC DCI and/or UE-specific DCI reuse the PUSCH TDRA for its SRS triggering offset design. In an embodiment, the GC DCI and/or UE-specific DCI reuse the PUSCH/PDSCH TDRA for its SRS triggering offset design, but modify the L value configuration and range so that it fits into SRS transmissions. For example, the network may configure SRS to be only on 8-14 OFDM symbols, and hence the current range of L for PUSCH of 4-14 or 1-14 may be modified to 8-14, so that L value can take fewer bits to indicate.

In an embodiment for the GC DCI and/or UE-specific DCI include a new field of A-SRS beamforming with dynamically indicated DL CMR and/or IMR. The field may be similar to the CSI request field in DCI format 0_1, or may reuse the same indication/configuration as the CSI request field. In an embodiment the A-SRS beamforming field is identical to the CSI request field with 0, 1, 2, 3, 4, 5, or 6 bits determined by higher layer parameter report TriggerSize. When all the bits of the field in DCI are set to zero, SRS is not beamformed. A non-zero codepoint of the field in the DCI is mapped to the CMR/IMR associated with a CSI triggering state according to the order of the associated positions of the up to 2^{N}^{_{TS}}−1 trigger states in CSI-AperiodicTriggerStateList with codepoint “1” mapped to the triggering state in the first position. After the UE determines the CMR from the field, the CMR's ports are also selected by the UE according to the antenna port indication field, and the selected CMR ports and the indicated/associated IMR are used by the UE to generate the SRS beamforming for each SRS port.

As described before, the primary purpose of flexible A-SRS is to enable data-specific CSI acquisition, i.e., the CSI acquisition via the flexible A-SRS is for a specific PUSCH/PDSCH transmission, as opposed to for generic, potential transmissions done in legacy systems. Consequently, flexible A-SRS design could be quite different from legacy SRS. For example, legacy SRS may need to cover the entire bandwidth (in one shot or over time) so that the gNB can determine on which PRBs the data transmissions should be scheduled. On the contrary, for a specific PUSCH/PDSCH transmission, the PRB allocation may have already been determined, and hence the flexible A-SRS may only need to cover those PRBs for CSI acquisition purpose. In this sense, a flexible A-SRS can be viewed as a “pilot” for a specific data transmission so that more accurate CSI can be obtained to improve the data transmission performance.

The association of flexible A-SRS to a specific data transmission implies that the flexible A-SRS transmission parameters should be the same as the data transmission parameters as much as possible, such as frequency-domain parameters, spatial domain parameters, etc. This facilitates two aspects of CSI acquisition for the specific data transmission, one for serving channel acquisition and the other for interference acquisition, which are discussed below.

In some embodiments, association of flexible A-SRS to a specific data transmission can be used to probe the quality of the MIMO serving channel (i.e., intra-cell CSI). In single-cell MU-MIMO with ZF or WMMSE, A-SRS can be used to probe DL channel and hence intra-cell interference for the paired UEs within a cell. That is, a UE transmits A-SRS on the PRBs indicated by the network which are to be used for PDSCH, and the network adjust PDSCH precoding based on these partial bandwidth A-SRS, instead of based on P/SP SRS sent by UE regularly to cover the entire wideband and with longer periodicity in typical ZF schemes. That is, the sounding used for ZF/WMMSE can be a flexible A-SRS whose frequency-domain resources, ports, and beamforming are tied to the PDSCH. The A-SRS based ZF with DL interference probing outperforms P/SP-SRS based ZF.

In some embodiments, the association of flexible A-SRS to a specific data transmission can be used to probe information about the prospective inter-cell interference condition, as done in BiT.

To summarize the above, associating flexible A-SRS with a specific data transmission is described. When a flexible A-SRS is linked to the data transmission, the network indicates the UE SRS transmission parameters based on the linked data, e.g., using the frequency domain and spatial domain parameters of a scheduling DCI for the flexible A-SRS as well. The linkage may be implicit when R17 flexible A-SRS is configured in RRC, implicit based on newly configured t field (e.g., available slot position(s)), or other new fields, according to R17 in a scheduling DCI, implicit based on a trigger state which is linked to a R17 flexible A-SRS in a scheduling DCI, or explicit for a scheduling DCI based on a flag in RRC, MAC, or DCI that signals the UE whether a linkage shall be assumed. In addition, the association can be known to the gNB only and transparent to UE, such as for A-SRS triggered by a non-scheduling UL DCI with a set of dynamic parameters for the SRS.

In some embodiments, one flag/switch is introduced to specify if the A-SRS triggered by a DCI reuses some fields from another scheduled/triggered transmission or not. The main purpose of the flag is to make the DCI useful for both BiT purposes and non-BiT purposes with minimum redesign. For example, when the flag is set, the UE shall assume the triggered A-SRS in the DCI reuses a field (e.g., FDRA) of a PDSCH scheduled by this DCI or another DCI, but when the flag is not set, the UE shall not assume the A-SRS reuses a field of another transmission. In other words, the flag serves as an indication to the UE about assuming an association of A-SRS parameters to another transmission or not.

In an embodiment, the flag/switch is a field in a DCI, that is, the association can be indicated dynamically for full flexibility. In an embodiment, the flag is turned on/off via MAC CE. In an embodiment, the flag is turned on/off via RRC configuration for a DCI format.

In an embodiment, the flag is for a DCI that may be used to schedule a PUSCH transmission. An example of this may be DCI format 0_1 or the like, which schedules PUSCH and includes fields for PUSCH transmission such as PUSCH FDRA, antenna port(s), with or without frequency hopping, on UL (uplink carrier) or SUL (supplementary uplink carrier), on which BWP, etc. In an embodiment, the flag is for an association of A-SRS to PUSCH. When the flag is set and an A-SRS is triggered and a PUSCH is scheduled, the UE uses the parameters obtained from some PUSCH fields for the SRS transmission, and the fields may include at least one or more of PUSCH FDRA, PUSCH antenna port(s) indication, PUSCH frequency hopping, UL/SUL indication, BWP indication, closed-loop TPC command, etc. The PUSCH and A-SRS have different timings so that they would not collide, that is, the A-SRS may have its own TDRA, or have an offset relative to the PUSCH such as n slots earlier than the PUSCH. However, when the flag is not set and an A-SRS is triggered, the UE does not use those PUSCH field for the A-SRS transmission. In an embodiment, the flag is a field associated with the SRS request field in the DCI format. In an embodiment, the flag field contains multiple bits to indicate the UE which PUSCH fields should be used for an associated A-SRS, such as a bit for A-SRS reusing PUSCH FDRA/BWP or not, and a bit for A-SRS reusing PUSCH TPC command or not, etc. In an embodiment, the flag is for an association of A-SRS to PDSCH. When the flag is set and an A-SRS is triggered, the UE uses the parameters obtained from some PDSCH fields for the SRS transmission, and the fields may include at least one or more of PDSCH FDRA, PDSCH antenna port(s) indication, PDSCH frequency hopping, BWP indication, PRB-to-VRB interleaving, etc. However, when the flag is not set and an A-SRS is triggered, the UE does not use those PDSCH field for the A-SRS transmission. The associated PDSCH is not scheduled with this DCI but the association is specified to the UE so that the UE can link to the correct PDSCH, which may be done via a common ID used for the SRS and PDSCH (e.g., a field with a ID, or the DCI RNTI, etc.) or via their timing relation (e.g., triggered at the same time, triggered within 2 slots, PDSCH scheduled n slot after the A-SRS, n being 1, 2, etc.).

In an embodiment, the flag is for a DCI that may be used to schedule a PDSCH transmission. An example of this may be DCI format 1_1 or the like, which schedules PDSCH and includes fields for PDSCH transmission such as PDSCH FDRA, antenna port(s), PRB bundling size, etc. In an embodiment, the flag is for an association of A-SRS to the PDSCH of the same DCI. When the flag is set and an A-SRS is triggered and a PDSCH is scheduled, the UE uses the parameters obtained from some PDSCH fields for the SRS transmission, and the fields may include at least one or more of PDSCH FDRA, PDSCH antenna port(s) indication, PDSCH PRB bundling size, etc. However, when the flag is not set and an A-SRS is triggered, the UE does not use those PDSCH field for the A-SRS transmission. In an embodiment, the flag is a field associated with the SRS request field in the DCI format. In an embodiment, the flag field contains multiple bits to indicate the UE which PDSCH fields should be used for an associated A-SRS, such as a bit for A-SRS reusing PDSCH FDRA/BWP or not, and a bit for A-SRS reusing PDSCH antenna ports or not, etc.

In an embodiment, the DCI that may schedule the PUSCH or PDSCH or trigger A-SRS may also have a CSI request field. The flag or a bit of the flag indicates to the UE whether the A-SRS is also associated with the CSI request field. When the flag is set, the UE may use the CMR and optionally IMR associated with the CSI request for the A-SRS beamforming. The DCI may be an extension of format 0_1 or 1_1. In the embodiment of DCI with PDSCH scheduling, SRS triggering, and CSI request, the A-SRS may be tied to the scheduled PDSCH (reusing PDSCH FDRA, for example) and/or the CSI request (reusing the CMR/IMR for beamforming). The CSI request may be associated with an aperiodic CSI-RS transmission. This can be especially useful for BiT as one DCI indicates the DL RS for the A-SRS beamforming, the A-SRS parameters shared with the PDSCH, and the PDSCH. The DL RS can also be used for DL probing for MCS adjustment, i.e., the UE reports a CQI but not a PMI to the gNB so that the gNB can perform link adaptation for the PDSCH.

In some embodiment, implicit association of A-SRS to the co-scheduled PDSCH/PDSCH is done via DCI parameters, e.g., certain SRS trigger states (e.g., >=4 where 4 is the number of legacy SRS trigger states that can be indicated in a legacy DCI, or linked to a SRS w/o FDRA, etc.), the presence of certain DCI fields configured (e.g., SRS TDRA field), matching the DCI type and SRS usage, etc., in a scheduling DCI.

Flexible A-SRS spatial-domain parameters include beamforming and SRS port(s). As described above, flexible A-SRS can be used to reflect the CSI for a specific UL/DL data transmission. The data transmission is typically beamformed. Therefore, the flexible A-SRS should be beamformed in the same way. In some cases the PUSCH beamforming follows the SRS beamforming (i.e., SRI-based PUSCH), but in some other cases, the PUSCH beamforming goes beyond existing SRS and relies on TPMI, for example, for interference consideration and so on. In other words, the existing SRS beamforming is a bit limited and can be further improved.

For SRS with usage of “codebook”.

Legacy SRS with usage of “codebook” is generally not precoded, but a precoded SRS may be useful here. The SRS beamforming and port indication may reuse/enhance existing TPMI field design, i.e., add a new field for flexible A-SRS triggering DCI to indicate the SRS TPMI using the existing TPMI field design, if the SRS is not triggered with a co-scheduled PUSCH. An SRI field may not be needed as it should refers to this SRS itself, unless it is needed to refer to a different reference SRS with usage of “codebook.” In addition, the A-SRS can reuse the TPMI field of the co-scheduled PUSCH if the SRS is used for CSI acquisition for the co-scheduled PUSCH transmission, which can be indicated with, e.g., a flag bit as described for frequency-domain parameters. The SRI field may refer to this SRS itself, or a different reference SRS with usage of “codebook.”

For SRS with “antennaSwitching” for PDSCH

Legacy SRS with usage of “antennaSwitching” is generally not precoded, but a precoded SRS may be useful here. The current SRS beamforming for antennaSwitching is not specified in the standards. It may be understood as an identity matrix precoding for the number of ports used for a sounding. To enhance this, in an embodiment, SRS beamforming can be based on a linked CSI-RS, such as a PL RS or a CSI-RS used for spatial relation info, which is already linked to the SRS. In an embodiment, SRS beamforming for antennaSwitching is based on a newly configured associatedCSI-RS. This may be further enhanced to more flexibly link to a different CSI-RS via DCI indication, that is, a SRS resource may be linked to multiple associatedCSI-RS by RRC configuration and/or MAC activation, and the DCI can indicate one of them dynamically. However, the resulting beamforming can only reflect the DL channel condition and cannot reflect the DL interference condition. An enhanced SRS beamforming to reflect both DL channel and interference conditions is desirable, that is, the SRS beamforming may be based on both a CSI-RS, i.e., a CMR, and a IMR. The embodiment techniques can reuse/enhance existing design of CMR/IMR indication in the CSI request field in DCI format 0_1. For the SRS port indication, we may reuse the co-scheduled PDSCH port indication field.

For SRS with Usage of “Noncodebook” for PUSCH:

The current beamforming is based on the configured associatedCSI-RS. This may be enhanced to more flexibly link to a different CSI-RS via DCI indication, that is, a SRS resource may be linked to multiple associatedCSI-RS by RRC configuration and/or MAC activation, and the DCI can indicate one of them dynamically. However in TDD, the resulting beamforming can only reflect the UL channel condition and cannot reflect the UL interference condition. Based on UL-DL reciprocity, an enhanced SRS beamforming to reflect both UL channel and interference conditions is desirable, that is, the SRS beamforming may be based on both a CSI-RS, i.e., a CMR, and an IMR. Embodiment techniques can reuse/enhance existing design of CMR/IMR indication in the CSI request field in DCI format 0_1. For the port indication, we may reuse/enhance existing PUSCH port indication field design, and we may reuse the PUSCH port indication field if the A-SRS is used for CSI acquisition for the co-scheduled PUSCH/PDSCH transmission. In some embodiments, the SRS with usage of “noncodebook” is used for both UL CSI acquisition with UE transmit beamforming and DL CSI acquisition with UE receive beamforming. In an embodiment, the UE transmit beamforming for SRS has the same spatial domain transmission filter as the UE receive beamforming used for the reception of the CSI-RS and optional IMR.

In some cases, the UE can only transmit on one antenna and may not even be able to support transmit antenna switching. However, this does not imply that SRS from only one antenna cannot be used by the gNB for spatial-domain transmission enhancement, as the gNB generally has many receive antennas and can utilize single-antenna sounding to adjust its receive beamforming and hence transmit beamforming in TDD. Therefore, even if a UE cannot beamform and/or has only one transmit antenna to sound, it can still be useful for gNB receive/transmit beamforming. In this case, no spatial-domain parameter needs to be signaled to the UE with supportedSRS-TxPortSwitch as notSupported. That is, no SRS beamforming or layer indication is needed, and the SRS beamforming field and layer indication field can be blank or not configured. If the SRS is associated with a PDSCH with beamforming and a layer number, the PDSCH beamforming and layer indication should be ignored by the UE for SRS. In some embodiments, the UE reports supportedSRS-TxPortSwitch as t1ry, e.g., t1r2, t1r4, etc., then antenna switching is possible with each time, one transmission antenna is used for sounding. Then the SRS beamforming does not need to be signaled by the gNB or used by the UE. The sounding is performed y times to provide full MIMO information to the gNB, so the SRS port number does not need to be signaled by the gNB or used by the UE. Even if the associated PDSCH is indicated with, e.g., 2 layers, the UE should still sound on all y ports. In some embodiments, the UE reports supportedSRS-TxPortSwitch as t2ry, e.g., t2r4, t2r6, etc., then antenna switching is possible with each time, two transmission antenna is used for sounding. Then the SRS beamforming does not need to be signaled by the gNB or used by the UE. The sounding is performed y/2 times to provide full MIMO information to the gNB, so the SRS port number does not need to be signaled by the gNB or used by the UE. Even if the associated PDSCH is indicated with, e.g., 2 layers, the UE should still sound on all y ports. Similar embodiments for txry (x<y) antenna switching configurations.

In an embodiment, an uplink DCI (e.g., 0_1) that may schedule a PUSCH indicates no PUSCH is scheduled via the UL-SCH indicator, i.e., UL-SCH bit is zero. The fields that are designed for PUSCH can be redefined for A-SRS triggering parameters. For example, a few bits may be used for A-SRS triggering offset or TDRA. A few bits may be used for A-SRS port indication. A few bits may be used for A-SRS FDRA. And so on.

In an embodiment, a downlink DCI (e.g., 1_1) that may schedule a PDSCH indicates no PDSCH is scheduled. The no-PDSCH may be indicated via a DL-SCH indicator, i.e., DL-SCH bit is zero, or may be indicated via setting a few bits in the original PDSCH fields to be zero, such as the Downlink assignment index bits, FDRA/TDRA bits, etc. The fields that are designed for PUSCH can be redefined for A-SRS triggering parameters. For example, a few bits may be used for A-SRS triggering offset or TDRA. A few bits may be used for A-SRS port indication. A few bits may be used for A-SRS FDRA. And so on.

In summary, UL DCI may be used for SRS trigger with or without PUSCH, with or without CSI request, with the SRS tied to PUSCH (e.g., FDRA, etc.) or not tied to PUSCH, with the SRS tied to PDSCH or not tied to PDSCH, with the SRS tied to the CSI request field or not tied to the CSI request field. DL DCI may be used for SRS trigger with or without PDSCH, with or without CSI request, with the SRS tied to PDSCH (e.g., FDRA, etc.) or not tied to PDSCH, with the SRS tied to the CSI request field or not tied to the CSI request field.

In some embodiments, the PDSCH transmission may be one of multiple PDSCH transmissions following a DCI, and the multiple PDSCH transmissions are associated with an RS such as an SRS (e.g., the DCI includes a reference signal association flag). In an embodiment, the PDSCH is a semi-persistent scheduled (SPS) PDSCH activated by the DCI, and the SRS is a semi-persistent (SP) SRS (implicitly via an association flag or explicitly via a bit field indicating the activation of the SP SRS) activated by the DCI, and the DCI includes a Cyclic redundancy check (CRC) scrambled by a Configured Scheduling (CS) Radio Network Temporary Identifier (RNTI) (CS-RNTI). For SPS PDSCH, some transmission parameters may be configured by RRC configuration signaling, but some other transmission parameters (e.g., FDRA and modulation order) may be provided by a DCI with a CRC scrambled by a CS-RNTI. After receiving the DCI, the SPS PDSCH can be periodically received by the UE according to a periodicity configured by RRC configuration signaling (i.e., the SPS PDSCH is activated by the DCI) until the UE receives another DCI with a CRC scrambled by a CS-RNTI to deactivate or modify the SPS PDSCH. So, the SPS PDSCH transmissions may reuse the same DCI (the activation DCI) for multiple periodic PDSCH. The SPS PDSCH is useful for periodic traffic loads with reduced scheduling latency and DCI overhead, such as in URLLC and XR.

The use of a DCI as opposed to MAC CE for activation has the benefit of reduced latency. In an embodiment, the DCI that activates the SPS PDSCH also activates the SP-SRS for interference probing. The SP-SRS transmission parameters (e.g., the FDRA, PRB allocation, spatial-domain parameters, periodicity, etc.) may be the same as the SPS PDSCH's parameters if the reference signal association is set to a specific value. Therefore, one or more slots/OFDM symbols (or any other time-domain offset configured or indicated to the UE) before each of the PDSCH transmissions, a SRS is transmitted to probe the interference, and the access node then adjusts the PDSCH precoding for the PDSCH transmission, and this repeats for multiple SRS/PDSCH transmissions. In an embodiment, the SRS periodicity may be a multiple of the PDSCH periodicity. That is, one SRS probing outcome may be used for several PDSCH transmissions, such as one SRS followed by 2 PDSCH transmissions in 2 TTIs. An advantage of this design is to better accommodate the periodic DL data arrival which cannot be fit into one transmission but cannot wait for another SRS due to the latency requirement. This design is also useful for limiting SRS overhead and accommodate TDD UL/DL slot structure. In an embodiment, semi-persistent CSI-RS and optionally CSI-IM may be activated by the DCI activating the SPS PDSCH. Each of the SP CSI-RS and CSI-IM may be sent before each SRS transmission so that the SRS may adjust its precoding based on the CSI-RS/CSI-IM. These embodiments have the advantages that multiple SRS probing operations and multiple PDSCH transmissions can be supported with a single DCI and hence, has very low control overhead. Furthermore, the PDSCH transmissions may progressively improve as the procedure effectively becomes iterative BIT, which is suitable for, e.g., XR with very frequent and periodic traffic arrivals, fixed wireless access (FWA), etc. With the reference signal association flag, the reference signal transmissions (e.g., the SRS transmissions) may be based on either the same parameters as the PDSCH transmissions or the pre-configured SRS parameters.

In some embodiments, one DCI may schedule multiple PDSCH transmissions over multiple slots (i.e., multi-slot scheduling or PDSCH repetition), and PDSCH precoding adjustment can be performed for the PDSCH transmissions after the A-SRS transmission triggered by the DCI. In yet some other embodiments, periodic, semi-persistent PDSCH, SRS, or CSI-RS are specified by higher-layer signaling such as RRC configuration signaling or MAC CE without using any DCI, and the SRS still reuses the PDSCH parameters for its transmission (e.g., the frequency-domain or spatial-domain parameters if the reference signal association flag is set to a specific value) and uses pre-configured SRS parameters for its transmission if the reference signal association flag is not set to the specific value. If the PDSCH parameters are configured to change over different TTIs, the SRS transmission immediately before a PDSCH transmission also adopts the same parameters as the PDSCH, for example.

The above embodiments on multiple PDSCH transmissions can be extended for multiple PUSCH transmissions. In some embodiments, the PUSCH transmission is one of multiple PUSCH transmissions following a control signaling, and the multiple PUSCH transmissions are associated with a RS such as a SRS (e.g., a DCI or RRC message includes a reference signal association flag). In an embodiment, the PUSCH is a Configured Grant (CG) Type 1 (specified by a RRC message without additional activation via DCI) or Type 2 (pre-configured by a RRC message and then activated by a DCI), and the SRS is a periodic SRS or semi-persistent (SP) SRS (implicitly via an association flag in RRC or explicitly via a bit field indicating the activation of the SP SRS) activated by the DCI, and the DCI includes a Cyclic redundancy check (CRC) scrambled by a Configured Scheduling (CS) Radio Network Temporary Identifier (RNTI) (CS-RNTI). For CG PUSCH Type 1, all transmission parameters are configured by RRC configuration signaling (e.g., FDRA and modulation order), and its associated RS may be additionally configured. After the configuration, the CG PUSCH Type 1 can be periodically sent by the UE according to a periodicity configured by RRC configuration signaling, and the associated RS can also be periodically transmitted before each PUSCH transmission or some PUSCH transmissions. For CG PUSCH Type 2, some transmission parameters are configured by RRC configuration signaling, but some other transmission parameters (e.g., FDRA and modulation order) may be provided by a DCI with a CRC scrambled by a CS-RNTI. After receiving the DCI, the CG PUSCH Type 2 may be periodically sent by the UE according to a periodicity configured by RRC configuration signaling (i.e., the CG PUSCH is activated by the DCI) until the UE receives another DCI with a CRC scrambled by a CS-RNTI to deactivate or modify the CG PUSCH. So, the CG PUSCH transmissions may reuse the same control message (e.g., the activation DCI) for multiple periodic PUSCH.

Associated with the CG PUSCH transmissions, the periodic RS or semi-persistent RS transmission parameters (e.g., the FDRA, PRB allocation, spatial-domain parameters, periodicity, etc.) may be the same as the CG PUSCH's parameters if the reference signal association is set to a specific value. Therefore, one or more slots/OFDM symbols (or any other time-domain offset configured or indicated to the UE) before each of the PUSCH transmissions, a RS is transmitted to probe the interference, and the UE then adjusts the PUSCH precoding for the PUSCH transmission, and this repeats for multiple RS/PDSCH transmissions. In an embodiment, the RS periodicity is a multiple of the PUSCH periodicity. That is, one RS probing outcome may be used for several PUSCH transmissions. In an embodiment, the RS may be CSI-RS.

In some embodiments, one DCI may schedule multiple PUSCH transmissions over multiple slots, i.e., multi-slot scheduling or PUSCH repetition, and PUSCH precoding adjustment can be performed for the PUSCH transmissions after the RS transmission triggered by the DCI. If the PUSCH parameters are instructed to change over different TTIs, the RS transmission immediately before a PUSCH transmission also adopts the same parameters as the PUSCH.

Dynamically indicated A-SRS frequency-domain resource allocation can also be useful for SRS capacity enhancements and collision avoidance. For SRS capacity enhancement, additional resources can be allocated to SRS, but SRS with pre-configured parameters may lack sufficient flexibility to utilize the additional resources. The gNB may need to determine some A-SRS parameters on the fly to fit the A-SRS into the available resources. Frequency-domain flexibility is especially important for flexible A-SRS due to considerable frequency-domain flexibility, in terms of the number of subbands (or PRBs), their frequency locations, the comb (2, 4, 8) and shift, frequency hopping, etc. If the A-SRS is not associated with a specific data transmission, its PRB allocation may not require the full flexibility as PUSCH/PDSCH PRB allocation, so a simplified PUSCH/PDSCH FDRA field design with fewer bits may be adopted, which can also incorporate the partial frequency sounding agreed for SRS coverage/capacity enhancement. For example, SRS may be transmitted in 1/P_{F}m_{SRS,B} contiguous PRBs, which can use PUSCH/PDSCH FDRA type 1 to specify a starting position and number of PRBs. As the number of PRBs is limited by a few choices of PF values, the resulting resource indication values (RIVs) are also limited and can be mapped to fewer bits. If the starting position has to be restricted to the hopping bandwidth, then RIV size is even smaller.

TPC command field may be added/reused/repurposed for SRS in a UE-specific DCI.

For a scheduling DL DCI, a new TPC command field for the triggered SRS may be added. Alternatively, if a SRS TPC field is not added, the SRS TPC can still rely on existing mechanism of GC DCI format 2_3.

For a scheduling UL DCI, a new TPC command field for the triggered SRS may be added if the SRS power control is separate from PUSCH power control, but a new TPC field is not needed if the SRS power control is joint with the PUSCH power control. In the case of separate power control, if a SRS TPC field is not added, the SRS TPC can still rely on existing mechanism of GC DCI format 2_3.

For a non-scheduling UL DCI, the unused PUSCH TPC command field, or any unused bits, may be repurposed for a new TPC command field for the triggered SRS. If a SRS TPC field is not added, the SRS TPC can still rely on existing mechanism of GC DCI format 2_3.

The power-domain parameters may also include open-loop PC parameters, such as Po, which can also be included in the DCI for SRS.

The current SRS trigger state can indicate at most 2 bits (with optionally 1 more bit for UL/SUL indication). This is far from sufficient. More bits may be added. For example, if M-TRP is supported, a bit to differentiate the TRPs may be added. Alternatively, no dedicated differentiation bit for TRPs (or CCs, or UL/SUL) is needed, and the SRS resources are associated with more DCI trigger states. The pro of this approach is that it is most straightforward to support and improves flexibility. The cons include that it may still lack the considerable flexibility needed for various applications unless the DCI overhead is high. Therefore, this is approach can be supported, but it is not a scalable approach and has to be accompanied with other enhancements outlined elsewhere.

Embodiments are provided for GC DCI to trigger SRS. An embodiment is to enhance the current GC DCI format 2_3. The enhanced DCI format 2_3 does not have a FDRA field to reduce overhead. The DCI may include multiple SRS blocks, each may be used to trigger one or more SRS transmissions. Each block includes a SRS request field (optional), one or more SRS TPC command fields if the block can trigger multiple SRS transmissions. The blocks may be for the same UE or multiple UEs. Each of the UEs that receive a SRS trigger in a block in the DCI assumes reception of another DCI with FDRA, and use that FDRA for the triggered SRS. The other DCI may be a UL DCI, e.g., 0_1 or enhanced 0_1 or 0_1 or so on, in which case the FDRA and possibly other fields such as MVP indication, UL/SUL indication, frequency hopping indication, antenna port indication, etc., are also used by the UE for the A-SRS transmission. The other DCI may be a DL DCI, e.g., 1_1 or enhanced 1_1 or 1_0 or so on, in which case the FDRA and possibly other fields such as antenna port indication, PRB bundling size indication, etc., are also used by the UE for the A-SRS transmission. In an embodiment, each UE's block in the GC DCI is associated with a flag/switch, and when the flag is set, the UE uses a linked DCI's field for the A-SRS, and when the flag is not set, the UE does not look for a linked DCI's field for the A-SRS. The flag may be a field in the GC DCI, may be activated/deactivated via MAC CE, or may be configured via RRC signaling. The linked DCI is specified to the UE so that the UE can link to the correct DCI, which may be done via a common ID used for the SRS and PDSCH (e.g., a field with a ID, or the DCI RNTI, etc.) or via their timing relation (e.g., triggered at the same time, triggered within 2 slots, PDSCH scheduled n slot after the A-SRS, n being 1, 2, etc.). In an embodiment, the GC DCI does not have to be for paired UEs only. Each UE's block and the fields within the block are pre-configured via RRC signaling, and when a UE's SRS request field has all the bits being 0, no SRS is triggered for that UE, and when a UE's SRS request field is not all 0, A-SRS is triggered.

In an embodiment, in a GC DCI, a same TDRA field is used for all the triggered SRS in GC DCI. That is, each UE does not have a UE-specific TDRA field, which saves overhead. In an embodiment, in a GC DCI, a few choices of TDRAs are provided for all the UEs using the DCI, and each TDRA is associated with an ID. Then in each UE's block, a field is used to indicate to the UE which one of the TDRAs that the UE shall apply based on the ID. In an embodiment, individual TDRA fields are configured for each SRS block, that is, each SRS triggered may be associated with a different TDRA. In an embodiment, the SRSs triggered by the DCI are transmitted at the same slot but possibly in different OFDM symbols. Then the DCI includes a group-common TDRA field (e.g., k0 for slot offset) that applies to all the triggered SRS from this DCI, and an individual TDRA field (e.g., OFDM symbol location, SLIV, etc.) for each SRS block.

The new A-SRS TDRA field should be added to UE-specific DCI and/or GC DCI. The bitwidth of the field can be configurable depending on how many combinations of triggering offset, starting symbol location, and the number of symbols are needed for a particular A-SRS resource. In light of existing UL/DL TDRA fields of at most 4 bits, likely this A-SRS field requires at most 4 bits. The SRS TDRA field may have configurable possible values/combinations for slot offset, starting symbol, and symbol length. For example, the slot offset may have 2 choices, i.e., 1 bit for the first available slot or the second available slot. Or the slot offset may have 4 choices, i.e., 2 bit for the first, second, third, and fourth available slots. The starting symbol and symbol length may be jointly indicated. Depending on the scenario, the gNB may select a number of combinations as the codepoints.

In some embodiments, if additional time domain related parameters need to be indicated, 1 or 2 more bits may be added for a new field to indicate the time-domain sounding behavior over the allocated multiple OFDM symbols (if applicable), which we may call as time-frequency domain parameter/behavior: repetition, hopping, or splitting. An A-SRS time-domain resource allocation field can indicate not only the triggering offset, but also the duration of the SRS transmission in terms of the number of OFDM symbols, other time domain behavior related parameters such as repetition, whether to allow non-consecutive symbols, etc. For example, if the indicated A-SRS symbol length is longer than the RRC-configured A-SRS symbol length, the A-SRS may be indicated to repeat, hop, or split in time domain to fill up the indicated symbols.

### Repetition

The same allocated bandwidth (i.e., PRBs) is repeated the same way over the multiple OFDM symbols.

### Frequency Hopping

Legacy hopping operations are to be performed over the multiple OFDM symbols.

### Splitting

As described above, when K non-contiguous SRS segments are to be transmitted, the gNB may indicate to the UE to autonomously split the K segments over K OFDM symbols and hence on each OFDM symbol, SRS transmission is only on a segment of contiguous PRBs.

Thus, an A-SRS time-frequency domain resource allocation field may be added, and it can indicate repetition, hopping, or splitting. This is similar to PUSCH frequency repetition and PUSCH frequency hopping over the same slot or multiple slots. In addition, if the association between the A-SRS and PUSCH is specified, and if the PUSCH performs frequency hopping over the same slot or multiple slots, the same frequency hopping over the same slot or multiple slots can be performed for the A-SRS.

If n separate soundings on n A-SRS resource sets are to be triggered using the same DCI, n such TDRA fields are to be included. However, to avoid significant redesigns of the existing DCI, an upper bound of n should be imposed for at least UE-specific DCIs. For example, only n=1,2,[3] may be allowed for UE-specific DCI. If larger n is desirable, a GC DCI is more suitable than using a UE-specific DCI. The n separate sounding may be on one or more slots, on one or more carriers, etc.

The following DCI enhancements may be utilized. One enhancement may be adding a field for A-SRS time-domain resource allocation, as described above. This enhancement may apply to UE-specific DCI and/or GC DCI. Another enhancement may be allowing dynamically indicated frequency-domain allocation, port allocation, and beamforming, reusing existing DCI field designs as much as possible, and reusing existing DCI fields as much as possible.

Dynamically indicated A-SRS frequency-domain resource allocation can be beneficial to a number of cases. For one, aperiodic SRS enhancement for interference probing in TDD massive MIMO which can significantly improve PDSCH spectrum efficiency. For another, the A-SRS may be used for CSI acquisition for a PUSCH transmission, and hence the A-SRS may be transmitted only on a set of PRBs that may be scheduled for the PUSCH, rather than on the wideband which consumes excessive resources and energy or on a pre-configured bandwidth on which the gNB cannot acquire relevant CSI for the PUSCH transmission. In addition, dynamically indicated A-SRS frequency-domain resource allocation can also be useful for SRS coverage/capacity enhancements related to partial frequency sounding. Similarly, dynamically indicated A-SRS port allocation and beamforming are also useful and should be supported.

To support flexible A-SRS triggering with dynamically indicated frequency-domain allocation, we note that existing DCI formats already provide well-designed PUSCH/PDSCH FDRA fields and thus may be reused or enhanced for A-SRS. In addition, if the A-SRS is used for CSI acquisition for the co-scheduled PUSCH/PDSCH transmission (as opposed to generic purposes and not tied to a specific transmission), the A-SRS may be transmitted on the same PRBs as the PUSCH/PDSCH. In this case, the gNB may indicate to the UE to reuse the PUSCH/PDSCH FDRA field for the A-SRS, which helps avoid high DCI overhead.

Likewise, to support flexible A-SRS triggering with dynamically indicated port allocation, we may reuse/enhance existing PUSCH/PDSCH port indication field design, and we may reuse the PUSCH/PDSCH port indication field if the A-SRS is used for CSI acquisition for the co-scheduled PUSCH/PDSCH transmission. To support flexible A-SRS triggering with dynamically indicated beamforming, for non-codebook based SRS beamforming, we can reuse/enhance existing design of CMR/IMR indication in the CSI request field in DCI format 0_1, and for codebook based SRS beamforming, we can reuse/enhance existing TPMI field design, and reuse the TPMI field if the SRS is used for CSI acquisition for the co-scheduled PUSCH transmission.

If n separate soundings on n A-SRS resource sets are to be triggered using the same DCI, n such FDRA fields, n such port indication fields, etc., are to be included. However, to avoid significant redesigns of the existing DCI, an upper bound of n should be imposed for at least UE-specific DCIs. For example, only n=1,2,[3] may be allowed for UE-specific DCI.

### Enhancing UE-Specific UL DCI and DL DCI for A-SRS

UE-specific UL DCI (e.g., DCI format 0_1, 0_2) can be enhanced for A-SRS. For example, we can extend the DCI for A-SRS triggering without a co-scheduled PUSCH, by adding fields indicating SRS TDRA, FDRA, port(s), and beamforming in the vacant PUSCH fields. Furthermore, we can extend the DCI for A-SRS triggering with co-scheduled PUSCH, by reusing the PUSCH fields indicating FDRA, port(s), and beamforming for the SRS, if the SRS is used for CSI acquisition, UL power control information acquisition, UL beam acquisition, etc., for the co-scheduled PUSCH transmission. In this case, UE first performs A-SRS transmission according to existing fields of FDRA and port indication, as well as the new fields of SRS resource indicator, SRS triggering offset, and CMR/IMR indication. UE then performs PUSCH transmission according to at least the same FDRA and port indication in the same DCI, and possibly following a TPC command sent in a GC DCI for this UE based on the gNB-received power from the A-SRS.

On the other hand, UE-specific DL DCI (e.g., DCI format 1_1) can be enhanced for A-SRS. Embodiment techniques can extend the DL DCI for A-SRS triggering with co-scheduled PDSCH, by reusing the PDSCH fields indicating FDRA, port(s), and beamforming for the SRS, if the SRS is used for CSI acquisition for the co-scheduled PDSCH transmission. In this case, UE first performs A-SRS transmission according to existing fields of FDRA, PRB bundling size indicator, and port indication, as well as the new fields of SRS resource indicator, SRS triggering offset, and CMR/IMR indication. UE then performs PDSCH reception according to at least the same FDRA and port indication in the same DCI.

### Enhancing GC DCI for A-SRS

GC DCI (such as DCI format 2_3 with multiple blocks, each block may be used to trigger one A-SRS transmission) can be enhanced for A-SRS.

A basic design principle for the GC DCI for A-SRS could be that the A-SRS transmissions scheduled by the GC DCI are likely to be about the same time, such as in the same slot or a couple of neighboring slots. Based on this principle, embodiment techniques may add a group-common field in the GC DCI to indicate a slot/symbol position that applies to all the A-SRS transmissions triggered by the DCI, together with UE-specific fields for UE-specific symbol offsets (can cross slot) for the UEs, or block-specific fields for block-specific symbol offsets for the SRS blocks.

Moreover, as the A-SRS transmissions may be on the same slot(s), pre-configured SRS transmission resources (e.g., symbol locations, PRBs, combs/shifts, cyclic shifts) may not fit well and there is likely to be resource conflicts, causing some SRS transmissions to be dropped. To resolve this, the GC DCI may indicate SRS multiplexing via UE-specific SRS port resources (symbols, comb/comb shift, and cyclic shifts).

The above GC DCI enhancement may be shown in FIG. 14B. FIG. 14 B illustrates an example of GC DCI for A-SRS transmissions. The SRS region starting symbol is indicated as a field common to all SRS blocks. Each SRS block is further assigned with a subset of port resources within the region. A SRS region is indicated for a SRS GC DCI, via a starting symbol in a slot and optionally a length (in terms of a number of symbols, such as a TDRA field; can go across slot boundary) and frequency domain allocation. All SRS indicated in the GC DCI multiplex all the SRS port resources within the SRS region. The GC DCI common timing field may indicate only a reference symbol and a reference PRB/RBG. Then all the block-specific resource allocations are relative to the reference symbol and reference PRB/RBG. The port resources in time domain include symbol location, comb and shift for a comb, cyclic shift. Each SRS block within the GC DCI is assigned with a subset of the port resources that are orthogonal to other SRS blocks' assigned resources.

### Time Offset and TDRA Indication

Time offset and TDRA indication may indicate UL TDRA or DL TDRA. Time offset and TDRA indication may be non-slot based (2, 4, 7 symbols for SRS, in UL slot or even DL slot for TDD). SRS triggering time offset and time-domain resources may utilize non-slot based structure. Even preemption (for eMBB/other UEs) can be used to allow very flexible SRS, to insert a SRS and optionally UL/DL URLLC data. A PDCCH may schedule a URLLC data (UL/DL) as well as a CSI-acquisition RS (SRS/CSI-RS), possibly all in the same slot, on different symbols

In sum, the present disclosure support at least the following flexible A-SRS triggering enhancements in UE-specific DCI: adding a field for A-SRS time-domain resource allocation; allowing dynamically indicated frequency-domain allocation, port allocation, and beamforming, reusing existing DCI field designs as much as possible, and reusing existing DCI fields as much as possible; and enhancing UE-specific UL DCI and DL DCI for A-SRS.

The present disclosure support at least the following flexible A-SRS triggering enhancements in group common DCI: design principle of the A-SRS transmissions scheduled by a GC DCI in the same or neighboring slots, including adding a group-common field for the slot/symbol position common to all the SRS transmissions, and indicating SRS multiplexing via UE-specific SRS port resources (symbols, comb/comb shift, and cyclic shifts).

For UL DCI 0_1 and 0_2 to trigger aperiodic SRS without data and without CSI, the unused fields for SRS parameter indication may be re-purposed, including adding new fields for A-SRS and reusing the design of some unused fields for A-SRS. The unused PUSCH TDRA field may be repurposed for A-SRS time-domain resource allocation on one or more OFDM symbols, with the PUSCH TDRA field design reused as much as possible. Also, a new field may be added to indicate the sounding behavior over the allocated multiple OFDM symbols: repetition, hopping, or splitting. The unused PUSCH FDRA field, port allocation field, beamforming field, TPC command field, etc., may be re-purposed for A-SRS, with the same field design reused as much as possible. The SRS request field may be designed to include more bits for indicating SRS resource(s)/resource set(s).

For UL DCI 0_1 and 0_2 with data and DL DCI 1_1 and 1_2 with data to trigger aperiodic SRS, one A-SRS TDRA field may be added for A-SRS time-domain resource allocation on one or more OFDM symbols, with the PUSCH/PDSCH TDRA field design reused as much as possible (up to 4 bits). Also, a new field may be added to indicate the sounding behavior over the allocated multiple OFDM symbols: repetition, hopping, or splitting. Further, one flag bit may be added to indicate whether or not the A-SRS also use PUSCH/PDSCH fields for its parameter indication, including FDRA field, port allocation field, beamforming field, etc.

Enhance GC DCI 2_3 to optionally include at least a TDRA field to a SRS triggering block, for flexible triggering offset, and increase the bits for indicating SRS resource(s)/resource set(s).

### Scheduling DL DCI

The following enhancements are needed for UE-specific scheduling DL DCI (e.g., DCI formats 1_1, 1_2) with usage “antennaSwitching.” When the association between A-SRS and the co-scheduled PDSCH is set, the A-SRS can reuse the PDSCH fields indicating FDRA, port(s), and beamforming for the SRS, if the SRS is used for CSI acquisition for the co-scheduled PDSCH transmission. In this case, UE first performs A-SRS transmission according to existing fields of FDRA, PRB bundling size indicator, and port indication, as well as the new fields of SRS resource indicator (optional if the SRS trigger state is used), SRS time t, and CMR/IMR indication for SRS beamforming. UE then performs PDSCH reception according to at least the same FDRA and port indication in the same DCI. When the association is not set, i.e., the A-SRS is not linked to a data, then the UE will only use the SRS t indication and time-frequency domain parameters for its sounding, and other SRS parameters are based on RRC configuration. The triggered A-SRS should be “antennaSwitching” to have the association as set; otherwise the association is expected as not set.

In some embodiments, the scheduling DCI schedules multiple PDSCH transmissions with the same transmission parameters except for their time-domain resource allocations, such as over several slots/Ms, with different OFDM symbol offsets, with different numbers of OFDM symbols, etc. The flexible A-SRS triggered with the same DCI and associated with these PDSCH transmissions enables the A-SRS based CSI acquisition to be used for multiple times for the multiple PDSCH transmissions.

For scheduling DL DCI, one or more of the following indications may be added: indication of association to the co-scheduled data transmission, indication of the field t (e.g., available slot position(s)); indication of frequency-domain parameters of comb and shift (optional); indication of time-frequency domain parameters including: indication of repetition, indication of frequency hopping, indication of splitting for PDSCH FDRA Type 0 RBG based DCI (unless “almost contiguous”) (this may not be needed for Type 1 PRB based DCI); and indication of SRS beamforming via CMR/IMR.

So, for scheduling DL DCI, indication of association to the co-scheduled data, t, comb and shift, repetition, hopping, splitting (for Type 0 FDRA only), and beamforming via CMR/IMR may be added.

### Scheduling UL DCI

For UE-specific scheduling UL DCI (e.g., DCI formats 0_1, 0_2) triggering flexible A-SRS with usage “codebook” or “noncodebook,” generally the enhancements are similar to those for scheduling DL DCI. The triggered A-SRS should be “codebook” or “noncodebook” to have the association with data as set; otherwise the association is expected as not set. When the association between A-SRS and the co-scheduled PUSCH is set, the A-SRS can reuse the PUSCH fields indicating FDRA, port(s), and beamforming for the SRS, if the SRS is used for CSI acquisition, UL power control information acquisition, UL beam acquisition, etc., for the co-scheduled PUSCH transmission. In this case, UE first performs A-SRS transmission according to existing fields of FDRA and port indication, as well as the new fields of SRS resource indicator, SRS triggering offset, and CMR/IMR indication. UE then performs PUSCH transmission according to at least the same FDRA and port indication in the same DCI, and possibly following a TPC command sent in a GC DCI for this UE based on the gNB-received power from the A-SRS.

When the association is not set, i.e., the A-SRS is not linked to a data, then the UE will only use the SRS t indication and time-frequency domain parameters for its sounding, and other SRS parameters are based on RRC configuration.

In some embodiments, the scheduling DCI schedules multiple PUSCH transmissions with the same transmission parameters except for their time-domain resource allocations, such as over several slots/Ms, with different OFDM symbol offsets, with different numbers of OFDM symbols, etc. The flexible A-SRS triggered with the same DCI and associated with these PUSCH transmissions enables the A-SRS based CSI acquisition to be used for multiple times for the multiple PUSCH transmissions.

For scheduling UL DCI, one or more of the following indications may be added: indication of association to the co-scheduled data transmission; indication oft; indication of frequency-domain parameters of comb and shift (optional); indication of time-frequency domain parameters including: indication of repetition, indication of frequency hopping, and indication of splitting for PUSCH FDRA Type 0 RBG based DCI (unless “almost contiguous”) (this may not be needed for Type 1 PRB based DCI; indication of SRS beamforming via CMR/IMR, e.g., by existing CSI request field, for “noncodebook” SRS (this may not be needed for “codebook” SRS).

So, for scheduling UL DCI, indication of association to the co-scheduled data, t, comb and shift, repetition, hopping, splitting (for Type 0 FDRA only), and beamforming via CMR/IMR (for “noncodebook” only) may be added.

### Non-Scheduling UL DCI

UE-specific UL DCI (e.g., DCI formats 0_1, 0_2) without scheduling can be enhanced for A-SRS. For example, fields indicating SRS TDRA, FDRA, port(s), and beamforming in the vacant PUSCH fields may be added. The SRS usage may be “antennaSwitching,” “codebook,” “noncodebook,” or “beamManagement.” The following fields may be added: indication oft; indication of FDRA; indication of comb and shift, cyclic shift, and sequence (optional); indication of time-frequency domain parameters: including: indication of repetition, indication of frequency hopping, and indication of splitting for PUSCH FDRA Type 0 RBG based DCI (unless “almost contiguous”) (this may not be needed for Type 1 PRB based DCI); indication of SRS beamforming via CMR/IMR, e.g., by existing CSI request field, for “antennaSwitching,” “noncodebook,” and “beamManagement” SRS (This is not needed for “codebook” SRS); indication of TPC command; indication of SRS resource, or trigger state.

So, for non-scheduling UL DCI, add indication of, t, FDRA, comb and shift, cyclic shift, sequency, repetition, hopping, splitting (for Type 0 FDRA only), beamforming via CMR/IMR (for “antennaSwitching”, “noncodebook”, and “beamManagement”), TPC command, and SRS resource or trigger state.

Embodiment procedure of the UE behavior determination based on the received DCI and the high level signaling configuration is described below. The received DCI is DL DCI format 1_1, or 1_2 (which is used to schedule PDSCH transmission in existing mechanisms) or any extension of them.

If A-SRS is triggered, and if the TDRA field is configured and indicates a valid value, and if the A-SRS usage is antennaSwitching, and if the A-SRS PDSCH association is explicitly or implicitly set (Conditions 1), the A-SRS uses the PDSCH FDRA (and ports, etc., when applicable) and other SRS parameters according to the DCI and/or the high level signaling configuration. Further, if FDRA Type 0 or frequency-domain splitting is indicated, the A-SRS applies frequency-domain splitting (autonomously for each non-contiguous segment for Type 0, or according to the indication.

Otherwise, if Conditions 1 above are not met, the A-SRS does not use the PDSCH FDRA (and ports, etc., when applicable), and the ASRS uses SRS parameters according to the DCI and/or the high level signaling configuration.

If CMR and optionally IMR are indicated for the A-SRS, the A-SRS uses the CMR and the optional IMR for beamforming; otherwise, A-SRS is for each port, and there is no beamforming.

The Received DCI is UL DCI for 0_1, 0_2 with PUSCH Scheduled.

If A-SRS is triggered, and if the TDRA field is configured and indicates a valid value, and if the A-SRS usage is codebook or noncodebook, and if the A-SRS PUSCH association is explicitly or implicitly set (Conditions 2), the A-SRS uses the PUSCH FDRA (and #ports, etc., when applicable) and other SRS parameters according to the DCI and/or the high level signaling configuration. Further, if FDRA Type 0 or frequency-domain splitting is indicated, the A-SRS applies frequency-domain splitting (autonomously for each non-contiguous segment for Type 0 if specified, or uses almost-contiguous allocation, or according to the splitting indication. Further, if the A-SRS usage is noncodebook, the A-SRS uses the CMR and the IMR for beamforming if CMR and IMR are indicated for the A-SRS, and the A-SRS uses the CMR for beamforming if IMR are not indicated for the A-SRS. If the A-SRS usage is codebook, The A-SRS uses TPMI for beamforming.

Otherwise, if Conditions 2 above are not met, A-SRS does not use the PUSCH FDRA (and ports, etc., when applicable), and the A-SRS uses SRS parameters according to the DCI and/or the high level signaling configuration.

The Received DCI is UL DCI for 0_1, 0_2 without PUSCH Scheduled.

If A-SRS is triggered, and if the SRS TDRA field is configured and indicates a valid value (Conditions 3), the A-SRS uses the DCI FDRA (and #ports, etc., when applicable) and other SRS parameters according to the DCI and/or the high level signaling configuration. Further, if FDRA Type 0 or frequency-domain splitting is indicated, the A-SRS applies frequency-domain splitting (autonomously for each non-contiguous segment for Type 0 if specified, or uses almost-contiguous allocation, or according to the splitting indication). Further, if the A-SRS usage is noncodebook or antennaSwitching, the A-SRS uses the CMR and the IMR for beamforming if CMR and IMR are indicated for the A-SRS; otherwise, the A-SRS uses the CMR for beamforming (noncodebook) or the A-SRS is for each port and no beamforming. If the A-SRS is codebook and not antennaSwitching, A-SRS uses TPMI for beamforming.

Many embodiments or variations can be obtained from the above embodiment procedure. In an embodiment, if the PUSCH is configured with frequency hopping, and the A-SRS is associated with the PUSCH, then the same frequency hopping behavior is to be followed by the UE for the A-SRS. In an embodiment, to be backward compatible with legacy SRS with usage antennaSwitching which has no precoding or antenna virtualization specified, the CMR/IMR configuration for the SRS may be optional. If CMR/IMR is configured for the SRS with usage antennaSwitching, then the SRS should use the CMR/IMR for beamforming, otherwise the SRS should not be precoded or use virtualization based on UE implementation. In another embodiment, if CMR/IMR is configured for the SRS with usage antennaSwitching, an indication to the UE is signaled so that the UE knows whether SRS beamforming based on the CMR/IMR should be used or not. In legacy antennaSwitching, it takes time for the UE to switch its physical antenna, and the switching time is specified as the minimum guard period between two SRS resources of an SRS resource set for antenna switching in TS 38.214, which is 1 or 2 OFDM symbol durations. However, for antennaSwitching for DL CSI acquisition with CMR and optionally IMR configured, the UE may be able to sound on multiple ports on the same OFDM symbol or on consecutive OFDM symbols without any switching time. Therefore, when CMR and optionally IMR are configured, the UE and gNB should not apply the guard period. Alternatively, a new SRS usage may be added, for which CMR and optionally IMR are configured are configured for the SRS, and beamforming according to the CMR/IMR is also expected.

Collision avoidance is to proactively take into account a potential A-SRS collision ahead of time and attempt to prevent it by changing the A-SRS resources/parameters in time/frequency/cyclic shift/sequence domains so that the A-SRS can be multiplexed with other transmissions rather than overlapped with other transmissions. Collision avoidance is mainly done by gNB. Collision handling is to reactively resolve a conflict, mainly by UE but also interpreted in the same way by the gNB. With higher capability of collision avoidance by gNB, the UE's complexity due to collision handling will be reduced.

### Collision Avoidance

It may be emphasized that the collision avoidance operation per se is a gNB implementation issue and has no standard impact, but the current standards do not have sufficient flexibility to allow collision avoidance. Therefore, standardization effort is required to provide the network with collision avoidance capability.

The standard support for collision avoidance includes dynamic indication of SRS parameters, such as starting symbol and symbol length, PRB/subband number or locations, comb and shift, cyclic shift, sequence number, etc. For example, if an intended A-SRS with a set of parameters will collide with another transmission on a symbol, the A-SRS may be indicated with a different symbol or a different symbol duration to avoid the collision, so that both transmissions can be performed. For another example, if an intended A-SRS with a set of parameters will collide with another SRS on the same subcarriers on a symbol, the A-SRS may be indicated with a different comb shift to avoid the collision, so that both SRS can be transmitted. For another example, if two intended A-SRS transmissions are on the same symbol and subcarriers, and their cyclic shifts are too close to each other, one or both of the A-SRS may be indicated with a different cyclic shift so that they can be more easily separable.

If multiple A-SRS transmissions are 1-1 associated with multiple data transmissions, and if data have not collision, then in principle the SRS can have no collision as long as there are sufficient SRS time-domain resources. For example, if UL slot occurs once every 5 TTIs, then 4 OFDM symbols in that UL slot can be used by A-SRS linked to PDSCH transmissions on 4 DL slots, and another OFDM symbol in that UL slot can be used by A-SRS linked to PUSCH transmissions on the UL slot or another UL slot. On each symbol, the same multiplexing as the linked data multiplexing can be indicated to the UE so that no A-SRS collision for the same cell will occur on those OFDM symbols.

### Collision Handling

With sufficient flexibility supported for A-SRS indication and SRS capacity enhancements, generally collisions can be significantly reduced. There may still be some cases that collisions occur. For example, a PUSCH transmission previously configured or scheduled may occupy a number of PRBs and symbols, leaving no resources for A-SRS which is needed now; in other words, the gNB needs to change its previous decision to allow the A-SRS to be transmitted. For another example, P/SP SRS is configured and will be transmitted on a slot, but the gNB now needs A-SRS to be transmitted on that slot, and with the A-SRS, the P/SP SRS is no longer needed; in this case, the gNB may indicate the A-SRS with (partially or fully) overlapping resources with the P/SP SRS so that the P/SP SRS is dropped. Therefore, A-SRS collision handling should be mostly to overwrite a previous decision, such as a PUSCH, P/SP SRS, etc., based on priority rules. The flexible A-SRS may have a higher priority to overwrite other transmissions, but may still have a lower priority than new decisions made by the gNB after the triggering (accounting for decoding/processing times) or ACK/NACK feedback. For example, A/N and AP UL triggered after (later than) R17 flexible A-SRS>R17 flexible A-SRS>other AP UL>P/SP UL, and further details can be discussed.

For flexible A-SRS enhancement, embodiment techniques support collision avoidance via dynamic indication of SRS parameters in time/frequency/cyclic shift/sequency domains, and embodiment techniques support collision handling via priority rules: A/N and AP UL triggered after R17 flexible A-SRS>R17 flexible A-SRS>other UL.

SRS coverage may be limited by the transmission power of the UE if the DL coverage for the UE is not an issue. To overcome the power limitation, the following embodiments are provided.

An embodiment is to focus the power on the narrower bandwidth or fewer subcarriers to increase the UL receive SNR. Current sounding already supports non-wideband transmissions (4 RBs at the minimum), but in a coverage-limited scenario, the narrowband sounding may be further split into multiple partial sounding to cover the bandwidth of one narrowband sounding. This is also useful to take advantage of frequency selectivity and to reduce interference between SRS from different UEs. In addition, this also improves the frequency-selective precoding by SRS.

To support partial bandwidth sounding, the standards may allow 1-2 PRB sounding, PRB skipping, larger comb (i.e., RE skipping), etc.

However, an issue that may arise from partial bandwidth sounding is that the gNB may not be able to combine multiple partial bandwidth sounding transmissions to obtain wideband CSI, since each sounding transmission is generally associated with an unknown random phase. This needs to be addressed.

An embodiment is to repeat in time domain, including multiple symbols in the same slot and across multiple slots. Simple repetition can be supported. Repetition with a different comb/comb shift or (staggered in REs/PRBs or with different densities) may also be allowed.

An embodiment is to allow TD-OCC in SRS. In CSI-RS, TD-OCC is supported so that multiple OFDM symbols can be utilized to strengthen CSI-RS transmission. This can also be adopted in SRS.

To increase SRS capacity, embodiments should allow more UEs to sound at the same time, and allow more sounding opportunities/resources as well as SRS transmissions multiplexed with other signals.

An embodiment is to use less time/frequency resources for each SRS transmission. If each SRS transmission occupies fewer subcarriers and/or OFDM symbols, then more UEs can sound and SRS capacity is increased. For example, SRS comb may be increased to 8 or 12. For another example, PRB skipping or narrower bandwidth for SRS may be considered and analyzed, which can also improve SRS coverage described above.

An embodiment is to allow non-orthogonal low-correlation sequences. The number of orthogonal sequences for SRS is limited. To allow more SRS transmissions be multiplexed on overlapping time/frequency resources, non-orthogonal low-correlation sequences may be adopted. The network can configure/trigger the transmission of non-orthogonal sequences when needed, such as when SRS capacity becomes a limiting factor for operations, but can still use only orthogonal sequences at other times.

An embodiment is to allow more time/frequency resources to be used by SRS. For example, all 14 symbols in a UL slot may be used for SRS, which is already supported in NR-U. To provide this flexibility, flexible configuration and triggering of SRS need to be standardized. This also motivates flexible A-SRS triggering to dynamically/opportunistically utilize unused UL symbols/PRBs or even DL symbols/PRBs in TDD. To support the latter, a SRS switching gap (due to RF retuning) similar to SRS carrier-based switching may be used for harvest some unused DL symbols, i.e., the UE switches from DL reception to SRS transmission on one or several OFDM symbols according to network configuration/indication after a SRS switching gap, and switches back to DL reception after the SRS transmission and another SRS switching gap. Additionally, concurrent SRS+PUCCH or even SRS+PUSCH may allow more SRS opportunities.

Regarding Class 1 enhancements of time bundling, this can possibly improve SRS coverage. A concern that may exist is the potential phase discontinuity issue. After further analysis, we understand that though in general this can be a problem, there exist at least some scenarios in which the phase changes between the SRS transmissions are sufficiently small, e.g., when the SRS transmissions are close enough in time, when the doppler is small, or when the UE's transmit chain can well maintain the phase between transmissions. In any event, the gNB can decide if the phase discontinuity is severe or not, and if not, it can configure the UE to sound in time bundles and then the gNB performs joint processing. This can be up to gNB implementation. As long as the standards provide sufficient support for configuration and/or indication of SRS transmissions in time bundles, the rest can be standard transparent. The current SRS configuration seems generally sufficient, and SRS indication via DCI can be enhanced to trigger time-bundled transmissions.

For SRS coverage/capacity enhancements Class 1 (Time bundling), at least for some scenarios, the potential phase discontinuity is sufficiently small, and time bundling can be supported. Further, standard support for time bundling via more flexible configuration/indication of SRS transmissions may be provided, and leave time bundling transparent to UE.

Regarding Class 2 enhancements of increased repetition, this is arguably the most straightforward way to improve SRS coverage and should be supported. The current standards already allow repetitionfactor values of n1, n2, n4 and nrofSymbols values of n1, n2, n4, n8, n12 to be configured. To enhance, repetitionfactor values of n3, n6, n8, etc., may be added, and nrofSymbols values of n3 (which complements n4 in a half slot), n5 (which complements n2 in a half slot), n6 (which complements n1 in a half slot and n8 in a slot), n10 (which complements n2 in a slot), and n14 may be added. One SRS occasion may also extend to the next slot, for example, for nrof Symbols of n6, the SRS may use the 2 last symbols in a slot and 4 symbols in the next slot, and the 4 symbols in the next slot may be at the beginning of that slot if the symbols are available SRS time-domain resources, or may be at a different time-domain location based on the available SRS time-domain resources. RRC configuration and DCI indication of SRS transmission repetitions/symbols can be enhanced.

The increased repetition may cause that fewer signals/UEs can be multiplexed at the same time. This negative effect may be partially compensated via partial frequency sounding, which will be discussed below. However, this means that the standards may need to consider joint design of time-domain repetition and partial frequency sounding, such as when the time-domain repetition increases, the frequency-domain resources may become sparser or less. This is also reasonable as the repetition is meant to improve coverage, which is usually accompanied with narrow bandwidth transmission. An example of a joint repetition-partial frequency sounding design is as follows. If the SRS nominal bandwidth is m PRBs with p repetitions and comb c, and when the repetition is increased by r times, that is, r*p repetitions in total, then the SRS bandwidth is reduced to floor(m/r) PRBs with comb c. If r1 is a factor of r and r1*c is a supported comb, the SRS bandwidth may be reduced to floor(m/r1) PRBs with comb r1*c

For SRS coverage/capacity enhancements Class 2 (Increase repetition), embodiment techniques may allow more repetitionfactor values and more nrofSymbols values to be configured/indicated, allow cross-slot resource mapping, allow joint design of partial frequency sounding with increased repetition to compensate the negative impact on SRS capacity.

Candidate schemes for Class 3 partial frequency sounding may include: Scheme 3-1: RB-level partial frequency sounding; Scheme 3-2: Subcarrier-level partial frequency sounding; Scheme 3-3: Subband-level partial frequency sounding; Scheme 3-4: Partial-frequency sounding schemes assisted with CSI-RS, where SRS is transmitted in a subset of RBs of the original SRS frequency resource; and Scheme 3-5: Dynamic change of SRS bandwidth with RB-level subband size scaling.

Class 3 enhancements of partial frequency sounding mainly include more flexibility on SRS frequency resources to allow SRS transmission on partial frequency resources within the legacy SRS frequency resources. Regarding Class 3 enhancements of partial frequency sounding, this is useful to focus the power on the narrower bandwidth or fewer subcarriers to increase the UL receive SNR. Current sounding already supports non-wideband transmissions (4 PRBs at the minimum), but in a coverage-limited scenario, the narrowband sounding may be further split into multiple partial sounding to cover the bandwidth of one narrowband sounding. This is also useful to take advantage of frequency selectivity and to reduce interference between SRS from different UEs. In addition, this also improves the frequency-selective precoding by SRS. The partial bandwidth granularity may be changed to 1-2 PRBs. However, to reduce signaling overhead, some restrictions may be considered. If the A-SRS is associated with a specific PDSCH/PUSCH transmission, the SRS may have the same granularity as PDSCH/PUSCH frequency-domain resource allocation granularity. For example, for resource allocation Type 0, which is RBG based, SRS may also follow the same RBG based granularity (a RBG is 2/4/8/16 PRBs). For resource allocation Type 1 (contiguous allocation in frequency domains, i.e., the frequency resources allocated for a transmission occupies contiguous PRBs), which is PRB based, SRS bandwidth may also be as small as one PRB.

Partial frequency sounding can also be achieved by spreading the transmission for one SRS resource (or resource set) into multi-hopping transmissions. For example, an SRS resource on 8 PRBs (PRBs 1-8) may be done in 2-hopping transmissions, the first hop on PRBs 1-4 and the second on 5-8. A hop may be configured/indicated based on frequency-domain granularity, such as a PRB (i.e., each hop has n PRBs) or an RBG (i.e., each hop has n RBGs). The different hops may also have different combs and/or different comb shifts. For example, an SRS resource of comb 4 and shift 0 may be split into 2 hops, the first with comb 8 and shift 0, and the second with comb 8 and shift 4.

Detailed analysis can show that Schemes other than 3-2 are all in this category with possibly different granularities of N consecutive PRBs. For Scheme 3-1, N=1; Scheme 3-3, N=4 or N can be the same as PDSCH/PUSCH frequency-domain resource allocation granularity as described above (i.e., N=2, 4, 8, 16); Scheme 3-4, N=1, 2, 4, 8, etc.; and Scheme 3-5, N=2 or 4. Although the schemes may be motivated in different ways, their standard impact may be similar and one unified design may be used to support all of them.

To summarize, Schemes 3-1, 3-3, 3-4, and 3-5 belong to Category A: Partial frequency sounding with granularity of N PRBs, where N=1, 2, 4, 8, 16, etc., and may be supported by one unified design.

Partial frequency sounding can also be achieved if each SRS transmission occupies fewer subcarriers, then more UEs can sound and SRS capacity is increased, which can also improve SRS coverage when the power is more focused. For example, SRS comb may be increased to 6, 8, or 12. Scheme 3-2 falls into this category, referred to as Category B: Partial frequency sounding with larger combs.

Note that Category A and Category B may be combined in some cases.

For conventional sounding, the SRS occupies one contiguous segment of the bandwidth, which prevents PAPR from becoming too high. Depending on the specific proposal/design/implementation, several candidate schemes (e.g., Schemes 3-1, 3-2, and 3-3) consider transmitting SRS on non-contiguous segments in the frequency domain, which generally leads to some small increase of PAPR. Based on our evaluations, about 0.5 dB to 3 dB increase of PAPR may be seen if two of more non-contiguous SRS segments are transmitted on the same OFDM symbol.

Several technical solutions may be applied to address the PAPR issue. First, as the PAPR increase is not significant and can be pre-estimated by both the gang and the UE, the gNB may decide some non-contiguous SRS transmissions only for some cell-center UEs. This is an implementation-oriented solution and does not require any standard support. Second, when K non-contiguous SRS segments are to be transmitted, the gNB may indicate to the UE to autonomously split the K segments on K OFDM symbols and hence on each OFDM symbol, SRS transmission is only on a segment of contiguous PRBs. This prevents the PAPR increase and further reduces the SRS transmission bandwidth, which is suitable for cell-center and cell-edge UEs. This requires some standard support, for example, the split may be indicated in the triggering DCI as part of the time-domain behaviour for the SRS on multiple OFDM symbols. In summary, non-contiguous SRS segments can still be supported without significant increase of PAPR.

Potential Standard Support for Category a Schemes with Possible Repetitions/Splits

Since Rel-15, PUSCH Type 0 FDRA may allow for some transmissions to be non-contiguous. More precisely, those PUSCH transmissions are called “almost contiguous allocation,” specified in the standards as follows:
TS 38.214:
In frequency range 1, only “almost contiguous allocation” defined in [8, TS 38.101-1] is allowed as non-contiguous allocation per component carrier for UL RB allocation for CP-OFDM.
In frequency range 2, non-contiguous allocation per component carrier for UL RB allocation for CP-OFDM is not supported.
TS 38.101-1:
If CP-OFDM allocation satisfies following conditions, it is considered as almost contiguous allocation

NRB_gap/(NRB_alloc+NRB_gap)≤0.25
and NRB_alloc+NRB_gap is larger than 106, 51 or 24 RBs for 15 kHz, 30 kHz or 60 kHz respectively where NRB_gap is the total number of unallocated RBs between allocated RBs and NRB_alloc is the total number of allocated RBs. The size and location of allocated and unallocated RBs are restricted by RBG parameters specified in clause 6.1.2.2 of TS 38.214 [10]. For these almost contiguous signals in power class 2 and 3, the allowed maximum power reduction defined in Table 6.2.2-1 is increased by

CEIL{10 log 10(1+NRB_gap/NRB_alloc),0.5} dB,
where CEIL{x,0.5} means x rounding upwards to closest 0.5 dB. The parameters of RBStart,Low and RBStart,High to specify valid RB allocation ranges for Outer and Inner RB allocations are defined as following:

RBStart,Low=max(1,floor((NRB_alloc+NRB_gap)/2))

RBStart,High=NRB−RBStart,Low−NRB_alloc−NRBgap
For the UE maximum output power modified by MPR, the power limits specified in clause 6.2.4 apply.

By the same token, in some embodiments, almost contiguous allocation for A-SRS should also be supported, so that the A-SRS for a specific PUSCH transmission in FR1 can match the PUSCH frequency-domain allocation.

In an embodiment, when K non-contiguous SRS segments are to be transmitted, the gNB may indicate to the UE to autonomously split k segments over k OFDM symbols, where k<=K, and each of the k segments is almost contiguous. The UE and gNB can determine whether a set of PRBs are almost contiguous or not based on the above definition. The UE starts from the one end (e.g., the lowest frequency PRB end, or the highest), and tries to add the next scheduled PRB to a segment. If the PRB is added to the segment and the segment is still almost contiguous, this PRB is added and the UE moves to the next scheduled PRB; If the PRB is added to the segment and the segment violates almost contiguous requirement, this PRB is not added to this segment, and the UE moves to the next segment with this PRB. This process continues until all scheduled PRBs are added to the k segments. Then each segment is almost contiguous and satisfies RAM/RAN4 standards. The value k does not need to be signaled to the UE, as the UE (and the gNB) can obtain k without any ambiguity. In an embodiment, the network specifies whether the UE should transmit K contiguous segments over K symbols or should transmit k contiguous segments over k symbols.

All schemes in Category A can be supported with a unified design which also incorporates possible repetitions/splits/hopping over multiple OFDM symbols. A DCI triggering a partial frequency sounding includes a FDRA field with a bitmap, each bit indicating sounding on N consecutive PRBs. Another field in the DCI can be used to indicate if the sounding is to be repeated on the indicated multiple OFDM symbols, hopped on the indicated multiple OFDM symbols, or split on the indicated multiple OFDM symbols.

Some embodiments support to transmit SRS only in 1/P_{F}m_{SRS,B} contiguous RBs in one OFDM symbol, where m_{SRS,B} indicates the number of RBs configured by BSRS and CSRS. Some potential PF values may be from {2, [3], 4, 8}. Other candidate values, e.g., non-integer values for PF, are also possible. SRS sequence shorter than the minimum length supported in the current specification is not pursued. It is applicable to frequency hopping and non-frequency hopping.

For the PF value candidates, a larger PF value can lead to more reduction of sounding bandwidth and improve coverage and capacity, but that may also cause the sounding to be more fragmented and difficult for the gNB to obtain some channel information, such as the delay information. For flexibility, it should be up to the gNB to potentially configure/indicate different PF values whenever needed, so multiple PF values should be supported.

For different SRS resources, different PF values should be allowed. For example, for SRS resource 1, m=48 PRBs, PF may take value from {1,2,3,4,8}, resulting bandwidth of 48, 24, 16, 12, 6 PRBs; but for SRS resource 2, if m=40 PRBs, and the PF candidate value set is still {1,2,3,4,8}, the resulting bandwidth becomes 40, 20, 13.3 (may be rounded to 13 or 14),10.5, and some of the bandwidths may not be desirable as the granularity of 4 PRBs (or even 2 PRBs) cannot be maintained; for SRS resource 3, if m=20 PRBs, the resulting bandwidths becomes 20, 10, 6.7 (rounded to 6 or 7), 5, 2.5 (rounded to 2 or 3), which has some redundant values as the other 2 resources. In this case, it is more reasonable to use different sets of PF values for different SRS resources, such as {1.5/4.5} for SRS resource 2, which leads to 40, 32, 8 PRBs, having granularity of 4 (or 8) PRBs and can be used to cover different PRB numbers as other resources. Note that fractional PF values can be especially useful here.

Therefore, it would be desirable to allow more candidate PF values, including fractional PF values, for the gNB to choose from.

For the frequency hopping and non-frequency hopping, both should be supported. In general, the per-hop sounding bandwidth is already quite narrow with hopping, but can be very wide without hopping. Thus, reducing the bandwidth for non-hopping SRS is needed. Note that for capacity/collision handling enhancements, it may be more costly to support reduced bandwidth for non-hopping SRS by RRC configuration of more SRS resources with various bandwidth values. Significantly more flexibility can be achieved by signaling PF values to a SRS resource to change its bandwidth, for both frequency hopping and non-frequency hopping.

For PF signaling mechanism, a few values can be pre-configured for each SRS resource, and MAC/DCI may specify one or more of them in a more dynamic fashion. Alternatively but equivalently, the resulting bandwidth values can be pre-configured for each SRS resource, and MAC/DCI may specify one or more of them in a more dynamic fashion.

For the signaling of the location of the 1/P_{F}m_{SRS,B} RBs, they may be located according to an offset relative to a reference position. The reference position may be within the current per-hop bandwidth and is the starting PRB position of the per-hop starting PRB, or is the starting position of the SRS resource (given by freqDomainShift), or is any starting PRB specified by the gNB. It seems the reference position being the starting position of the SRS resource is most reasonable, as it provides the network with sufficient flexibility in frequency domain while keeping the sounding within the configured bandwidth. The offset relative to the reference position may be specified according to a certain granularity, such as subband of 4 PRBs, 4/P_{F} PRBs (rounded as needed), 1 PRB, RBG, etc. Note that (1) whether hopping is configured, and (2) the starting PRB position and bandwidth of the SRS transmission when hopping is not configured, and (3) the starting PRB position and bandwidth of the per-hop SRS transmission when hopping is configured, when partial frequency sounding is not configured, are already specified in existing standards (refer to TS 38.211, “3rd Generation Partnership Project; Technical Specification Group Radio Access Network; NR; Physical channels and modulation,” v16.3.0 (2020 September), Clause 6.4.1.4.3, which is incorporated herein by reference).

For SRS coverage/capacity enhancements Class 3 (Partial frequency sounding), embodiment techniques may support SRS partial bandwidth granularity based on PDSCH/PUSCH resource allocation granularity; support SRS comb 6, 8, and 12; and support multi-hopping SRS resource (one SRS resource done by multiple hopping in terms of PRB/RBGs and/or comb shifts).

Regarding comb enhancement, comb 8 (or 12, 16, etc.) and shifts should be supported in RRC configuration. In addition, for better flexibility and collision avoidance purpose, MAC or even DCI-based indication for comb and shift should also be supported. All 3 combs, i.e., comb 2, comb 4, and comb 8, as well as their shifts, may be indicated dynamically for full flexibility, which results in 4 bits control overhead. If lower overhead is desirable in some cases, the comb may be fixed and only the comb shift is indicated dynamically.

In 3GPP Release 17 further enhanced MIMO (FeMIMO) sounding reference signal enhancements include: identifying and specifying enhancements on aperiodic SRS triggering to facilitate more flexible triggering and/or DCI overhead/usage reduction; specifying SRS switching for up to 8 antennas (e.g., xTyR, x={1, 2, 4} and y={6, 8}); evaluating and, if needed, specifying the following mechanism(s) to enhance SRS capacity and/or coverage: SRS time bundling, increased SRS repetition, partial sounding across frequency.

Motivations regarding flexible triggering include: limited triggering info in DCI (1, 2, or 3 bits only); inflexible triggering delay; important roles of SRS in DL full MIMO CSI acquisition, BM, UL frequency diversity and MIMO support, etc.; important roles of an aperiodic SRS (A-SRS) in TDD cooperative MIMO via DL interference probing and mitigation including: UE to Tx SRS according to DL (pre-)scheduling results, so that gNB can estimate DL interference and then mitigate DL interference via precoder adjustment; some similarity with DL NZP CSI-RS based interference probing for better MCS. This is also after scheduling and before PDSCH, but with UL SRS for better precoding (hence bi-directional training, BiT); also closely related to SRS coverage/capacity enhancements.

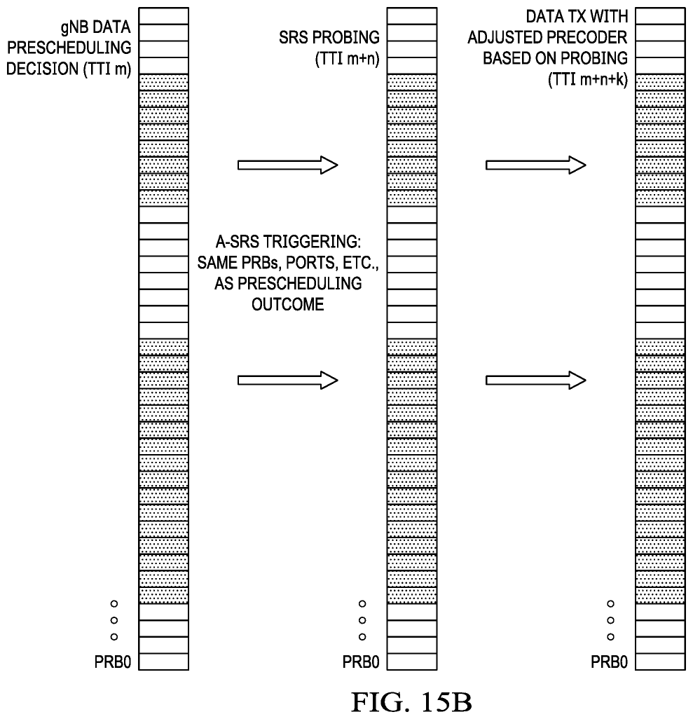

FIG. 15A illustrates an example one-shot BiT operation flow 1500. In BiT, a precoded SRS is based on PDSCH scheduling and then the PDSCH itself. The precoded sounding is based on MU pre-scheduling for the gNB to cooperatively probe the DL interference conditions in the UL.

As shown in FIG. 15A, Cove(Y) captures inter/intra cell interference in UL and the (Cov(Y))⁻¹ h enables UL interference avoidance. Then, by reciprocity, DL Tx with this precoding enables cooperative DL interference avoidance. Theoretical guidance is derived from global optimization.

FIG. 15B illustrates one specific example of BiT based on A-SRS triggering with dynamically indicated partial frequency sounding. Since the SRS transmission is now tied to a specific data transmission, flexible A-SRS triggering can be used. To probe the interference on a subset of PRBs pre-scheduled for data, the UE only needs to sound on the subset of PRBs, based on which data transmission with precoder adjusted from the SRS-based interference probing can be done.

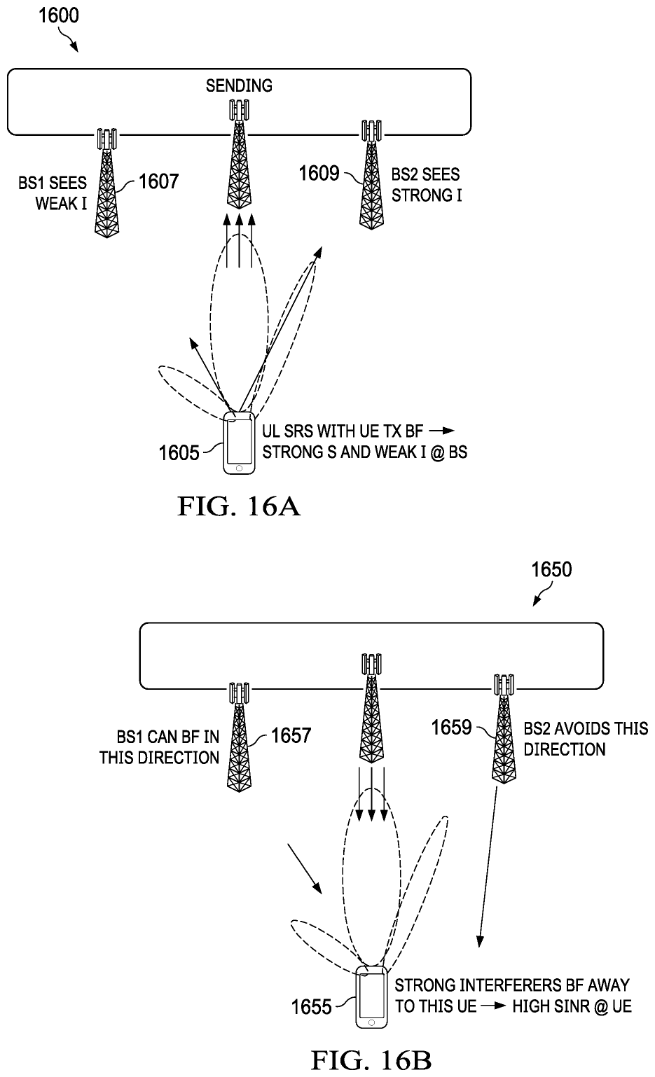

FIGS. 16A and 16B illustrate communication systems highlighting example interference conditions. Communication system 1600 of FIG. 16A illustrates a situation where UL SRS transmissions made by UE 1605, using transmit beamforming results in weak interference at a first BS 1607, while a second BS 1609 sees strong interference. Communication system 1650 of FIG. 16B illustrates a situation where beamforming may be used to reduce interference to UEs. A first BS 1657 can use beamforming in the direction of UE 1655, but a second BS 1659 avoids beamforming in the direction of UE 1655 because such transmissions may cause high interference at UE 1655.

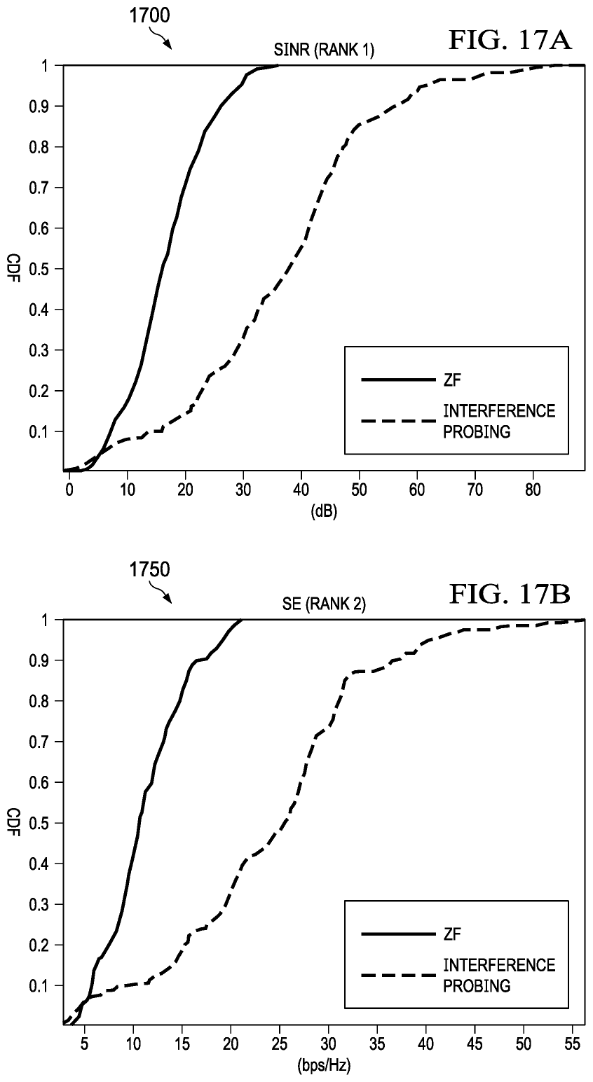

FIGS. 17A and 17B illustrate data plots 1700 and 1750 of example BiT performance.

As related to flexible A-SRS triggering for BiT, SRS may include enhancements with dynamically indicated parameters associated with corresponding DL transmissions. The enhancements may include, A-SRS triggering with dynamically indicated PRB allocation (e.g., FDRA) and port allocation, A-SRS triggering with dynamically indicated DL channel measurement resources (CMR) and/or interference measurement resources (IMR), and A-SRS triggering with flexible triggering delay.

As related to reducing DCI overhead for flexible triggering, motivations include: all the flexible triggering may lead to higher DCI overhead; and BiT may also require more A-SRS triggers.

Example solutions may include: UE-specific DCI for A-SRS with FDRA and port indication (same as PDSCH). However, FDRA may require 5-19 bits in general, and port indication may require 4-6 bits; and Group common DCI to a set of UEs possibly paired for MU transmission in a slot, with FDRA and port indication. However, SRS triggering offsets may not be equal for the set of UEs.

According to an example embodiment, methods and apparatus on how to trigger the SRS transmissions with all the needed SRS parameters in DCI but with reduced DCI overhead, as well as the associated UE assumptions/behavior/configurations for the support are provided.

TABLE 3
Current DCI 1_1 format used for scheduling of PDSCH in one cell.

| Field (Item) | Bits | Reference |
|---|---|---|
| Carrier indicator | 0, 3 | |
| Identifier for DCI | 1 | Set to 1, indicating a DL DCI format |
| formats | | |
| Bandwidth part | 0, 1, 2 | |
| indicator | | |
| Frequency domain | Variable | Variable with Resource Allocation Type |
| resource assignment | | |
| Time domain | 4 | Carries the row index of the items |
| resource assignment | | in pdsch_allocationList in RRC |
| VRB-to-PRB | 0, 1 | 0 bit if only resource allocation type 0 is configured or if |
| mapping | | interleaved VRB-to-PRB mapping is not configured by |
| | | high layers; |
| | | 1 bit according to Table 7.3.1.1.2-33 otherwise, only |
| | | applicable to resource allocation type 1 |
| PRB bundling size | 0, 1 | 0 bit if the higher layer parameter prb-BundlingType is |
| indicator | | not configured or is set to ‘static’ |
| | | 1 bit if the higher layer parameter prb-BundlingType is |
| | | set to ‘dynamic’ |
| Rate matching | 0, 1, 2 | Bit size is determined by higher layer parameters |
| indicator | | rateMatchPatternGroup1 and rateMatchPatternGroup2. |
| ZP CSI-RS Trigger | 0, 1, 2 | |
| Modulation and | 5 | |
| coding scheme [TB1] | | |
| New data indicator | 1 | |
| [TB1] | | |
| Redundancy version | 2 | |
| [TB1] | | |
| Modulation and | 5 | |
| coding scheme [TB2] | | |
| New data indicator | 1 | |
| [TB2] | | |
| Redundancy version | 2 | |
| [TB2] | | |
| HARQ process | 4 | |
| number | | |
| Downlink | 0, 2, 4 | 4 bits if more than one serving cell are configured in the |
| assignment index | | DL and the higher layer parameter pdsch-HARQACK- |
| | | Codebook = dynamic, where the 2 MSB bits are the |
| | | counter DAI and the 2 LSB bits are the total DAI; |
| | | 2 bits if only one serving cell is configured in the DL and |
| | | the higher layer parameter pdsch-HARQ- |
| | | ACKCodebook = dynamic, where the 2 bits are the |
| | | counter DAI; |
| | | 0 bits otherwise. |
| TPC command for | 2 | |
| scheduled PUCCH | | |
| PUCCH resource | 2 | |
| indicator | | |
| PDSCH-to- | 0, 1, 2, 3 | Row number(index) of K1 |
| HARQ_feedback | | Number of bit is determined by log2(I). ‘I’ is the number |
| timing indicator | | of elements in the IE PUCCH-Config.dl-DataToUL-ACK |
| Antenna port(s) and | 4, 5, 6 | Determined by dmrs Configuration Type and max |
| number of layers | | Length. See the table to the right. |
| Transmission | 0, 3 | 0 bit if higher layer parameter tci-PresentInDCI is not |
| configuration | | enabled; |
| indication | | 3 bits otherwise (See QCL page) |
| SRS request | 2 | |
| CBG transmission | 0, 2, 4, 6, 8 | |
| information(CBGTI) | | |
| CBG flushing out | 0, 1 | |
| information(CBGFI) | | |
| DMRS sequence | 1 | |
| initialization | | |

TABLE 4
Antenna ports.

| dmrs- | | Bit Field | Table in |
|---|---|---|---|
| Type | maxLength | Length | 38.212 |
| 1 | 1 | 4 | Table |
| | | | 7.3.1.2.2-1 |
| 1 | 2 | 5 | Table |
| | | | 7.3.1.2.2-2 |
| 2 | 1 | 5 | Table |
| | | | 7.3.1.2.2-3 |
| 2 | 1 | 6 | Table |
| | | | 7.3.1.2.2-4 |

According to an example embodiment, an enhanced DCI 1_1 format is provided. The enhanced DCI 1_1 format supports the scheduling of PDSCH in one cell, as well as associated SRS probing. Table 5 provides details regarding the enhanced DCI 1_1 format.

TABLE 5
Example of enhanced DCI 1_1 format used for scheduling
PDSCH in one cell and associated SRS probing

| Field (Item) | Bits | Reference | Notes |
|---|---|---|---|
| Frequency | Variable | Variable with Resource | Existing for PDSCH. Now |
| domain resource | | Allocation Type | apply to PDSCH and SRS |
| assignment | | | |
| (FDRA) | | | |
| Time domain | 4 | Carries the row index of the | Existing for PDSCH. No |
| resource | | items in pdsch_allocationList in | change |
| assignment | | RRC | |
| (TDRA) | | | |
| VRB-to-PRB | 0, 1 | 0 bit if only resource allocation | Existing for PDSCH. Now |
| mapping | | type 0 is configured or if | may also apply to SRS |
| | | interleaved VRB-to-PRB | |
| | | mapping is not configured by | |
| | | high layers; | |
| | | 1 bit according to Table | |
| | | 7.3.1.1.2-33 otherwise, only | |
| | | applicable to resource allocation | |
| | | type 1 | |
| PRB bundling | 0, 1 | 0 bit if the higher layer | Existing for PDSCH. Now |
| size indicator | | parameter prb-BundlingType is | may also apply to SRS |
| | | not configured or is set to ‘static’ | |
| | | 1 bit if the higher layer | |
| | | parameter prb-BundlingType is | |
| | | set to ‘dynamic’ | |
| Antenna port(s) | 4, 5, 6 | Determined by | Existing for PDSCH. Now |
| and number of | | dmrs Configuration Type and | apply to PDSCH and SRS |
| layers | | max Length | |
| | | See e.g., Table 7.3.1.2.2-2 of TS | |
| | | 38.212 v16.2.0. | |
| SRS request | 2 or | | Existing. Now may add |
| | more | | more bits for SRS resource |
| | | | selection |
| SRS Time | 0-4 | Carries the row index of the | New. Apply to SRS. |
| domain resource | | items in pdsch_allocationList or | Optional. Shall be earlier |
| assignment | | pusch_allocationList or | than PDSCH |
| | | srs_allocationList in RRC. | |
| | | Optional. Default is per RRC | |
| | | configuration | |
| SRS TPC | 0, 2 | Optional for SRS power control | New. Optional. May present |
| command | | | if SRS has separate power |
| | | | control than PUSCH |
| SRS | 0-6 | Optional, indicate SRS | New. Optional. Can reuse |
| beamforming | | beamforming/precoding based | 0_1 CSI Request field |
| indicator | | on a CMR and optionally an | design |
| | | IMR. If not present then a | |
| | | default CMR is used for SRS | |
| | | beamforming determination | |
| SRS association | 0, 1 | Optional. If set, then A-SRS uses | New |
| with PDSCH | | PDSCH fields such as FDRA. | |
| CSI request | 0-6 | Optional. Triggers an aperiodic | New |
| | | CSI report. May also trigger an | |
| | | aperiodic CSI-RS/CSI-IM | |
| | | transmission. | |
| SRS association | 0, 1 | Optional. If set, then A-SRS uses | New |
| with the CSI | | CSI-RS/CSI-IM associated with | |
| request | | the CSI request fields for | |
| | | beamforming. | |
| . . . | | | Other fields: same as before |

The enhanced DCI 1_1 format includes the following beneficial features: the fields FDRA and antenna port indications are needed for SRS probing, but the overhead is high. The enhanced DCI 1_1 design reuses existing fields of FDRA and antenna port indications in the associated PDSCH-scheduling DCI, and adds a new SRS triggering offset, so that one DCI can be used for two operations (SRS transmissions and PDSCH reception, for example); and the GC DCI may also add a new SRS triggering offset field, so that all SRSs are transmitted on overlapping resources for BiT purposes.

Not all the new fields or optional fields need to be present in Enhanced DCI 1_1 format.

Further enhancements to DCI 2_3 and 0_1 may include: the SRS triggered by the DCI may be linked to another DL DCI, the SRS reuses fields (e.g., FDRA, antenna ports) from the linked DCI.

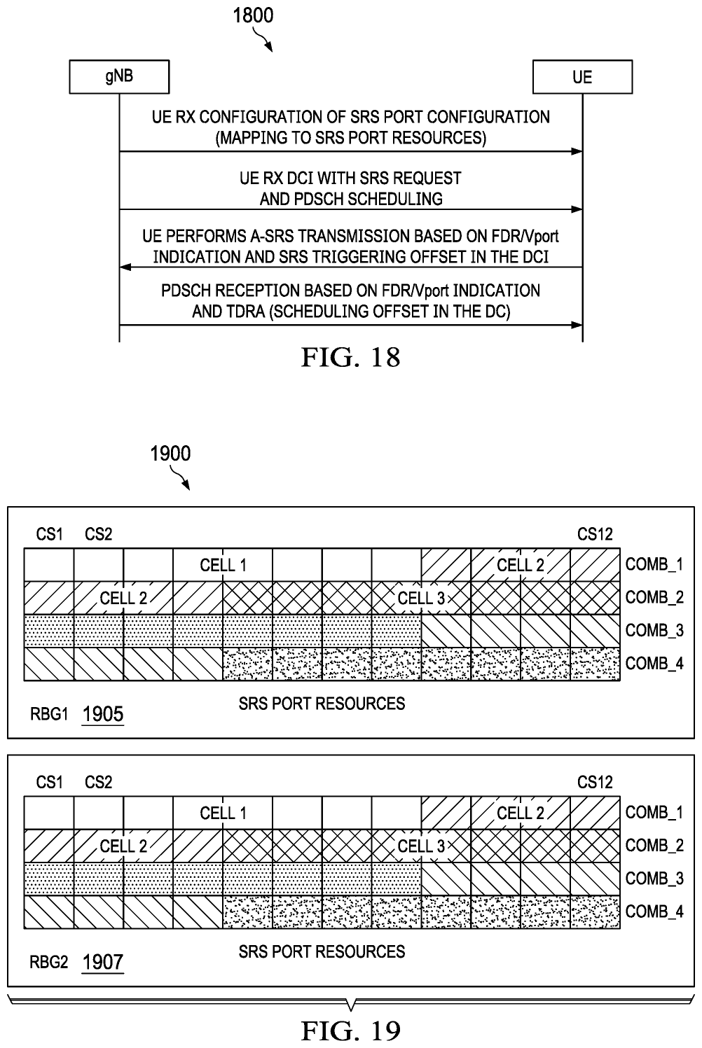

FIG. 18 illustrates a diagram 1800 of information exchanged between a gNB and a UE as the gNB configures UL SRS sounding and then makes a DL transmission based on the UL SRS sounding results.

According to an example embodiment, an enhanced DCI 0_1 format is provided. The enhanced DCI 0_1 format supports the scheduling of PUSCH in one cell, as well as associated SRS probing. Table 6 below provides details regarding the enhanced DCI 0_1 format.

TABLE 6
Example of Enhanced DCI 0_1 format used for scheduling
PUSCH in one cell and associated SRS probing

| Field | Bits | Reference | Note |
|---|---|---|---|
| Identifier for DCI | 1 | | Existing for |
| formats | | | PUSCH |
| Carrier indicator | 0 or 3 | | Existing for |
| | | | PUSCH. Now may |
| | | | apply to SRS as |
| | | | well |
| UL/SUL Indicator | 0, 1 | 0 - bit for UE not configured with | Existing for |
| | | SUL in the cell | PUSCH. Now may |
| | | 1 - bit for UEs configured with SUL in | apply to SRS as |
| | | the cell | well |
| Bandwidth part | 0, 1, 2 | Determined by BandwidthPart- | Existing for |
| indicator | | Config in higher layer message and | PUSCH. Now may |
| | | 38.212 - Table 7.3.1.1.2-1 | apply to SRS as |
| | | | well |
| Frequency | Variable | Variable with Resource Allocation | Existing for |
| domain resource | | Type | PUSCH. Now may |
| assignment | | | apply to SRS as |
| | | | well |
| Time domain | 4 | Carries the row index of the items | Existing for |
| resource | | in pusch_allocationList in RRC | PUSCH. Now may |
| assignment | | Number of Bit Length is determined | apply to SRS as |
| | | by log(I, 2), where I is the number of | well but with |
| | | elements in pusch_allocationList in | certain offset |
| | | RRC | |
| Frequency | 0, 1 | | Existing for |
| Hopping Flag | | | PUSCH. Now may |
| | | | apply to SRS as |
| | | | well |
| Modulation and | 5 | 38.214-6.1.4 | Existing for |
| coding scheme | | | PUSCH. |
| New data | 1 | | Existing for |
| indicator | | | PUSCH. |
| Redundancy | 2 | 0, 1, 2, 3 | Existing for |
| version | | | PUSCH. |
| HARQ process | 4 | | Existing for |
| number | | | PUSCH. |
| TPC command for | 2 | | Existing for |
| scheduled PUSCH | | | PUSCH. Now may |
| | | | apply to SRS as |
| | | | well |
| SRS resource | Variable | Determined by RRC Parameter SRS- | Existing for |
| indicator | | SetUse | PUSCH. Now may |
| | | | apply to SRS as |
| | | | well |
| Precoding | 0, 2, 3, 4, 5, 6 | Determined by ulTxConfig, Number | Existing for |
| information and | | of Antenna ports, PUSCH-tp, | PUSCH. Now may |
| number of layers | | ULmaxRank | apply to SRS as |
| (TPMI) | | | well |
| Antenna ports | 2, 3, 4, 5 | Determined by PUSCH-tp, DL- | Existing for |
| | | DMRS-config-type, DL-DMRS- | PUSCH. Now may |
| | | config-max-len, Rank | apply to SRS as |
| | | | well |
| SRS request | 2 | Table 7.3.1.1.2-24 | Existing for |
| | | | PUSCH. Now may |
| | | | include more bits |
| | | | and more |
| | | | information |
| CSI request | 0, 1, 2, 3, 4, 5, 6 | Determined by ReportTriggerSize in | Existing for |
| | | RRC message. | PUSCH. Now may |
| | | See Configure Aperiodic Trigger | apply to SRS as |
| | | section for the details. | well for |
| | | | beamforming |
| SRS Time domain | 0-4 | Carries the row index of the items | New. Apply to |
| resource | | in pdsch_allocationList or | SRS. Optional. |
| assignment | | pusch_allocationList or | Shall be earlier |
| | | srs_allocationList in RRC. Optional. | than PDSCH |
| | | Default is per RRC configuration | |
| SRS TPC | 0, 2 | Optional for SRS power control | New. Optional. |
| command | | | May present if SRS |
| | | | has separate |
| | | | power control than |
| | | | PUSCH |
| SRS association | 0, 1, or more | Optional. If set, then A-SRS uses | New |
| with | | PDSCH fields such as FDRA, or an | |
| PDSCH/PUSCH | | associated PDSCH's fields such as | |
| | | FDRA | |
| SRS association | 0, 1 | Optional. If set, then A-SRS uses CSI- | New |
| with the CSI | | RS/CSI-IM associated with the CSI | |
| request | | request fields for beamforming. | |
| UL-SCH | 1 | 0 - UL-SCH shall not be transmitted | |
| Indicator | | on the PUSCH | |
| | | 1 - UL-SCH shall be transmitted on | |
| | | the PUSCH | |

Not all the new fields or optional fields need to be present in Enhanced DCI 0_1 format.

TABLE 7
Example fields in DCI format 0_1 repurposed for A-SRS triggering

| | | | New Usage with | New Usage with | New Usage for |
|---|---|---|---|---|---|
| | | | data/CSI and SRS | data/CSI and SRS | SRS without data |
| Field in 0_1 | Bits | Current Usage | not linked to data | linked to data | and without CSI |
| Identifier | 1 | Identify 0_1 | Identify 0_1 | Identify 0_1 | Identify 0_1 |
| for DCI | | | | | |
| formats | | | | | |
| Carrier | 0 or 3 | PUSCH carrier | PUSCH carrier | SRS carrier same | SRS carrier or |
| indicator | | | | as PUSCH | carrier set |
| UL/SUL | 0, 1 | UL/SUL for | UL/SUL for | SRS UL/SUL | UL/SUL for SRS |
| Indicator | | PUSCH | PUSCH | same as PUSCH | |
| Bandwidth | 0, 1, 2 | BWP for | BWP for PUSCH | SRS BWP same as | BWP for SRS |
| part | | PUSCH | | PUSCH | |
| indicator | | | | | |
| Frequency | Variable | PUSCH FDRA | PUSCH FDRA | SRS FDRA same | SRS FDRA |
| domain | | | | as PUSCH | |
| resource | | | | | |
| assignment | | | | | |
| Time | 4 | PUSCH TDRA | PUSCH TDRA | PUSCH TDRA | SRS TDRA |
| domain | | | | | |
| resource | | | | | |
| assignment | | | | | |
| Frequency | 0, 1 | PUSCH | PUSCH | SRS hopping same | SRS hopping |
| Hopping | | hopping | hopping | as PUSCH | |
| Flag | | | | | |
| Modulation | 5 | PUSCH MCS | PUSCH MCS | PUSCH MCS | N/A |
| and coding | | | | | |
| scheme | | | | | |
| New data | 1 | PUSCH NDI | PUSCH NDI | PUSCH NDI | N/A |
| indicator | | | | | |
| Redundancy | 2 | PUSCH RV | PUSCH RV | PUSCH RV | N/A |
| version | | | | | |
| HARQ | 4 | PUSCH HARQ | PUSCH HARQ | PUSCH HARQ | N/A |
| process | | | | | |
| number | | | | | |
| TPC | 2 | PUSCH TPC | PUSCH TPC | PUSCH TPC (may | SRS TPC |
| command | | | | also be SRS TPC | |
| for | | | | if not separate PC) | |
| scheduled | | | | | |
| PUSCH | | | | | |
| SRS | Variable | SRI for PUSCH | SRI for PUSCH | May be the same | May be combined |
| resource | | | | as SRS request | with SRS request |
| indicator | | | | | |
| Precoding | 0, 2, 3, | PUSCH TPMI | PUSCH TPMI | SRS codebook- | SRS codebook- |
| information | 4, 5, 6 | | | based precoding | based precoding |
| and number | | | | and # of ports, | and # of ports |
| of layers | | | | same as PUSCH | |
| (TPMI) | | | | | |
| Antenna | 2, 3, 4, 5 | PUSCH ports | PUSCH ports | SRS ports same as | SRS ports |
| ports | | | | PUSCH | |
| SRS request | 2 | SRS request | SRS request (may | SRS request (may | SRS request (may |
| | | | use more bits) | use more bits) | use more bits) |
| CSI request | 0, 1, 2, 3, | For AP CSI | For AP CSI, and | For AP CSI, and | For SRS non- |
| | 4, 5, 6 | | may also be for | may also be for | codebook based |
| | | | SRS non- | SRS non- | precoding |
| | | | codebook based | codebook based | |
| | | | precoding | precoding | |
| SRS Time | 0-4 | N/A | SRS TDRA | SRS TDRA | SRS TDRA |
| domain | | | | | |
| resource | | | | | |
| assignment | | | | | |
| SRS TPC | 0, 2 | N/A | SRS TPC if SRS | SRS TPC if SRS | N/A |
| command | | | has separate power | has separate power | |
| | | | control than | control than | |
| | | | PUSCH | PUSCH | |
| SRS | 0, 1 | N/A | =0, SRS does not | =1, SRS reuses | N/A |
| association | | | reuse PUSCH | PUSCH fields | |
| with | | | fields | | |
| PUSCH | | | | | |
| SRS | 0, 1 | N/A | SRS uses CSI | SRS uses CSI | N/A |
| association | | | resources for | resources for | |
| with the | | | precoding or not | precoding or not | |
| CSI request | | | | | |
| UL-SCH | 1 | 0 - UL-SCH | 1 | 1 | 0 |
| Indicator | | shall not be | | | |
| | | transmitted | | | |
| . . . | | 1 - UL-SCH | | | |
| | | shall be | | | |
| | | transmitted on | | | |
| | | the PUSCH | | | |

For all other SRS parameters not indicated in the DCI, RRC/MAC signaling is used to determine those parameters.

TABLE 8
Example fields in DCI format 1_1 repurposed for A-SRS triggering

| | | | New Usage with data | |
|---|---|---|---|---|
| | | | and SRS not linked to | New Usage with data and |
| Field in 1_1 | Bits | Current Usage | data | SRS linked to data |
| Frequency | Variable | PDSCH FDRA | PDSCH FDRA | SRS FDRA same as |
| domain | | | | PDSCH |
| resource | | | | |
| assignment | | | | |
| (FDRA) | | | | |
| Time domain | 4 | PDSCH TDRA | PDSCH TDRA | PDSCH TDRA |
| resource | | | | |
| assignment | | | | |
| (TDRA) | | | | |
| VRB-to-PRB | 0, 1 | PDSCH mapping | PDSCH mapping | SRS mapping same as |
| mapping | | | | PDSCH |
| PRB bundling | 0, 1 | PDSCH bundling | PDSCH bundling | SRS bundling same as |
| size indicator | | | | PDSCH |
| Antenna | 4, 5, 6 | PDSCH port(s) and | PDSCH port(s) and # of | SRS port(s) and # of |
| port(s) and | | # of layers | layers | layers, same as PDSCH |
| number of | | | | |
| layers | | | | |
| SRS request | 2 or | For SRS | For SRS, may add more | For SRS, may add more |
| | more | | bits for SRS resource | bits for SRS resource |
| | | | selection | selection |
| SRS Time | 0-4 | N/A | SRS TDRA | SRS TDRA |
| domain | | | | |
| resource | | | | |
| assignment | | | | |
| SRS TPC | 0, 2 | Optional for SRS | SRS TPC command | SRS TPC command |
| command | | power control | | |
| SRS | 0-6 | N/A | SRS precoding based on | SRS precoding based on |
| beamforming | | | a CMR and optionally | a CMR and optionally an |
| indicator | | | an IMR | IMR |
| SRS | 0, 1 | N/A | =0, A-SRS does not | =1, A-SRS reuses |
| association | | | reuse PDSCH fields | PDSCH fields |
| with PDSCH | | | | |
| . . . | | | Other fields: same as | Other fields: same as |
| | | | existing | existing |

As shown in FIG. 18, the A-SRS may also be based on the Carrier indicator field, Bandwidth part indicator field, VRB-PRB mapping field, PRB bundling size field, TPC command for the PUCCH field, or TPC command for the SRS field in the DCI. Furthermore, the SRS triggering offset may be indicated in a TDRA field (reused design from PUSCH or PDSCH, for example). A CMR, and optionally an IMR, may be included for the UE to determine the SRS precoding, which may reuse the design of CSI request field, for example.

Example SRS mapping of resources and ports may be as follows. Assume DMRS Type 1, (i.e., 8 ports/RBG/cell for all paired UEs) is used, the 8 ports may be associated with 8 SRS port resources, selected from n available port resources (for comb 4, n=48; for comb 2, n=16). The SRS from neighboring cells may be multiplexed on the n SRS port resources. Then, indicating to a UE which 1/2/4 SRS port resources out of the available n SRS port resources may require too many bits.

In general, the following parameters may be indicated in flexible A-SRS triggering DCI for the A-SRS. Category A time time-domain parameters may include: A-1: indication of available slot position, (i.e., the t values); A-2: indication of slot offset; A-3: indication of SRS symbol-level offset; and A-4: indication of time-domain behavior for SRS transmission over multiple OFDM symbols, e.g., repetition, hopping, and/or splitting. Category B frequency-domain parameters may include: B-1: indication of a group of CCs for SRS transmission; and B-2: indication of frequency domain resource in a BWP for SRS transmission; B-3: Indication of whether DL/UL BWP is applied for SRS transmission. Category C power control parameters may include: C-1: re-purpose “TPC command for PUSCH” as “TPC command for SRS” (FFS impact on power control, impact from triggering a group of CCs for SRS); and C-2: Indication of open loop power control parameter (e.g., p0). Category D spatial-domain parameters may include indication of SRS port and beamforming. Category E may extend the number of DCI codepoints for aperiodic SRS trigger states.

These parameters are covered in difference places in this application.

FIG. 19 illustrates diagrams 1900 of RGBs 1905 and 1907 with an example mapping of SRS resources and ports. In an embodiment, apply the UE-group CSI-RS/DMRS design to SRS design. As an example, for each cell, restrict the cell to only a specified number (e.g., 8, but other values are possible) of pre-defined SRS port resources. Then, in the group DCI, indicate the layers/ports for a UE from within the specified number (e.g., 8) pre-defined SRS port resources. For example, configure a SRS resource for all active UEs in cell 1 with all SRS resources having the same 8 ports. The group DCI indicates which of the 8 ports are for a particular UE. For example, rank [1, 2, 4, 1] are signaled for UE 1, 2, 3, 4. There is no need to indicate the layer index. For another example, reuse DMRS port mapping. As another example, the SRS resource may be configured for all RBGs, but the scheduling/group DCI allows different UEs to be scheduled on different RBGs.

TS 38.331 specifies the usage for an SRS resource below.

| | |
|---|---|
| usage | ENUMERATED {beamManagement, codebook, |

nonCodebook, antennaSwitching},

In TS 38.214, procedures are specified for SRS resources with different usages. Some of the procedures are the same for “codebook” and “antennaSwitching” but some are not:

the UE receives a downlink DCI, a group common DCI, or an uplink DCI based command
where a codepoint of the DCI may trigger one or more SRS resource set(s). For SRS in a
resource set with usage set to ‘codebook’ or ‘antennaSwitching’, the minimal time interval
between the last symbol of the PDCCH triggering the aperiodic SRS transmission and the
first symbol of SRS resource is N₂ + T_{switch}. Otherwise, the minimal time interval between
the last symbol of the PDCCH triggering the aperiodic SRS transmission and the first
symbol of SRS resource is N₂ + T_{switch} + 14. The minimal time interval in units of OFDM
symbols is counted based on the minimum subcarrier spacing between the PDCCH and
the aperiodic SRS.
when a UE receives an spatial relation update command, as described in clause 6.1.3.26 of
[10, TS 38.321], for an SRS resource, and when the HARQ-ACK corresponding to the
PDSCH carrying the update command is transmitted in slot n, the corresponding actions
in [10, TS 38.321] and the UE assumptions on updating spatial relation for the SRS
resource shall be applied for SRS transmission starting from the first slot that is after slot
n + 3Nₛₗₒₜ^{subframe, μ}. The update command contains spatial relation assumptions provided by
a list of references to reference signal IDs, one per element of the updated SRS resource
set. Each ID in the list refers to a reference SS/PBCH block, NZP CSI-RS resource
configured on serving cell indicated by Resource Serving Cell ID field in the update
command if present, same serving cell as the SRS resource set otherwise, or SRS resource
configured on serving cell and uplink bandwidth part indicated by Resource Serving Cell
ID field and Resource BWP ID field in the update command if present, same serving cell
and bandwidth part as the SRS resource set otherwise. When the UE is configured with
the higher layer parameter usage in SRS-ResourceSet set to ‘antennaSwitching’, the UE
shall not expect to be configured with different spatial relations for SRS resources in the
same SRS resource set.

When the UE is configured with the higher layer parameter usage in SRS-ResourceSet set to
‘antennaSwitching’, and a guard period of Y symbols is configured according to Clause 6.2.1.2,
the UE shall use the same priority rules as defined above during the guard period as if SRS was
configured.

Generally, there are some more restrictions on “antennaSwitching” than on “codebook.” In a particular operation scenario, if the same procedures apply to the different usages, the network may configure one SRS resource with either usage but the network may utilize it for both usage purposes with no standard impact, or the network may configure two SRS resources almost identical except for “usage” (with no standard impact), or the network may configure one SRS resource with two “usage” values (with changes in TS 38.331 needed). In general operation scenarios, different usages may require different procedures and hence different SRS resources have to be configured. This is up to the network to decide. Overall it seems the use cases for this potential enhancement is limited, and the potential benefits may include some minor RRC overhead reduction and avoiding reaching UE's SRS resource limit of 64. Based on the analysis, we prefer to stick with the implementation approach and not to enhance, unless some other strong justifications are identified.

So, embodiment techniques rely on implementation approach to reuse a SRS resource for more than one usage such as “antennaSwitching” and “codebook.”

Regarding whether to support relevant enhancement for indicating a subset of Tx/Rx antennas in SRS antenna switching, we point out that there are some CSI measurement related issues not yet considered in existing discussions. When UE Tx/Rx antenna numbers are changed in a more dynamic fashion, the MIMO channel properties are also changed more dynamically and abruptly. Consequently, the UL/DL CSI would be changed. Existing RI/PMI/CQI etc., need to support fast adaptation, such as CSI measurement based on time-domain restrictions (on one-shot CSI-RS or multi-shot CSI-RS, but cannot be averaged/filtered outside a time window). That is, at the slot that the UE antenna configuration is changed, all the CSI measurements need to reset, and new measurements are performed without averaged/filtered with any measurements before the slot.

If the network intends to perform dynamic switching between two or more UE antenna configurations rather frequently, the network needs to configure multiple sets of CSI measurements/reporting, and no averaging across the CSI measurement resources is allowed. If n different UE antenna configurations are configured, then each of the n antenna configurations is configured with at least one set of CSI measurements and reporting configurations separate/independent from those for another UE antenna configuration.

Both the UE Tx antenna switching and UE Rx antenna switching can be considered and analyzed. Some analysis and embodiments are provided here, separately for Tx and Rx antenna switching.

### UE Tx Port Switching:

First of all, to clarify which one of the following is intended for the UE Tx port switching, UE has 2T but may reduce to 1T: e.g., 2T2R or 2T4R reduces to 1T2R or 1T4R or 1T1R for a period of time based on dynamic indication; or UE has 4T but may reduce to 1T or 2T for a period of time based on dynamic indication. Since the current specs specify UE antenna configurations as 1T2R, 2T2R, etc., this actually implies a dynamic switching of xTyR to zTyR where x is not equal to z. This is the Rel-16 SRS Tx port switching capability which is actually “antenna configuration downgrading.”

DCI-based on/off and/or MAC-based on/off may be considered and analyzed. This may be a new operation and capability different from existing txSwitching reported to the network. For example, 2T4R is to have Tx switching between {0,1} and {2,3}, but this is to switch from {0,1} to {0} to save UE RF power (not tx power).

UE has 2T, physical or virtual, denoted as {0,1}, and the DCI dynamically selects either {0} or {1} as the Tx antenna; or UE has 4T, physical or virtual, denoted as {0,1,2,3}, and the DCI dynamically selects one (or more) from the set for a specific sounding, e.g., {0} or {0,1}, etc. That is, the switching is among the Tx antennas.

This seems to be motivated, as it can save configuration overhead/SRS resource set number. Without it, if the gNB wants the UE to operate with Tx antennas {0,1,2,3}, {0,1}, or {0}, it has to configure multiple SRS resources/resource sets. On the other hand, with this enhancement, the gNB can just configure one SRS resource set with Tx antennas {0,1,2,3} and rely on DCI to select some or all of the Tx antennas. If there is not enough SRS capacity for the UE to sound on all Tx antennas, the gNB can decide dynamically to let the UE sound on some of the Tx antennas.

### UE Rx Port Switching:

The potential justification is UE Rx power saving and monitoring complexity reduction when some Rx hardware/processing are turned off for some time; DCI and/or MAC based switching may be considered.

If UE Rx antenna port switching is supported, it needs to address the CSI issue: When UE Rx antenna numbers are changed in a more dynamic fashion, the MIMO channel properties are also changed more dynamically and abruptly. Consequently, the UL/DL CSI and link adaptation would be changed abruptly. Existing RI/PMI/CQI etc., need to support fast adaptation, such as CSI measurement based on time-domain restrictions (e.g., based on one-shot CSI-RS or multi-shot CSI-RS, but cannot be averaged/filtered outside a time window). If the network intends to perform dynamic switching between two or more UE antenna configurations, the network needs to configure multiple sets of CSI measurements/reporting, and no averaging across the CSI measurement resources is allowed.

If the Rx port switching leads to fewer Rx ports than the currently operating Tx ports, the Tx ports should also be downgraded to the same or fewer ports. For example, if UE has 8T8R, and Rx port switching indicates 4R, then the UE should switch to 4T4R. This may be done by the UE autonomously. Alternatively, the network may indicate joint Tx-Rx port switching, such as from 8T8R to 4T4R, which requires more DCI bits to indicate.

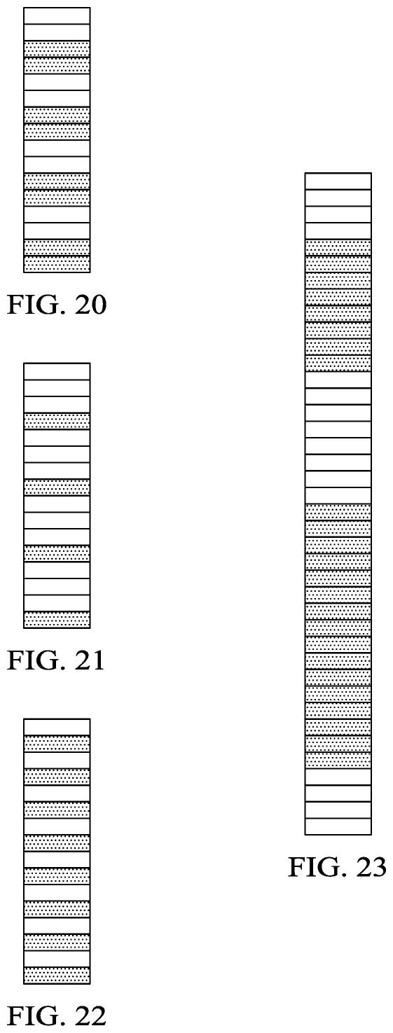

Further details on non-contiguous sounding PAPR are provided. A number of evaluations have been performed for non-contiguous segments of sounding to see how much increase there is on PAPR. To describe a SRS pattern, a bitmap for the PRBs is used, with 1 representing sounding on that PRB and 0 for no sounding. For example, For example, [0 0 1 1 0 0 1 1 0 0 1 1 0 0 1 1] is for 16 PRBs in a portion of the bandwidth, and 4 non-contiguous segments are transmitted, in which each segment contains 2 consecutive PRBs for sounding and the other 2 PRBs no sounding. FIG. 20 illustrates this example. On each PRB, comb 4 is assumed (i.e., 3 tones per PRB is used). When sounding on multiple non-contiguous segments, it may be possible to use different sequences on different segments, or the same sequence can be used. Both are evaluated.

Scenario 1: Periodic Segments with the Pattern of [0 0 1 1 0 0 1 1 0 0 1 1 0 0 1 1 . . . ]

With this pattern, the following cases are shown. In Case 1, there are 8 PRBs ([0 0 1 1 0 0 1 1]; same sequence). In Case 2, there are 16 PRBs ([0 0 1 1 0 0 1 1 0 0 1 1 0 0 1 1]; same or different sequences; see FIG. 20 illustrating an example of Scenario 1 with non-contiguous sounding on 16 PRBs in a portion of the bandwidth, represented as [0 0 1 1 0 0 1 1 0 0 1 1 0 0 1 1]). In Case 3, there are 32 PRBs ([0 0 1 1 0 0 1 1 0 0 1 1 0 0 1 1 0 0 1 1 0 0 1 1 0 0 1 1 0 0 1 1], same or different sequences

Scenario 2: Periodic Segments with the Pattern of [0 0 0 1 0 0 0 1 0 0 0 1 0 0 0 1 . . . ]

With this pattern, the following cases are shown. In Case 1, there are 8 PRBs ([0 0 0 1 0 0 0 1]; same sequence). In Case 2, there are 16 PRBs ([0 0 0 1 0 0 0 1 0 0 0 1 0 0 0 1]; same or different sequences; see FIG. 21 illustrating an example of Scenario 2 non-contiguous sounding on 16 PRBs, represented as ([0 0 0 1 0 0 0 1 0 0 0 1 0 0 0 1]). In Case 3, there are 32 PRBs ([0 0 0 1 0 0 0 1 0 0 0 1 0 0 0 1 0 0 0 1 0 0 0 1 0 0 1], same or different sequences).

Scenario 3: Periodic Segments with the Pattern of [0 1 0 1 0 1 0 1 0 1 0 1 0 1 0 1 . . . ]

With this pattern, the following cases are shown. In Case 1, there are 8 PRBs ([0 1 0 1 0 1 0 1]; same sequence). In Case 2, there are 16 PRBs ([0 1 0 1 0 1 0 1 0 1 0 1 0 1 0 1]; same or different sequences; see FIG. 22 illustrating an example of Scenario 3 non-contiguous sounding on 16 PRBs, represented as ([0 1 0 1 0 1 0 1 0 1 0 1 0 1 0 1]). In Case 3, there are 32 PRBs ([0 1 0 1 0 1 0 1 0 1 0 1 0 1 0 10 1 0 1 0 1 0 1 0 1 0 1 0 1], same or different sequences).

Scenario 4: Aperiodic 2 Segments in the Form of [000011111111000000001111 . . . ] with Randomized Locations for the Segments

or this scenario, the 4 cases are shown in Table 9 below. Further, FIG. 23 shows an example of Scenario 4 non-contiguous sounding represented as ([0000111111110000000011111111111111110000].

TABLE 9
Example cases for Scenario 4

| | Case 1 | Case 2 | Case 3 | Case 4 |
|---|---|---|---|---|
| | # subbands | # subbands | # subbands | # subbands |
| | (of 4 PRBs) | (of 4 PRBs) | (of 4 PRBs) | (of 4 PRBs) |
| Segment 1 | 1 | 2 | 4 | 4 |
| Segment 2 | 2 | 4 | 4 | 10 |

For this scenario, the 3 cases are shown in Table 10 below.

TABLE 10
Example cases for Scenario 5

| | Case 1 | Case 2 | Case 3 |
|---|---|---|---|
| | # subbands | # subbands | # subbands |
| | (of 4 PRBs) | (of 4 PRBs) | (of 4 PRBs) |
| Segment 1 | 1 | 2 | 4 |
| Segment 2 | 2 | 4 | 4 |
| Segment 3 | 1 | 6 | 4 |

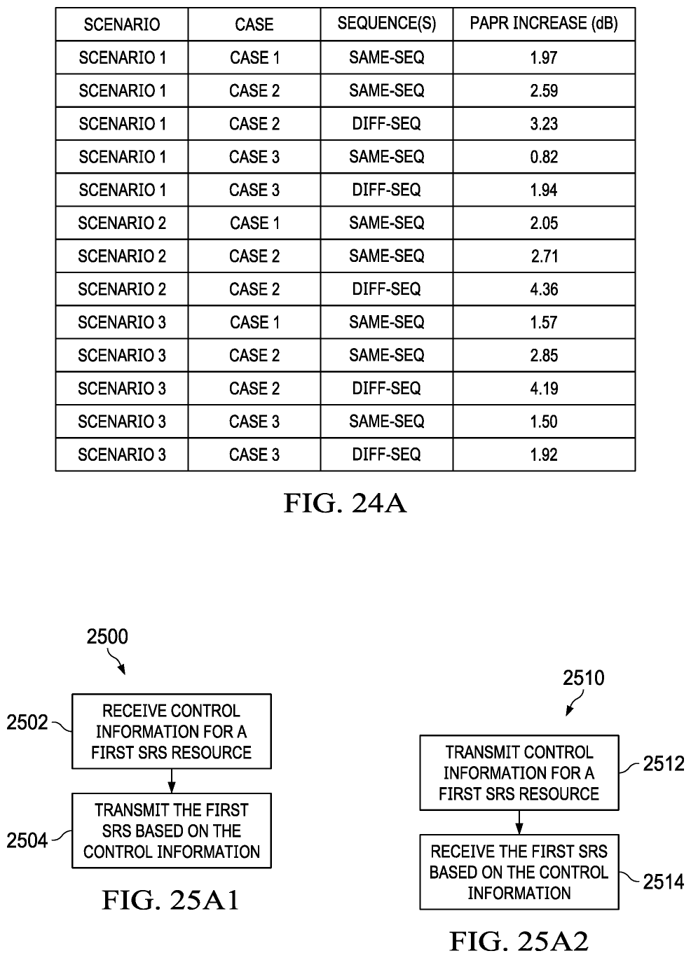

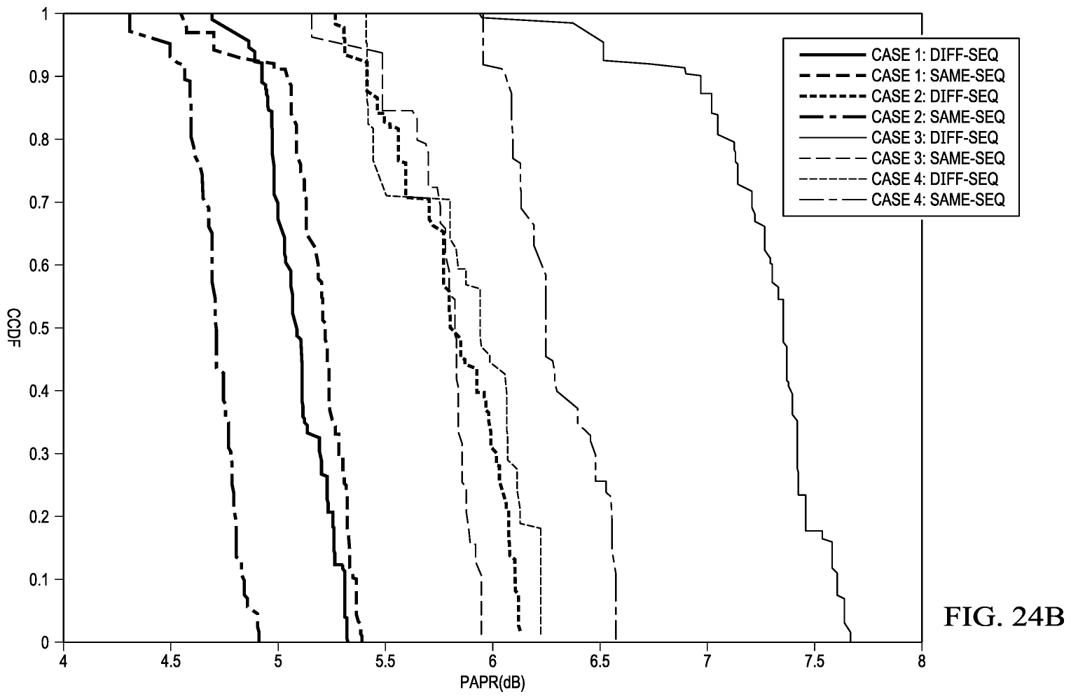

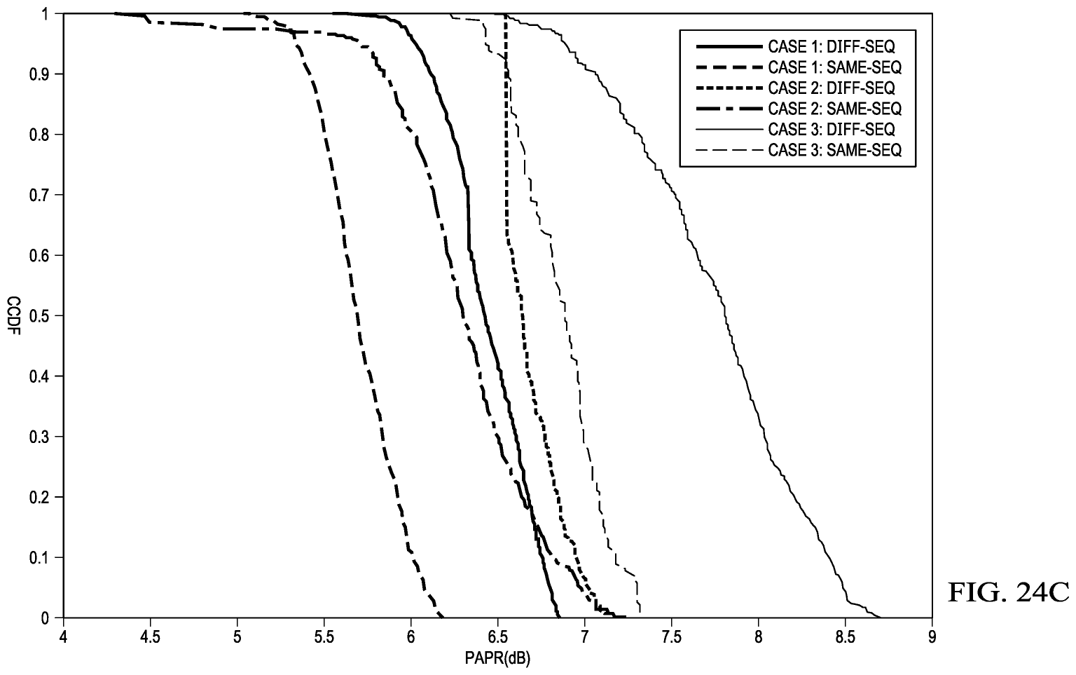

The evaluation results for the above scenarios are shown in FIGS. 24A-C. FIG. 24A illustrates PAPR increase for Scenarios 1-3. As shown in FIG. 24A, for Scenarios 1-3, the PAPR increase is roughly within 0.8 dB to 4.3 dB, and using the same sequence is better than using different sequences. When focusing on the same sequence tests, the PAPR increase is within 0.8 dB to 2.9 dB.

FIG. 24B illustrates CCDF for PAPR of Scenario 4 non-contiguous sounding Cases 1-4, with the same or different sequences. As shown in FIG. 24B, for Scenario 4, the PAPR increase is roughly within 0.5 dB to 1.5 dB, and using the same sequence may be better or worse than using different sequences.

FIG. 24C illustrates CCDF for PAPR of Scenario 5 non-contiguous sounding Cases 1-3, with the same or different sequences. As shown in FIG. 24C, for Scenario 5, the PAPR increase is also roughly within 0.5 dB to 1.5 dB, and using the same sequence is better than using different sequences for the cases tested.

The evaluations show that in most cases, for non-contiguous sounding, the UE should transmit using the same sequence, even if the sounding PRBs are not consecutive. If a sequence is [S₁ S₂ S₃ S₄ S₅ S₆ S₇ S₈ S₉ S₁₀ S₁₁ S₁₂ . . . ], for example, it may be transmitted as [S₁ S₂ S₃ gap S₄ S₅ S₆ S₇ S₈ S₉ gap S₁₀ S₁₁ S₁₂ . . . ], wherein the gaps are the PRBs without sounding, i.e., the elements in the sequence are not skipped on the PRBs without sounding, and they are just transmitted in a different PRB. Alternatively, it may be transmitted as [S₁ S₂ S₃ gap S₇ S₈ S₉ gap S₁₀ S₁₁ S₁₂ . . . ], wherein the gaps are the PRBs without sounding. That is, some elements in the sequence are skipped on the PRBs without sounding. The network can configure/indicate to the UE which alternative it intends the UE to use. In addition, in a few cases, using different sequences on the non-contiguous segments can result in lower PAPR than using the same sequence. In this case, the network can configure/indicate to the UE which sequence(s) are to be used via index(es) of the sequence(s). In some embodiments, in the A-CSI triggering DCI, the DCI indicates a SRS whose resources are on PRBs non-contiguous, and the SRS is to be transmitted on the same OFDM symbol. The gNB may also signal to the UE one or more sequence indexes for the SRS, as well as the lengths to be used for each sequence. For example, 2 sequences may be indicated, and for the first sequence, 12 elements (e.g., 1 subband according to the SRS configuration) are to be used, and for the second, 24 elements (e.g., 2 subbands according to the SRS configuration) are to be used. Then the UE transmit the SRS accordingly.

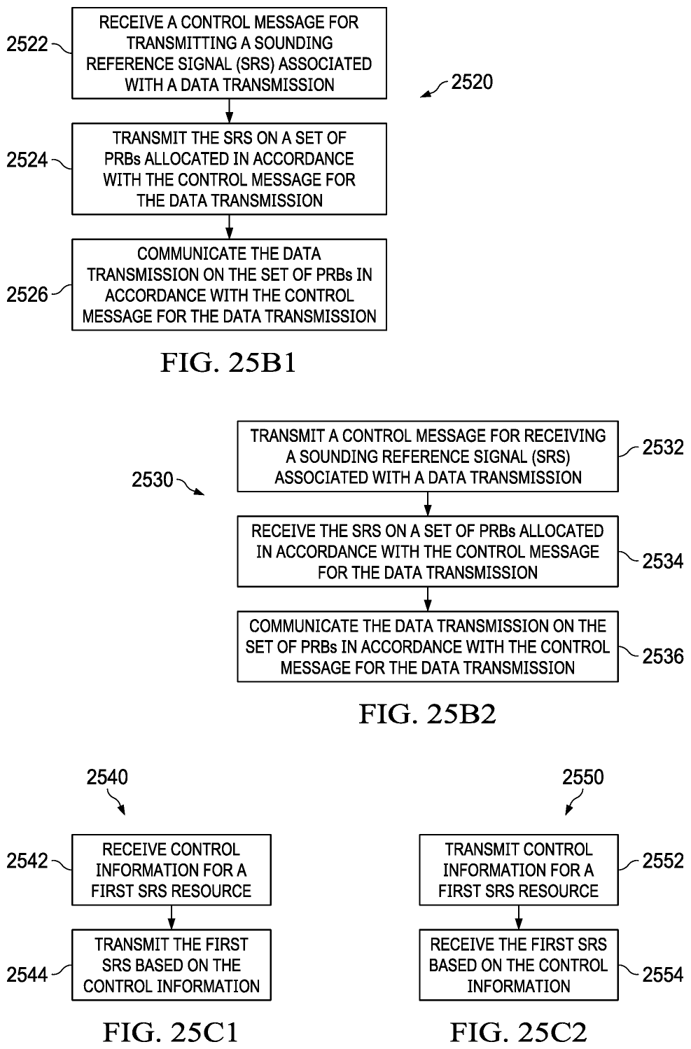

FIG. 25A1 is a flowchart of a method 2500 for transmitting an SRS based on received control information, according to some embodiments. Method 2500 starts at operation 2502, where the UE receives control information for a first sounding reference signal (SRS) resource. The control information indicates at least a first frequency resource in a carrier, a frequency-domain shift parameter, a PF value, and a frequency-domain offset value. At operation 2504, based on the control information, the UE transmits the first SRS resource on a first partial frequency sounding resource within the first frequency resource in the carrier. A resource starting physical resource block (PRB) of the first frequency resource is in accordance with the frequency-domain shift parameter. A bandwidth of the first partial frequency sounding resource is based on at least the PF value and a bandwidth of the first frequency resource. A partial frequency sounding resource starting PRB of the first partial frequency sounding resource is based at least on the resource starting PRB of the first frequency resource and the frequency-domain offset value.

In some embodiments, the first frequency resource may be configured with m PRBs. The first partial frequency sounding resource may be configured with m/(the PF value) PRBs in the m PRBs of the first frequency resource. In some embodiments, the partial frequency sounding resource starting PRB of the first partial frequency sounding resource may be the resource starting PRB of the first frequency resource shifted in accordance with the frequency-domain offset value. In some embodiments, the control information may further indicate a hopping parameter. The partial frequency sounding resource starting PRB of the first partial frequency sounding resource may be based on the resource starting PRB of the first frequency resource, the frequency-domain offset value, and a hopping offset value in accordance with the hopping parameter. In some embodiments, the PF value may be one of 2, 4, or 8. In some embodiments, the control information may be received in a radio resource control (RRC) message. In some embodiments, the first SRS resource may be configured in a first SRS resource set including one or more SRS resources, and each SRS resource in the first SRS resource set may be separately configured with a separate frequency resource in the carrier, a separate frequency-domain shift parameter, a separate PF value, and a separate frequency-domain offset value.

FIG. 25A2 is a flowchart of a method 2510 for receiving an SRS based on transmitted control information, according to some embodiments. Method 2510 starts at operation 2512, where the base station transmits to a user equipment (UE) control information for a first sounding reference signal (SRS) resource. The control information indicates at least a first frequency resource in a carrier, a frequency-domain shift parameter, a PF value, and a frequency-domain offset value. At operation 2514, based on the control information, the base station receives from the UE the first SRS resource on a first partial frequency sounding resource within the first frequency resource in the carrier. A resource starting physical resource block (PRB) of the first frequency resource is in accordance with the frequency-domain shift parameter. A bandwidth of the first partial frequency sounding resource is based on at least the PF value and a bandwidth of the first frequency resource. A partial frequency sounding resource starting PRB of the first partial frequency sounding resource is based at least on the resource starting PRB of the first frequency resource and the frequency-domain offset value.

In some embodiments, the first frequency resource may be configured with m PRBs. The first partial frequency sounding resource may be configured with m/(the PF value) PRBs in the m PRBs of the first frequency resource. In some embodiments, the partial frequency sounding resource starting PRB of the first partial frequency sounding resource may be the resource starting PRB of the first frequency resource shifted in accordance with the frequency-domain offset value. In some embodiments, the control information may further indicate a hopping parameter. The partial frequency sounding resource starting PRB of the first partial frequency sounding resource may be based on the resource starting PRB of the first frequency resource, the frequency-domain offset value, and a hopping offset value in accordance with the hopping parameter. In some embodiments, the PF value may be one of 2, 4, or 8. In some embodiments, the control information may be received in a radio resource control (RRC) message. In some embodiments, the first SRS resource may be configured in a first SRS resource set including one or more SRS resources, and each SRS resource in the first SRS resource set may be separately configured with a separate frequency resource in the carrier, a separate frequency-domain shift parameter, a separate PF value, and a separate frequency-domain offset value.

FIG. 25B1 is a flowchart of a method 2520 for transmitting an SRS associated with a data transmission, according to some embodiments. Method 2520 starts at operation 2522, where the UE receives a control message for transmitting a sounding reference signal (SRS) associated with a data transmission. At operation 2524, the UE transmits the SRS on a set of physical resource blocks (PRBs) allocated in accordance with the control message for the data transmission. The set of PRBs allocated for the data transmission is an almost contiguous allocation which includes at least two subset of PRBs with at least one gap PRB between the at least two subset of PRBs. A ratio of a gap size of the at least one gap PRB over a sum of a size of the set of PRBs and the gap size of the at least one gap PRB is less than or equal to a threshold value. After transmitting the SRS at operation 2524, at operation 2526, the UE communicates the data transmission on the set of PRBs allocated for the data transmission.

In some embodiments, the transmitting of the SRS on the set of PRBs may be on an OFDM symbol. In some embodiments, the threshold value may be 0.25. In some embodiments, the data transmission may be one of a physical uplink shared channel (PUSCH) data transmission or a physical downlink shared channel (PDSCH) data transmission. In some embodiments, the control message may be a radio resource control (RRC) configuration message, a medium access control (MAC) control element (CE) message, or a downlink control information (DCI) message. In some embodiments, the data transmission may be one of a dynamically scheduled PUSCH or PDSCH, a PDSCH with a semi-persistent scheduling (SPS) configuration, or a PUSCH with a configured grant (CG) configuration.

FIG. 25B2 is a flowchart of a method 2530 for receiving an SRS associated with a data transmission, according to some embodiments. Method 2530 starts at operation 2532, where the base station transmits to a user equipment (UE) a control message for receiving a sounding reference signal (SRS) associated with a data transmission. At operation 2534, the base station receives from the UE the SRS on a set of physical resource blocks (PRBs) allocated in accordance with the control message for the data transmission. The set of PRBs allocated for the data transmission is an almost contiguous allocation which includes at least two subset of PRBs with at least one gap PRB between the at least two subset of PRBs. A ratio of a gap size of the at least one gap PRB over a sum of a size of the set of PRBs and the gap size of the at least one gap PRB is less than or equal to a threshold value. After receiving the SRS at operation 2534, at operation 2536, the base station communicates the data transmission with the UE on the set of PRBs allocated for the data transmission.

In some embodiments, the receiving of the SRS on the set of PRBs may be on an orthogonal frequency division multiplexing (OFDM) symbol. In some embodiments, the threshold value may be 0.25. In some embodiments, the data transmission may be one of a physical uplink shared channel (PUSCH) data transmission or a physical downlink shared channel (PDSCH) data transmission. In some embodiments, the control message may be a radio resource control (RRC) configuration message, a medium access control (MAC) control element (CE) message, or a downlink control information (DCI) message. In some embodiments, the data transmission may be one of a dynamically scheduled PUSCH or PDSCH, a PDSCH with a semi-persistent scheduling (SPS) configuration, or a PUSCH with a configured grant (CG) configuration.

FIG. 25C1 is a flowchart of a method 2540 for transmitting an SRS based on received control information, according to some embodiments. Method 2540 starts at operation 2542, where the UE receives control information for a first sounding reference signal (SRS) resource in a carrier. The control information indicates at least a first bandwidth parameter, a frequency-domain shift parameter, a PF value, and a frequency-domain offset value. At operation 2544, based on the control information, the UE transmits the first SRS resource on a first partial frequency sounding resource in the carrier. A bandwidth of the first partial frequency sounding resource is based on at least the PF value and the first bandwidth parameter. A partial frequency sounding resource starting PRB of the first partial frequency sounding resource is based on at least the frequency-domain shift parameter and the frequency-domain offset value.

In some embodiments, the first bandwidth parameter may be configured with m PRBs, and wherein the first partial frequency sounding resource is configured with m/(the PF value) PRBs. In some embodiments, the control information may further indicate a hopping parameter. The partial frequency sounding resource starting PRB of the first partial frequency sounding resource may be based on the frequency-domain shift parameter, the frequency-domain offset value, and a hopping offset value in accordance with the hopping parameter. In some embodiments, the PF value may be one of 2, 4, or 8. In some embodiments, the control information is received in a radio resource control (RRC) message. In some embodiments, the first SRS resource may be configured in a first SRS resource set including one or more SRS resources in the carrier. Each SRS resource in the first SRS resource set may be separately configured with a separate bandwidth parameter, a separate frequency-domain shift parameter, a separate PF value, and a separate frequency-domain offset value.

FIG. 25C2 is a flowchart of a method 2550 for receiving an SRS based on transmitted control information, according to some embodiments. Method 2550 starts at operation 2552, where the base stations transmits to a user equipment (UE) control information for a first sounding reference signal (SRS) resource in a carrier. The control information indicates at least a first bandwidth parameter, a frequency-domain shift parameter, a PF value, and a frequency-domain offset value. At operation 2554, based on the control information, the base station receives from the UE the first SRS resource on a first partial frequency sounding resource in the carrier. A bandwidth of the first partial frequency sounding resource is based on at least the PF value and the first bandwidth parameter. A partial frequency sounding resource starting PRB of the first partial frequency sounding resource is based on at least the frequency-domain shift parameter and the frequency-domain offset value.

In some embodiments, the first bandwidth parameter may be configured with m PRBs, and wherein the first partial frequency sounding resource is configured with m/(the PF value) PRBs. In some embodiments, the control information may further indicate a hopping parameter. The partial frequency sounding resource starting PRB of the first partial frequency sounding resource may be based on the frequency-domain shift parameter, the frequency-domain offset value, and a hopping offset value in accordance with the hopping parameter. In some embodiments, the PF value may be one of 2, 4, or 8. In some embodiments, the control information is received in a radio resource control (RRC) message. In some embodiments, the first SRS resource may be configured in a first SRS resource set including one or more SRS resources in the carrier. Each SRS resource in the first SRS resource set may be separately configured with a separate bandwidth parameter, a separate frequency-domain shift parameter, a separate PF value, and a separate frequency-domain offset value.

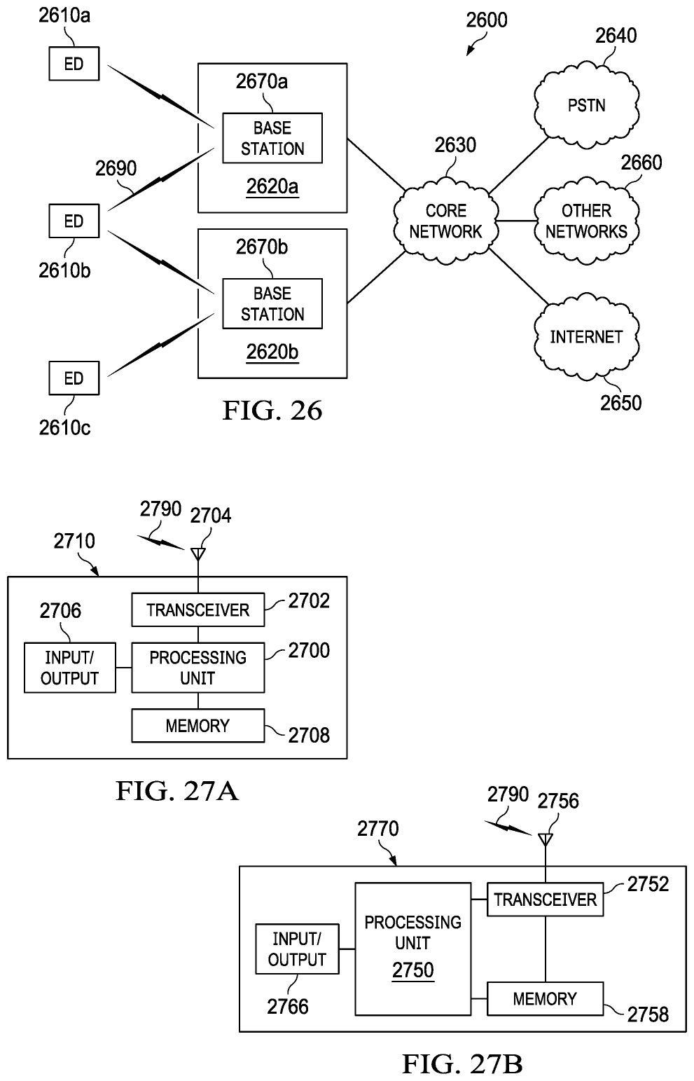

FIG. 26 illustrates an example communication system 2600. In general, the system 2600 enables multiple wireless or wired users to transmit and receive data and other content. The system 2600 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 2600 includes electronic devices (ED) 2610a-2610c, radio access networks (RANs) 2620a-2620b, a core network 2630, a public switched telephone network (PSTN) 2640, the Internet 2650, and other networks 2660. While certain numbers of these components or elements are shown in FIG. 26, any number of these components or elements may be included in the system 2600.

The EDs 2610a-2610c are configured to operate or communicate in the system 2600. For example, the EDs 2610a-2610c are configured to transmit or receive via wireless or wired communication channels. Each ED 2610a-2610c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 2620a-2620b here include base stations 2670a-2670b, respectively. Each base station 2670a-2670b is configured to wirelessly interface with one or more of the EDs 2610a-2610c to enable access to the core network 2630, the PSTN 2640, the Internet 2650, or the other networks 2660. For example, the base stations 2670a-2670b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 2610a-2610c are configured to interface and communicate with the Internet 2650 and may access the core network 2630, the PSTN 2640, or the other networks 2660.

In the embodiment shown in FIG. 26, the base station 2670a forms part of the RAN 2620a, which may include other base stations, elements, or devices. Also, the base station 2670b forms part of the RAN 2620b, which may include other base stations, elements, or devices. Each base station 2670a-2670b operates to transmit or receive wireless signals within a particular geographic region or area, sometimes referred to as a “cell.” In some embodiments, multiple-input multiple-output (MIMO) technology may be employed having multiple transceivers for each cell.

The base stations 2670a-2670b communicate with one or more of the EDs 2610a-2610c over one or more air interfaces 2690 using wireless communication links. The air interfaces 2690 may utilize any suitable radio access technology.

It is contemplated that the system 2600 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 2620a-2620b are in communication with the core network 2630 to provide the EDs 2610a-2610c with voice, data, application, Voice over Internet Protocol (VoIP), or other services. Understandably, the RANs 2620a-2620b or the core network 2630 may be in direct or indirect communication with one or more other RANs (not shown). The core network 2630 may also serve as a gateway access for other networks (such as the PSTN 2640, the Internet 2650, and the other networks 2660). In addition, some or all of the EDs 2610a-2610c may include functionality for communicating with different wireless networks over different wireless links using different wireless technologies or protocols. Instead of wireless communication (or in addition thereto), the EDs may communicate via wired communication channels to a service provider or switch (not shown), and to the Internet 2650.

Although FIG. 26 illustrates one example of a communication system, various changes may be made to FIG. 26. For example, the communication system 2600 could include any number of EDs, base stations, networks, or other components in any suitable configuration.

FIGS. 27A and 27B illustrate example devices that may implement the methods and teachings according to this disclosure. In particular, FIG. 27A illustrates an example ED 2710, and FIG. 27B illustrates an example base station 2770. These components could be used in the system 2600 or in any other suitable system.

As shown in FIG. 27A, the ED 2710 includes at least one processing unit 2700. The processing unit 2700 implements various processing operations of the ED 2710. For example, the processing unit 2700 could perform signal coding, data processing, power control, input/output processing, or any other functionality enabling the ED 2710 to operate in the system 2600. The processing unit 2700 also supports the methods and teachings described in more detail above. Each processing unit 2700 includes any suitable processing or computing device configured to perform one or more operations. Each processing unit 2700 could, for example, include a microprocessor, microcontroller, digital signal processor, field programmable gate array, or application specific integrated circuit.

The ED 2710 also includes at least one transceiver 2702. The transceiver 2702 is configured to modulate data or other content for transmission by at least one antenna or NIC (Network Interface Controller) 2704. The transceiver 2702 is also configured to demodulate data or other content received by the at least one antenna 2704. Each transceiver 2702 includes any suitable structure for generating signals for wireless or wired transmission or processing signals received wirelessly or by wire. Each antenna 2704 includes any suitable structure for transmitting or receiving wireless or wired signals. One or multiple transceivers 2702 could be used in the ED 2710, and one or multiple antennas 2704 could be used in the ED 2710. Although shown as a single functional unit, a transceiver 2702 could also be implemented using at least one transmitter and at least one separate receiver.

The ED 2710 further includes one or more input/output devices 2706 or interfaces (such as a wired interface to the Internet 2650). The input/output devices 2706 facilitate interaction with a user or other devices (network communications) in the network. Each input/output device 2706 includes any suitable structure for providing information to or receiving information from a user, such as a speaker, microphone, keypad, keyboard, display, or touch screen, including network interface communications.

In addition, the ED 2710 includes at least one memory 2708. The memory 2708 stores instructions and data used, generated, or collected by the ED 2710. For example, the memory 2708 could store software or firmware instructions executed by the processing unit(s) 2700 and data used to reduce or eliminate interference in incoming signals. Each memory 2708 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 27B, the base station 2770 includes at least one processing unit 2750, at least one transceiver 2752, which includes functionality for a transmitter and a receiver, one or more antennas 2756, at least one memory 2758, and one or more input/output devices or interfaces 2766. A scheduler, which would be understood by one skilled in the art, is coupled to the processing unit 2750. The scheduler could be included within or operated separately from the base station 2770. The processing unit 2750 implements various processing operations of the base station 2770, such as signal coding, data processing, power control, input/output processing, or any other functionality. The processing unit 2750 can also support the methods and teachings described in more detail above. Each processing unit 2750 includes any suitable processing or computing device configured to perform one or more operations. Each processing unit 2750 could, for example, include a microprocessor, microcontroller, digital signal processor, field programmable gate array, or application specific integrated circuit.

Each transceiver 2752 includes any suitable structure for generating signals for wireless or wired transmission to one or more EDs or other devices. Each transceiver 2752 further includes any suitable structure for processing signals received wirelessly or by wire from one or more EDs or other devices. Although shown combined as a transceiver 2752, a transmitter and a receiver could be separate components. Each antenna 2756 includes any suitable structure for transmitting or receiving wireless or wired signals. While a common antenna 2756 is shown here as being coupled to the transceiver 2752, one or more antennas 2756 could be coupled to the transceiver(s) 2752, allowing separate antennas 2756 to be coupled to the transmitter and the receiver if equipped as separate components. Each memory 2758 includes any suitable volatile or non-volatile storage and retrieval device(s). Each input/output device 2766 facilitates interaction with a user or other devices (network communications) in the network. Each input/output device 2766 includes any suitable structure for providing information to or receiving/providing information from a user, including network interface communications.

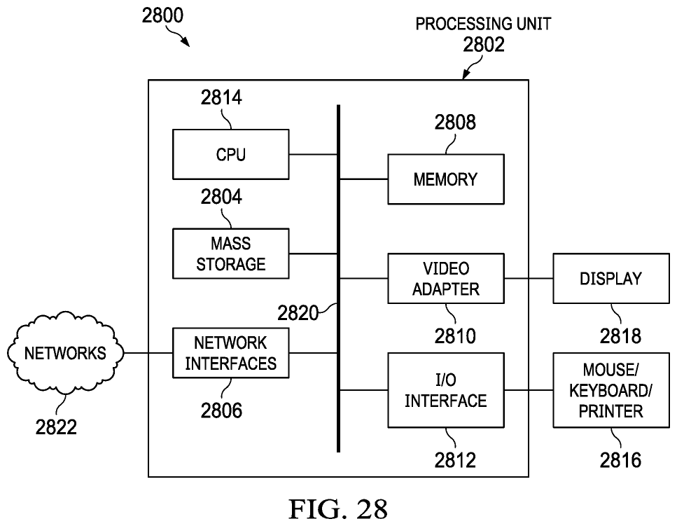

FIG. 28 is a block diagram of a computing system 2800 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2800 includes a processing unit 2802. The processing unit includes a central processing unit (CPU) 2814, memory 2808, and may further include a mass storage device 2804, a video adapter 2810, and an I/O interface 2812 connected to a bus 2820.

The bus 2820 may be one or more of any type of several bus architectures including a memory bus or memory controller, a peripheral bus, or a video bus. The CPU 2814 may comprise any type of electronic data processor. The memory 2808 may comprise any type of non-transitory system memory such as static random access memory (SRAM), dynamic random access memory (DRAM), synchronous DRAM (SDRAM), read-only memory (ROM), or a combination thereof. In an embodiment, the memory 2808 may include ROM for use at boot-up, and DRAM for program and data storage for use while executing programs.

The mass storage 2804 may comprise any type of non-transitory storage device configured to store data, programs, and other information and to make the data, programs, and other information accessible via the bus 2820. The mass storage 2804 may comprise, for example, one or more of a solid state drive, hard disk drive, a magnetic disk drive, or an optical disk drive.

The video adapter 2810 and the I/O interface 2812 provide interfaces to couple external input and output devices to the processing unit 2802. As illustrated, examples of input and output devices include a display 2818 coupled to the video adapter 2810 and a mouse, keyboard, or printer 2816 coupled to the I/O interface 2812. Other devices may be coupled to the processing unit 2802, and additional or fewer interface cards may be utilized. For example, a serial interface such as Universal Serial Bus (USB) (not shown) may be used to provide an interface for an external device.

The processing unit 2802 also includes one or more network interfaces 2806, which may comprise wired links, such as an Ethernet cable, or wireless links to access nodes or different networks. The network interfaces 2806 allow the processing unit 2802 to communicate with remote units via the networks. For example, the network interfaces 2806 may provide wireless communication via one or more transmitters/transmit antennas and one or more receivers/receive antennas. In an embodiment, the processing unit 2802 is coupled to a local-area network 2822 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a selecting unit or module, a determining unit or module, or an assigning unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

What is claimed is:

1. A method, comprising:
receiving, by a user equipment (UE), control information for a first sounding reference signal (SRS), the control information indicating at least a first frequency resource in a carrier, a frequency-domain shift parameter, a partial frequency (PF) value, and a frequency-domain offset value; and
transmitting, by the UE based on the control information, the first SRS on a first PF sounding resource within the first frequency resource in the carrier, wherein a resource starting physical resource block (PRB) of the first frequency resource is in accordance with the frequency-domain shift parameter, wherein a PF bandwidth of the first PF sounding resource is based on at least the PF value and a bandwidth of the first frequency resource, and wherein a PF sounding resource starting PRB of the first PF sounding resource is based at least on the resource starting PRB of the first frequency resource and the frequency-domain offset value.

2. The method of claim 1, wherein the first frequency resource is configured with m PRBs, and the first PF sounding resource is configured with m/(the PF value) PRBs in the m PRBs of the first frequency resource.

3. The method of claim 1, wherein the PF sounding resource starting PRB of the first PF sounding resource is the resource starting PRB of the first frequency resource shifted in accordance with the frequency-domain offset value.

4. The method of claim 1, wherein the control information further indicates a hopping parameter, and wherein the PF sounding resource starting PRB of the first PF sounding resource is based on the resource starting PRB of the first frequency resource, the frequency-domain offset value, and a hopping offset value in accordance with the hopping parameter.

5. The method of claim 1, wherein the PF value is one of 2, 4, or 8.

6. The method of claim 1, wherein the control information is received in a radio resource control (RRC) message.

7. The method of claim 1, wherein the first SRS is configured in a first SRS resource set including one or more SRS resources, and each SRS resource in the first SRS resource set is separately configured with a separate frequency resource in the carrier, a separate frequency-domain shift parameter, a separate PF value, and a separate frequency-domain offset value.

8. The method of claim 7, wherein the first SRS is transmitted on a first SRS resource in the first SRS resource set.

9. A method, comprising:
transmitting, by a base station to a user equipment (UE), control information for a first sounding reference signal (SRS), the control information indicating at least a first frequency resource in a carrier, a frequency-domain shift parameter, a partial frequency (PF) value, and a frequency-domain offset value; and
receiving, by the base station from the UE based on the control information, the first SRS on a first PF sounding resource within the first frequency resource in the carrier, wherein a resource starting physical resource block (PRB) of the first frequency resource is in accordance with the frequency-domain shift parameter, wherein a PF bandwidth of the first PF sounding resource is based on at least the PF value and a bandwidth of the first frequency resource, and wherein a PF sounding resource starting PRB of the first PF sounding resource is based at least on the resource starting PRB of the first frequency resource and the frequency-domain offset value.

10. The method of claim 9, wherein the first frequency resource is configured with m PRBs, and the first PF sounding resource is configured with m/(the PF value) PRBs in the m PRBs of the first frequency resource.

11. The method of claim 9, wherein the PF sounding resource starting PRB of the first PF sounding resource is the resource starting PRB of the first frequency resource shifted in accordance with the frequency-domain offset value.

12. The method of claim 9, wherein the control information further indicates a hopping parameter, and wherein the PF sounding resource starting PRB of the first PF sounding resource is based on the resource starting PRB of the first frequency resource, the frequency-domain offset value, and a hopping offset value in accordance with the hopping parameter.

13. The method of claim 9, wherein the PF value is one of 2, 4, or 8.

14. The method of claim 9, wherein the control information is received in a radio resource control (RRC) message.

15. The method of claim 9, wherein the first SRS is configured in a first SRS resource set including one or more SRS resources, and each SRS resource in the first SRS resource set is separately configured with a separate frequency resource in the carrier, a separate frequency-domain shift parameter, a separate PF value, and a separate frequency-domain offset value.

16. A user equipment (UE) comprising:
at least one processor; and
a non-transitory computer readable storage medium storing instructions that, when executed by the at least one processor, cause the UE to perform operations including:
receiving control information for a first sounding reference signal (SRS), the control information indicating at least a first frequency resource in a carrier, a frequency-domain shift parameter, a partial frequency (PF) value, and a frequency-domain offset value; and
transmitting, based on the control information, the first SRS on a first PF sounding resource within the first frequency resource in the carrier, wherein a resource starting physical resource block (PRB) of the first frequency resource is in accordance with the frequency-domain shift parameter, wherein a PF bandwidth of the first PF sounding resource is based on at least the PF value and a bandwidth of the first frequency resource, and wherein a PF sounding resource starting PRB of the first PF sounding resource is based at least on the resource starting PRB of the first frequency resource and the frequency-domain offset value.

17. The UE of claim 16, wherein the first frequency resource is configured with m PRBs, and the first PF sounding resource is configured with m/(the PF value) PRBs in the m PRBs of the first frequency resource.

18. The UE of claim 16, wherein the PF sounding resource starting PRB of the first PF sounding resource is the resource starting PRB of the first frequency resource shifted in accordance with the frequency-domain offset value.

19. The UE of claim 16, wherein the control information further indicates a hopping parameter, and wherein the PF sounding resource starting PRB of the first PF sounding resource is based on the resource starting PRB of the first frequency resource, the frequency-domain offset value, and a hopping offset value in accordance with the hopping parameter.

20. The UE of claim 16, wherein the PF value is one of 2, 4, or 8.

21. The UE of claim 16, wherein the control information is received in a radio resource control (RRC) message.

22. The UE of claim 16, wherein the first SRS is configured in a first SRS resource set including one or more SRS resources, and each SRS resource in the first SRS resource set is separately configured with a separate frequency resource in the carrier, a separate frequency-domain shift parameter, a separate PF value, and a separate frequency-domain offset value.

23. A base station comprising:
at least one processor; and
a non-transitory computer readable storage medium storing instructions that, when executed by the at least one processor, cause the base station to perform operations including:
transmitting, to a user equipment (UE), control information for a first sounding reference signal (SRS), the control information indicating at least a first frequency resource in a carrier, a frequency-domain shift parameter, a partial frequency (PF) value, and a frequency-domain offset value; and
receiving, from the UE based on the control information, the first SRS on a first PF sounding resource within the first frequency resource in the carrier, wherein a resource starting physical resource block (PRB) of the first frequency resource is in accordance with the frequency-domain shift parameter, wherein a PF bandwidth of the first PF sounding resource is based on at least the PF value and a bandwidth of the first frequency resource, and wherein a PF sounding resource starting PRB of the first PF sounding resource is based at least on the resource starting PRB of the first frequency resource and the frequency-domain offset value.

24. The base station of claim 23, wherein the first frequency resource is configured with m PRBs, and the first PF sounding resource is configured with m/(the PF value) PRBs in the m PRBs of the first frequency resource.

25. The base station of claim 23, wherein the PF sounding resource starting PRB of the first PF sounding resource is the resource starting PRB of the first frequency resource shifted in accordance with the frequency-domain offset value.

26. The base station of claim 23, wherein the control information further indicates a hopping parameter, and wherein the PF sounding resource starting PRB of the first PF sounding resource is based on the resource starting PRB of the first frequency resource, the frequency-domain offset value, and a hopping offset value in accordance with the hopping parameter.

27. The base station of claim 23, wherein the PF value is one of 2, 4, or 8.

28. The base station of claim 23, wherein the control information is received in a radio resource control (RRC) message.

29. The base station of claim 23, wherein the first SRS is configured in a first SRS resource set including one or more SRS resources, and each SRS resource in the first SRS resource set is separately configured with a separate frequency resource in the carrier, a separate frequency-domain shift parameter, a separate PF value, and a separate frequency-domain offset value.
